(19) United States
(12) Patent Application Publication
(10) Pub. No.: US 2026/0301023 A1
(43) Pub. Date: Oct. 1, 2026

(54) SYSTEM AND METHOD FOR CUSTOMER CLASSIFICATION BASED ON CONVERSATION DATA

(71) Applicant: Truist Bank, Charlotte, NC (US)

(72) Inventors: Ankita Kumar, Charlotte, NC (US); Dennis Yerby, Charlotte, NC (US)

(73) Assignee: Truist Bank, Charlotte, NC (US)

(21) Appl. No.: 19/093,475

(22) Filed: Mar. 28, 2025

(51) Int. Cl. G06Q 30/0251; G06N 3/092

(52) U.S. Cl. CPC G06Q 30/0255; G06N 3/092

(57) ABSTRACT

A server computing system includes: a processor; and a non-transitory memory, coupled to the processor, having stored therein, customer conversation data associated with a customer, a plurality of product/service data relating to a respective plurality of available products/services, and a set of instructions of computer-executable program code, which when executed by the processor, cause the processor to perform operations including: analyzing the customer conversation data via a machine learning algorithm; classifying the customer, based on the analysis of the customer conversation data, as one classification type within a plurality of different classification types; identifying an available product based on the one classification type; generating an available product signal based on the available product; and transmitting the available product signal to a client device to cause display of information related to the available product on a user interface of the client device.

### TECHNICAL FIELD

Aspects of the present disclosure are generally related to systems and computer-implemented methods of identifying and classifying customers based on conversations.

### BACKGROUND

Traditional enterprise systems struggle with accurately classifying customer conversations and identifying high-value clients. Conventional methods for classifying customer conversations and identifying high-value clients have many problems. For example, bank tellers and customer support agents manually categorize customer interactions. Accordingly, such categorizations are inconsistent across an enterprise, and many times are ultimately inaccurate. Further, customers may engage with an enterprise via multiple channels such as by phone calls, emails, texts, video conferences, and in-person visits. However, conventional methods for classifying customer conversations fail to integrate these multiple different channels of interactions effectively. Still further, enterprises rely on historical data for segmentation instead of real-time insights. As a result, conventional methods for classifying customer conversations lack proactive engagement.

What is needed is a system and computer-implemented method of operating a system to categorize customers consistently and accurately, based on customer conversations, so as to match customers with available enterprise products/services and/or enterprise services that will optimize the financial interest of the customer and the financial interest of the enterprise.

### SUMMARY

An aspect of the present disclosure is drawn to a server computing system including: a processor; and a non-transitory memory, coupled to the processor, having stored therein, customer conversation data associated with a customer, product/service data relating to a respective plurality of available products/services, and a set of instructions of computer-executable program code, which when executed by the processor, cause the processor to perform operations including: analyzing the customer conversation data via a machine learning algorithm; classifying the customer, based on the analysis of the customer conversation data, as one classification type within a plurality of different classification types; identifying an available product based on the one classification type; generating an available product signal based on the available product; and transmitting the available product signal to a client device to cause display of information related to the available product on a user interface of the client device.

In one or more embodiments of this aspect, the set of instructions, which when executed by the processor, cause the processor to perform operations including: identifying a second available product based on the one classification type; generating the available product signal based on the available product and the second available product; and transmitting the available product signal to a client device to cause display of information related to the available product and the second available product on the user interface of the client device.

In one or more embodiments of this aspect, the set of instructions, which when executed by the processor, cause the processor to perform operations including analyzing the customer conversation data using a neural network that has been trained via reinforcement learning as the machine learning algorithm.

In one or more embodiments of this aspect, the set of instructions, which when executed by the processor, cause the processor to perform operations including analyzing the customer conversation data using the neural network that has been trained via reinforcement learning to analyze at least one of an email message from the customer, a recorded voice message from the customer, a text message from the customer, data related to an in-person visit by the customer, and combinations thereof, of the customer conversation data.

In one or more embodiments of this aspect, the set of instructions, which when executed by the processor, cause the processor to perform operations including analyzing the customer conversation data using the neural network that has been trained via reinforcement learning of historical customer conversation (HCC) data of at least one of an email message from a second customer, a recorded voice message from the second customer, a text message from the second customer, data related to an in-person visit by the second customer, and combinations thereof.

In one or more embodiments of this aspect, the set of instructions, which when executed by the processor, cause the processor to perform operations including analyzing the customer conversation data using the neural network that has been trained via reinforcement learning additionally of synthetic customer conversation data created from historical customer conversation data of at least one of the email message from the second customer, the recorded voice message from the second customer, the text message from the second customer, the data related to the in-person visit by the second customer, and combinations thereof.

In one or more embodiments of this aspect, the set of instructions, which when executed by the processor, cause the processor to perform operations including analyzing the customer conversation data using the neural network that has been trained via reinforcement learning additionally of APCC data of at least one of an email message, a recorded voice message, a text message, data related to an in-person visit, and combinations thereof.

In one or more embodiments of this aspect, the set of instructions, which when executed by the processor, cause the processor to perform operations including transmitting, to a second server computing system having the neural network stored therein, updated customer conversation data based on at least one of a new email message from the customer, a new recorded voice message from the customer, a new text message from the customer, data related to a new in-person visit by the customer, and combinations thereof, to cause the second server computing system to update the neural network based on the updated customer conversation data.

In one or more embodiments of this aspect, the set of instructions, which when executed by the processor, cause the processor to perform operations including: receiving, from a second server computing system having the neural network stored therein, a modification instruction; and updating the neural network based on the modification instruction.

In one or more embodiments of this aspect, the set of instructions, which when executed by the processor, cause the processor to perform operations including: analyzing the customer conversation data using the neural network that has been updated based on the modification instruction; reclassifying the customer, based on the analysis of the customer conversation data using the neural network that has been updated based on the modification instruction, as a new classification type within the plurality of different classification types; identifying a new available product based on the new classification type; generating a new available product signal based on the new available product; and transmitting the new available product signal to the client device to cause display of new information related to the new available product on the user interface of the client device.

In one or more embodiments of this aspect, the set of instructions, which when executed by the processor, cause the processor to perform operations including: determining whether the one classification type is different from the new classification type; generating a classification type change signal when the one classification type is different from the new classification type; and transmitting the classification type change signal to the client device to cause display of classification type change information related to change in classification type on the user interface of the client device.

In one or more embodiments of this aspect, the set of instructions, which when executed by the processor, cause the processor to perform operations including: determining whether the available product is different from the new available product; generating an available product change signal when the available product is different from the new available product; and transmitting the available product change signal to the client device to cause display of available product change information related to change in available product on the user interface of the client device.

In one or more embodiments of this aspect, the set of instructions, which when executed by the processor, cause the processor to perform operations including: receiving new customer conversation data based on at least one of a new email message from the customer, a new recorded voice message from the customer, a new text message from the customer, new data related to a new in-person visit by the customer, and combinations thereof; analyzing the new customer conversation data using the neural network that has been updated based on the modification instruction; reclassifying the customer, based on the analysis of the new customer conversation data using the neural network that has been updated based on the modification instruction, as new classification type within the plurality of different classification types; identifying a new available product based on the new classification type; generating a new available product signal based on the new available product; and transmitting the new available product signal to the client device to cause display of new information related to the new available product on the user interface of the client device.

In one or more embodiments of this aspect, the set of instructions, which when executed by the processor, cause the processor to perform operations including: determining whether the one classification type is different from the new classification type; generating a classification type change signal when the one classification type is different from the new classification type; and transmitting the classification type change signal to the client device to cause display of classification type change information related to change in classification type on the user interface of the client device.

Another aspect of the present disclosure is drawn a computer-implemented method of operating a system for implementation by a processor of a server computing system, the computer-implemented method including: generating customer conversation data associated with a customer; analyzing the customer conversation data via a machine learning algorithm; classifying the customer, based on the analysis of the customer conversation data, as one classification type within a plurality of different classification types; identifying an available product based on the one classification type; generating an available product signal based on the available product; and transmitting the available product signal to a client device to cause display of information related to the available product on a user interface of the client device.

In one or more embodiments of this aspect, the method further includes: identifying a second available product based on the one classification type; generating the available product signal based on the available product and the second available product; and transmitting the available product signal to a client device to cause display of information related to the available product and the second available product on the user interface of the client device.

Another aspect of the present disclosure is drawn to a computer program product comprising at least one non-transitory computer readable medium having a set of instructions of computer-executable program code, which when executed by a processor of an enterprise computer server system, cause the processor to perform a computer-implemented method including: generating customer conversation data associated with a customer; analyzing the customer conversation data via a machine learning algorithm; classifying the customer, based on the analysis of the customer conversation data, as one classification type within a plurality of different classification types; identifying an available product based on the one classification type; generating an available product signal based on the available product; and transmitting the available product signal to a client device to cause display of information related to the available product on a user interface of the client device.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein.

FIG. 2 illustrates a block diagram of the client device of FIG. 1.

FIG. 3 illustrates a block diagram of the one or more enterprise servers of FIG. 1.

FIG. 4 illustrates a block diagram of the data stores of the one or more servers of FIG. 3.

FIG. 5 illustrates a block diagram of the customers data storage of the data stores of FIG. 4.

FIG. 6 illustrates a block diagram of the conversations data storage of the data stores of FIG. 4.

FIG. 7 illustrates a block diagram of the historical customer conversations history data storage of the conversations data storage of FIG. 6.

FIG. 8 illustrates a block diagram of the synthetic customer conversations history data storage of the conversations data storage of FIG. 6.

FIG. 9 illustrates a block diagram of the a priori customer conversations history data storage of the conversations data storage of FIG. 6.

FIG. 10 illustrates a block diagram of the products/services data storage of the data stores of FIG. 4.

FIG. 11 illustrates a block diagram of an example enterprise having the one or more servers of FIG. 1.

FIG. 12 illustrates an example computer-implemented method of generating a product message for an enterprise customer based on a customer classification, which is based on a conversation history in accordance with aspects of the present disclosure.

FIG. 13 illustrates an example computer-implemented method of creating a machine learning (ML) algorithm in the example computer-implemented method of FIG. 12.

FIG. 14 illustrates an example computer-implemented method of obtaining conversation data in the example computer-implemented method of FIG. 13.

FIG. 15 illustrates a block diagram of a portion of one or more enterprise servers of FIG. 3 for obtaining historical customer conversation history data in accordance with aspects of the present disclosure.

FIG. 16 illustrates an example computer-implemented method of obtaining synthetic customer conversation data in the example computer-implemented method of FIG. 14.

FIG. 17A illustrates a block diagram of a portion of one or more enterprise servers of FIG. 3 for obtaining synthetic customer conversation history in accordance with aspects of the present disclosure.

FIG. 17B illustrates the block diagram of FIG. 17A at a subsequent time.

FIG. 18 illustrates a block diagram of a portion of one or more enterprise servers of FIG. 3 for obtaining a priori customer conversation history in accordance with aspects of the present disclosure.

FIG. 19 illustrates a block diagram of a portion of one or more enterprise servers of FIG. 3 for training a ML algorithm to classify enterprise customers based on conversation history in accordance with aspects of the present disclosure.

FIG. 20A illustrates a block diagram of the ML algorithm of FIG. 19, when the ML algorithm correctly classifies a customer, corresponding to a repackaged conversation data structure, as one classification type within a plurality of different classification types.

FIG. 20B illustrates a block diagram of the ML algorithm of FIG. 19, when the ML algorithm incorrectly classifies a customer, corresponding to a repackaged conversation data structure, as one classification type within a plurality of different classification types.

FIG. 21 illustrates a block diagram of one or more enterprise servers of FIG. 3 for obtaining HCC data from unclassified customers in accordance with aspects of the present disclosure.

FIG. 22 illustrates a block diagram of an ML algorithm for classifying a previously unclassified customer, corresponding to a repackaged conversation data structure, as one classification type within a plurality of different classification types, in accordance with aspects of the present disclosure.

FIG. 23A illustrates a block diagram of a portion of one or more enterprise servers of FIG. 3 for obtaining conversation data of a customer in accordance with aspects of the present disclosure.

FIG. 23B illustrates the block diagram of FIG. 23A for classifying the customer at a subsequent time.

FIG. 24 illustrates a block diagram of the enterprise user device of FIG. 11.

FIG. 25 illustrates a block diagram of a portion of one or more enterprise servers of FIG. 3 for determining whether a customer qualifies for any products/services in accordance with aspects of the present disclosure.

FIG. 26 illustrates an example computer-implemented method of generating a product message of the example computer-implemented method of generating a product message for an enterprise customer based on a customer classification, which is based on a conversation history of FIG. 12, in accordance with aspects of the present disclosure.

FIG. 27 illustrates a block diagram of a portion of one or more enterprise servers of FIG. 3 for identifying whether a customer is currently using an available product in accordance with aspects of the present disclosure.

FIG. 28 illustrates a block diagram of a portion of one or more enterprise servers of FIG. 3 for identifying whether a customer's currently used product(s) is the available product(s), in accordance with aspects of the present disclosure.

FIG. 29A illustrates a block diagram of a portion of one or more enterprise servers of FIG. 3 and an enterprise user device for displaying information related to acknowledging a currently used product(s) in accordance with aspects of the present disclosure.

FIG. 29B illustrates a block diagram of a portion of one or more enterprise servers of FIG. 3 and an enterprise user device for displaying information related to informing of an additional product(s) in accordance with aspects of the present disclosure.

FIG. 29C illustrates a block diagram of a portion of one or more enterprise servers of FIG. 3 and an enterprise user device for displaying information related to informing of a product in accordance with aspects of the present disclosure.

FIG. 30A illustrates a user interface of enterprise user device of FIG. 24 displaying an acknowledge product message in accordance with aspects of the present disclosure.

FIG. 30B illustrates the user interface of the enterprise user device of FIG. 24 displaying an alternate product message in accordance with aspects of the present disclosure.

FIG. 30C illustrates the user interface of the enterprise user device of FIG. 24 displaying a product message in accordance with aspects of the present disclosure.

### DESCRIPTION

Hereinbelow are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (Al)” relates to one or more computer system operable to perform one or more tasks that normally require human intelligence, such as visual perception, speech recognition, decision-making, and translation between languages.

As used herein, “dynamically” relates to customer engagement events or actions that can be caused, triggered, or otherwise occur without human intervention.

As used herein, “machine learning” relates to an application of Al that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programable gate array (FPGA) or an application specific integrated circuit (ASIC). A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein.

As used herein, “hardware-implemented module” refers to a hardware module. Considering embodiments in which hardware modules are temporarily configured (e.g., programmed), each of the hardware modules need not be configured or instantiated at any one instance in time. For example, where a hardware module includes a general-purpose processor configured by software to become a special-purpose processor, the general-purpose processor may be configured as respectively different special-purpose processors (e.g., including different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access.

As used herein, “disk” or “disc” includes compact disc (CD), laser disc, optical disc, digital versatile disc (DVD), floppy disk and Blu-ray disc.

As used herein, “network” or “networks” relates to any combination of electronic communication networks, including without limitation the Internet, a local area network (LAN), a wide area network, a wireless network, and a cellular network (e.g., 4G, 5G).

As used herein, “input interface” relates to any device, software, component, system, element, or arrangement or groups thereof that enable information and/or data to be entered as input commands by a user in a manner that directs a processor to execute instructions.

As used herein, “output interface” relates to any device, software, component, system, element or arrangement or groups thereof that enable information/data to be presented to a user.

As used herein, “synthetic data” is artificially generated data that mimics the patterns and characteristics of real-world data.

As used herein, “a priori data” refers to knowledge or assumptions made based on deductive reasoning or existing information, without relying on empirical evidence or new observations. A priori data is derived from logical reasoning and known facts rather than from experience or experimentation.

As used herein, “historical data” is data that is based on information collected from past events, situations, or phenomena that have been previously recorded or recorded over a previous time period.

As used herein, “embeddings” are low-dimensional, learned continuous vector representations of discrete variables. These vectors capture meaningful data about objects such as words, images, or videos, allowing an ML algorithm to process them efficiently.

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a computer-implemented method, could be implemented as a series of software instructions for being operated by a processor, such that the embodiments could be implemented as software, hardware, or a combination thereof.

As used herein, “real-time” relates to a level of processing responsiveness that a user, module, or system senses as sufficiently immediate for a particular process or determination to be made, or that enables the processor to keep up with some external process.

As used herein, “enterprise” is an institution that provides services and/or products/services to customers.

As used herein, “user” relates to a consumer, machine entity, and/or requesting party, and may be human or machine.

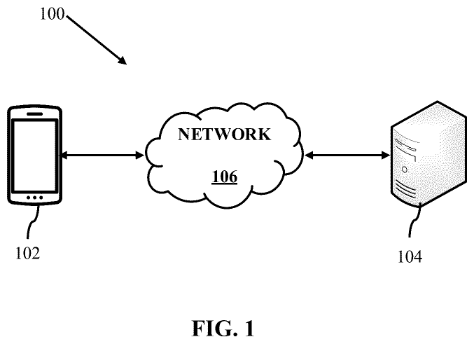

Turning to the figures, FIG. 1 illustrates a communication environment 100 in which a user communicates with an enterprise. A client device 102 operating in communication environment 100 facilitates user access to and user management of one or more user accounts residing at one or more enterprise servers 104. Communication environment 100 includes client device 102, one or more enterprise servers 104, and a communications network 106 through which communication is facilitated between client device 102 and one or more enterprise servers 104.

In accordance with one or more embodiments, client device 102 may take the form of a computing device, non-limiting examples of which include a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates client device 102 including any form of electronic device that optimizes the performance and functionality of the one or more embodiments in a manner that falls within the spirit and scope of the principles of this disclosure.

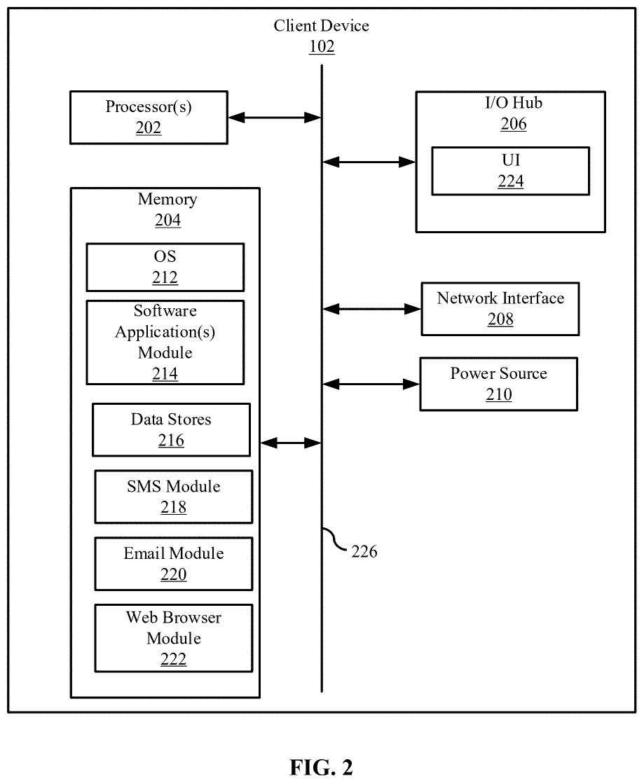

FIG. 2 illustrates a block diagram of client device 102. It will be understood that it is not necessary for client device 102 to have all the elements illustrated in FIG. 2. For example, client device 102 may have any combination of the various elements illustrated in FIG. 2. Moreover, client device 102 may have additional elements to those illustrated in FIG. 2.

As shown in the figure, client device 102 includes one or more processors 202, a non-transitory memory 204 operatively coupled to one or more processors 202, an input/output (I/O) hub 206, a network interface 208, a power source 210, and a communication bus 226.

In this example, one or more processors 202, non-transitory memory 204, I/O hub 206, network interface 208, and power source 210 are illustrated as individual elements of client device 102. However, in one or more embodiments, at least two of one or more processors 202, non-transitory memory 204, I/O hub 206, network interface 208, and power source 210 may be combined as a unitary device. Further, in one or more embodiments, at least one of one or more processors 202, non-transitory memory 204, I/O hub 206, and network interface 208 may be implemented as a computer having non-transitory computer-readable media for carrying or having computer-executable instructions or data structures stored thereon. Such non-transitory computer-readable recording medium refers to any computer program product, apparatus or device, such as a magnetic disk, optical disk, solid-state storage device, memory, programmable logic devices (PLDs), DRAM, RAM, ROM, EEPROM, CD-ROM or other optical disk storage, magnetic disk storage or other magnetic storage devices, or any other medium that can be used to carry or store desired computer-readable program code in the form of instructions or data structures and that can be accessed by a general-purpose or special-purpose computer, or a general-purpose or special-purpose processor. Combinations of the above are also included within the scope of computer-readable media. For information transferred or provided over a network or another communications connection (either hardwired, wireless, or a combination of hardwired or wireless) to a computer, the computer may properly view the connection as a computer-readable medium. Thus, any such connection may be properly termed a computer-readable medium. Combinations of the above should also be included within the scope of computer-readable media.

Example tangible computer-readable media may be coupled to client device 102 such that the processor may read information from and write information to the tangible computer-readable media. In the alternative, the tangible computer-readable media may be integral to client device 102. The tangible computer-readable media may reside in an integrated circuit (IC), an ASIC, or large-scale integrated circuit (LSI), system LSI, super LSI, or ultra LSI components that perform a part or all of the functions described herein. In the alternative, the tangible computer-readable media may reside as discrete components.

Example tangible computer-readable media may be also coupled to systems, non-limiting examples of which include a computer system/server, which is operational with numerous other general purpose or special purpose computing system environments or configurations. Examples of well-known computing systems, environments, and/or configurations that may be suitable for use with computer system/server include, but are not limited to, personal computer systems, server computer systems, thin clients, thick clients, handheld or laptop devices, multiprocessor systems, microprocessor-based systems, set-top boxes, programmable consumer electronics, network PCs, minicomputer systems, mainframe computer systems, and distributed cloud computing environments that include any of the above systems or devices, and the like.

Such a computer system/server may be described in the general context of computer system-executable instructions, such as program modules, being executed by a computer system. Generally, program modules may include routines, programs, objects, components, logic, data structures, and so on that perform particular tasks or implement particular abstract data types. Further, such a computer system/server may be practiced in distributed cloud computing environments where tasks are performed by remote processing devices that are linked through a communications network. In a distributed cloud computing environment, program modules may be located in both local and remote computer system storage media including memory storage devices.

In the figure, one or more processors 202, non-transitory memory 204, I/O hub 206, network interface 208, and power source 210 are configured to communicate with one another via communication bus 226.

Non-transitory memory 204 includes a set of instructions of computer-executable program code, an operating system 212, a software application module 214, one or more data stores 216, a short message service (SMS) module 218, an email module 220, and a web browser module 222.

In this example, operating system 212, software application module 214, one or more data stores 216, SMS module 218, email module 220, and web browser module 222 are illustrated as individual elements of non-transitory memory 204. However, in one or more embodiments, at least two of operating system 212, software application module 214, one or more data stores 216, SMS module 218, email module 220, and web browser module 222 may be combined as a unitary element.

The set of instructions within non-transitory memory 204 are executable by one or more processors 202 to cause one or more processors 202 to execute operating system 212 and one or more software applications of software application module 214 that reside in non-transitory memory 204. The one or more software applications residing in non-transitory memory 204 includes, but is not limited to, an enterprise application that is associated with the one or more enterprise servers 104 and which facilitates user access to the one or more user accounts in addition to user management of the one or more user accounts. The enterprise application includes a mobile application that facilitates establishment of a secure connection between client device 102 and one or more enterprise servers 104.

One or more data stores 216 are operable to store one or more types of data. Client device 102 may include one or more interfaces that facilitate one or more systems or modules thereof to transform, manage, retrieve, modify, add, or delete, the data residing in one or more data stores 216. One or more data stores 216 may include volatile and/or non-volatile memory. Examples of suitable data stores 216 include, but are not limited to RAM (Random Access Memory), flash memory, ROM (Read Only Memory), PROM (Programmable Read-Only Memory), (Erasable Programmable Read-Only Memory), EEPROM (Electrically Erasable Programmable Read-Only Memory), registers, magnetic disks, optical disks, hard drives, or any other suitable storage medium, or any combination thereof. One or more data stores 216 may be a component of one or more processors 202, or alternatively, may be operatively connected to one or more processors 202 for use thereby. As set forth, described, and/or illustrated herein, “operatively connected” may include direct or indirect connections, including connections without direct physical contact.

SMS module 218 is operable to facilitate user transmission and receipt of text messages via client device 102 though communications network 106. In one example embodiment, a user may receive text messages from the enterprise that are associated with the user access and the user management of the one or more user accounts.

Email module 220 is operable to facilitate user transmission and receipt of email messages via client device 102 through communications network 106. In one example embodiment, a user may receive email messages from the enterprise that are associated with the user access and the user management of the one or more user accounts.

Web browser module 222 is operable to facilitate user access to one or more websites associated with the enterprise through communications network 106.

I/O hub 206 is operable to connect to other systems and subsystems of client device 102. I/O hub 206 may include one or more of an input interface, an output interface, and a network controller to facilitate communications between client device 102 and one or more enterprise servers 104. The input interface and the output interface may be integrated as a single, unitary user interface 224, or alternatively, be separate as independent interfaces that are operatively connected.

The input interface enable information and/or data to be entered as input commands by a user in a manner that directs one or more processors 202 to execute instructions. The input interface may include a user interface (UI), a graphical user interface (GUI), such as, for example, a display, human-machine interface (HMI), or the like. Embodiments, however, are not limited thereto, and thus, this disclosure contemplates the input interface including a keypad, touch screen, multi-touch screen, button, joystick, mouse, trackball, microphone, and/or combinations thereof.

The output interface may include one or more of a visual display or an audio display, including, but not limited to, a microphone, earphone, and/or speaker. One or more components of client device 102 may serve as both a component of the input interface and a component of the output interface.

Network interface 208 is operable to facilitate connection to communications network 106.

Power source 210 includes at least one of a wired powered source, a wireless power source, a replaceable battery source, a rechargeable battery source, and combinations thereof.

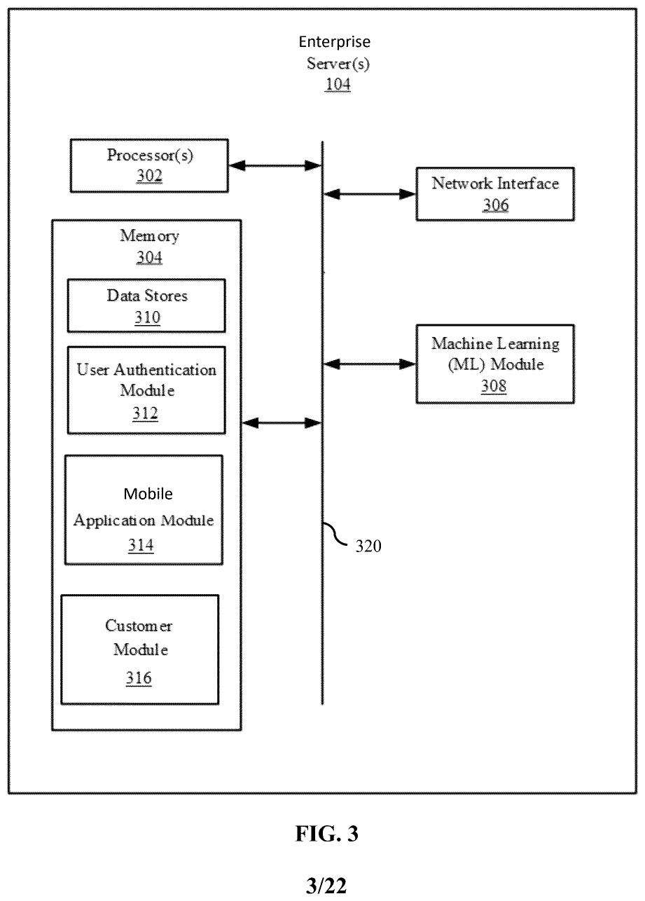

FIG. 3 illustrates a block diagram of one or more enterprise servers 104. It will be understood that it is not necessary for each server in one or more enterprise servers 104 to have all the elements illustrated in FIG. 3. For example, each server in one or more enterprise servers 104 may have any combination of the various elements illustrated in FIG. 3. Moreover, each server in one or more enterprise servers 104 may have additional elements to those illustrated in FIG. 3.

As illustrated in FIG. 3, one or more enterprise servers 104 includes one or more processors 302, a non-transitory memory 304 operatively coupled to one or more processors 302, a network interface 306, a machine learning (ML) module 308, and a communication bus 320.

In this example, one or more processors 302, non-transitory memory 304, network interface 306, and ML module 308 are illustrated as individual elements of one or more enterprise servers 104. However, in one or more embodiments, at least two of one or more processors 302, non-transitory memory 304, network interface 306, and ML module 308 may be combined as a unitary device. Further, in one or more embodiments, at least one of one or more processors 302, non-transitory memory 304, network interface 306, and ML module 308 may be implemented as a computer having non-transitory computer-readable media for carrying or having computer-executable instructions or data structures stored thereon.

In the figure, one or more processors 302, non-transitory memory 304, network interface 306, and ML module 308 are configured to communicate with one another via communication bus 226.

Non-transitory memory 304 includes a set of instructions of computer-executable program code, one or more data stores 310, a user authentication module 312, and a mobile application module 314.

In this example, one or more data stores 310, a user authentication module 312, and a mobile application module 314 are illustrated as individual elements of non-transitory memory 304. However, in one or more embodiments, at least two of one or more data stores 310, a user authentication module 312, and a mobile application module 314 may be combined as a unitary element.

The set of instructions in non-transitory memory 304 are executable by one or more processors 302 in manner that facilitates control of a user authentication module 312 and a mobile application module 314 having one or more mobile applications that reside in non-transitory memory 304.

One or more data stores 310 are operable to store one or more types of data, including but not limited to, user account data and user authentication data. One or more data stores 310 may include volatile and/or non-volatile memory. Examples of suitable data stores 310 include, but are not limited to RAM, flash memory, ROM, PROM, EPROM, EEPROM, registers, magnetic disks, optical disks, hard drives, or any other suitable storage medium, or any combination thereof. One or more data stores 310 may be a component of one or more processors 302, or alternatively, may be operatively connected to one or more processors 302 for use thereby. As set forth, described, and/or illustrated herein, “operatively connected” may include direct or indirect connections, including connections without direct physical contact.

The computer-executable program code may instruct one or more processors 302 to cause user authentication module 312 to authenticate a user in order to gain user access to the one or more user accounts. User authentication module 312 may be caused to request user input user data or user identification that include, but are not limited to, user identity (e.g., user name), a user passcode, a cookie, user biometric data, a private key, a token, and/or another suitable authentication data or information.

The computer-executable program code of the one or more mobile applications of mobile application module 314 may instruct one or more processors 302 to execute certain logic, data-processing, and data-storing functions of one or more enterprise servers 104, in addition to certain communication functions of one or more enterprise servers 104. The one or more mobile applications of mobile application module 314 are operable to communicate with client device 102 in a manner which facilitates user access to the one or more user accounts in addition to user management of the one or more user accounts based on successful user authentication.

In accordance with one or more embodiments set forth, described, and/or illustrated herein, communications network 106 may include a wireless network, a wired network, or any suitable combination thereof. For example, communications network 106 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

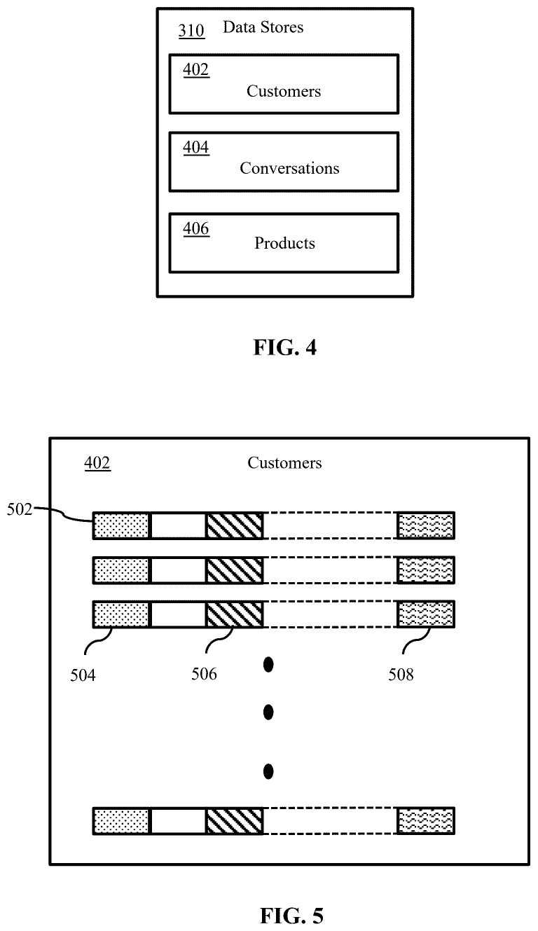

FIG. 4 illustrates a block diagram of data stores 310. As shown in the figure, data stores 310 includes a customers data storage 402, a conversations data storage 404, and a products/services data storage 406.

Customers data storage 402 may be configured to store data associated with each individual customer, non-limiting examples of which include: customer name; customer address; customer phone number(s); customer email address(es); customer start date; customer payment history; customer account limit; customer account number; customer classification; and enterprise product(s) of the customer. This will be described in greater detail with reference to FIG. 5.

FIG. 5 illustrates a block diagram of customers data storage 402 of data stores 310. As shown in the figure, customers data storage 402 includes a plurality of customer data structures, a sample of which is indicated as customer data structure 502. Each customer data structure corresponds to a distinct respective customer of the enterprise. Furthermore, each customer data structure includes distinct data portions corresponding to respective distinct data of a respective customer as discussed above.

In one or more embodiments, each customer data structure includes: a customer name data portion, a sample of which is indicated as customer name data portion 504; a customer classification data portion, a sample of which is indicated as customer classification data portion 506; and customer products/services data portion, a sample of which is indicated as customer products/services data portion 508.

In one or more embodiments, the customer name data portion identifies the name of the customer.

In one or more embodiments, the customer classification data portion identifies the classification of the customer. An enterprise may classify customers by any known method, non-limiting examples of which include regulatory classifications, risk-based classifications, demographic and behavioral classifications, and customer value classifications, and combinations thereof.

Regulatory classifications may include, for example: retail clients such as individual customers; professional clients such as large companies and pension fund managers; and institutional clients such as banks and insurance companies.

Risk-based classifications may include, for example: low-risk customers such as individuals or entities with straightforward financial needs and transparent backgrounds; medium-risk customers such as customers requiring more scrutiny due to their financial activities or profile; and high-risk customers such as customers posing greater risk due to factors such as their occupation, transaction patterns, or geographic location.

Demographic and behavioral classifications may include, for example: age groups, wherein customers are segmented based on their age, e.g., young professions, retirees; income levels, wherein customers are segmented by their income or wealth; geographic location, wherein customers are segmented based on where they live or work; and behavioral patterns, wherein customers are segmented based on their banking habits, product usage, and transaction history.

Customer value classifications may include, for example: loyal customers, such as those that represent a small percentage of the total customers, but contribute significantly more revenue to the enterprise; impulse customers, such as those who make spontaneous purchases and are receptive to upselling; discount customers, such as those who are price-sensitive and primarily seek out deals and promotions; and need-based customers, such as those who make purchases based on specific requirements.

In one or more embodiments, the customer products/services data portion identifies the enterprise products/services of which the customer currently uses. Non-limiting examples of enterprise products/services include: deposit accounts including savings accounts, checking accounts, money market accounts, and certificates of deposit (CDs); loans including personal loans, home loans, auto loans, business loans, and home equity loans; credit products/services including credit cards and lines of credit; investment products/services including mutual funds, exchange-traded funds (ETFs), stocks, and bonds; foreign exchange services including currency exchange and foreign currency accounts; wealth management products/services including personal management trusts and investment management accounts; insurance products/services including life insurance trusts; business services products/services including cash management solutions, payroll services, and merchant services; digital banking products/services including online and mobile banking platforms and digital payment solutions; and specialized account products/services including individual retirement accounts (IRAs) and business accounts.

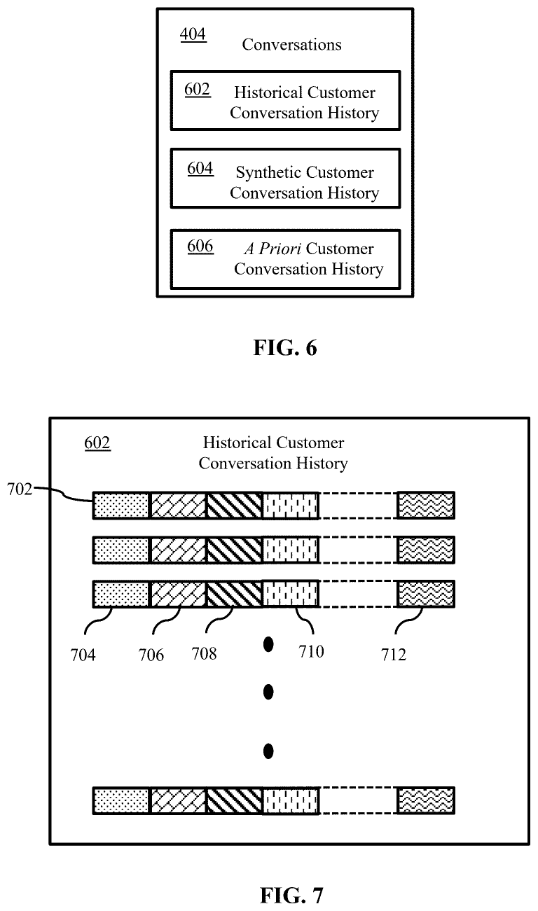

Returning to FIG. 4, conversations data storage 404 may be configured to store data associated with conversations. This will be described in greater detail with reference to FIG. 6.

FIG. 6 illustrates a block diagram of conversations data storage 404 of data stores 310. As shown in the figure, conversations data storage 404 includes a historical customer conversation (HCC) history data storage 602, a synthetic customer conversation (SCC) history data storage 604, and an a priori customer conversation (APCC) history data storage 606.

HCC history data storage 602 may be configured to store data associated with conversations between the enterprise and each individual customer, non-limiting examples of which include: image data of an image file, for example of a portable document format (pdf) file of a text to an employee of the enterprise from a customer or of a text from an employee of the enterprise to a customer; text data of a text file, for example of a plain text (TXT) file of an email or text from a mobile phone to an employee of the enterprise from a customer, or from an email or text from a mobile phone from an employee of the enterprise to a customer; audio data of an audio file, for example of a waveform audio file format (WAV) file of a recorded phone message to an employee of the enterprise from a customer or from a recorded phone message from an employee of the enterprise to a customer; text data of a text file, for example of a TXT file of notes provided by an enterprise employee regarding a customer; video data of a video file, for example an MP4 (MPEG 4) file of a video meeting between an enterprise employee and a customer; and audio data of an audio file, for example a WAV file of a recorded voice input message provided by an enterprise employee regarding a customer. This will be described in greater detail with reference to FIG. 7.

FIG. 7 illustrates a block diagram of HCC history data storage 602 of conversations data storage 404. As shown in the figure, HCC history data storage 602 includes a plurality of HCC data structures, a sample of which is indicated as HCC data structure 702. Each HCC data structure corresponds to a distinct respective conversation associated with a customer of the enterprise. Furthermore, each HCC data structure includes distinct data portions corresponding to respective distinct data of a respective customer conversation as discussed above.

In one or more embodiments, each HCC data structure includes: a customer name data portion, a sample of which is indicated as customer name data portion 704; a customer classification data portion, a sample of which is indicated as customer classification data portion 706; a conversation type data portion, a sample of which is indicated as conversation type data portion 708; a date/time data portion, as sample of which is indicated as date/time data portion 710; and a conversation payload data portion, a sample of which is indicated as conversation payload data portion 712.

In one or more embodiments, the customer name data portion identifies the name of the customer associated with the HCC of the HCC data structure.

In one or more embodiments, the customer classification data portion identifies the classification of the customer associated with the HCC of the HCC data structure.

In one or more embodiments, the conversation type data portion identifies the data type of the customer communication, e.g., image data, text data, audio data, video data, of the conversation payload portion of the HCC data structure. In one or more embodiments, the conversation type data portion indicates the type of encoding, e.g., image, text, audio, video, of the data within the conversation payload data portion of the HCC data structure.

In one or more embodiments, the date/time data portion identifies at least one of the date and time of the HCC of the HCC data structure.

In one or more embodiments, the conversation payload data portion is the actual data of the historical communication, e.g.: image data of the image file, non-limiting examples of which include image data in at least one of a joint photographic experts group (JPEG) format, a portable network graphics (PNG) format, a graphics interchange format (GIF), a bitmap format, a tagged image file format (TIFF), a WebP format, an AV1 image file format (AVIF), a scalable vector graphics (SVG) format, and a portable document format (PDF); text data of the text file, non-limiting examples of which include text data in at least one of plaint text (TXT) format, a comma-separated values (CSV) format, a JavaScript Object Notation (JSON) format, an extensible Markup Language (XML) format, a rich text format (RTF), a tab-separated values (TSV) format, and a hypertext markup language (HTML) format; audio data of the audio file, non-limiting examples of which include audio data in at least one of a waveform audio file format (WAV), an audio interchange file format (AIFF), a pulse code modulation (PCM) format, a free lossless audio codec (FLAC) format, an Apple lossless audio codec (ALAC) format, a WavPack format, an MPEG layer III audio (MP3) format, an advanced audio coding (AAC) format, an Opus format, a direct stream digital (DSD) format, an OGG Vorbis format, and an M4A format; video data of the video file, non-limiting examples of which include an MPEG-4 (MP4) format, a QuickTime Movie (MOV) format, an audio video interleave (AVI) format, a Windows media video (WMV) format, an advanced video coding high definition (AVCHD) format, a Matroska video (MKV) format, a web media (WEBM) format, a Flash video (FLV/F4V/SWF) format, and an MPEG-2 format, of the HCC data structure.

Returning to FIG. 6, SCC history data storage 604 may be configured to store SCC data associated with communications between the enterprise and at least one customer.

Synthetic data is used to train machine learning algorithms when real data is difficult or expensive to obtain, or when privacy concerns restrict access to actual data. Accordingly, SCC data, as used herein, is artificially generated customer conversation data that mimics the patterns and characteristics of HCC data.

SCC data may be generated by any known method, non-limiting examples of which include: the use of generative models including generation via a generative adversarial network (GAN), generation via a variational autoencoder (VAE), and generation via an autoregressive model; the use of statistical distribution methods that involve analyzing the statistical properties of HCC data (e.g., mean, variance) and generating new data points that follow the same distribution; and generation via agent-based modeling that involves fitting HCC data to known distributions or models to generate SCC data that mimics real-world behaviors of the HCC data.

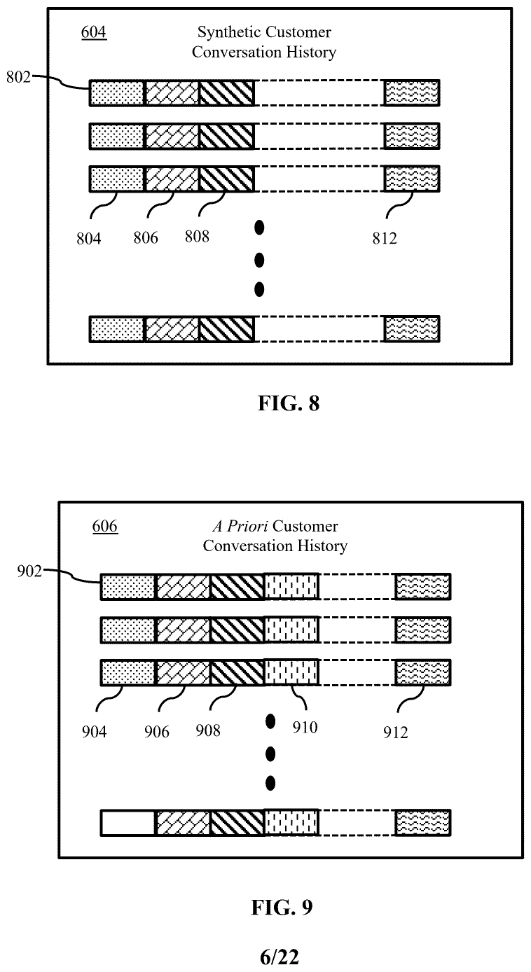

In one or more embodiments, non-limiting examples of synthetic data associated with communication between the enterprise and at least one customer that may be stored in SCC history data storage 604 include: synthetic data derived from HCC history data of an image file, for example of a pdf file of a text to an employee of the enterprise from a customer or of a text from an employee of the enterprise to a customer; synthetic data derived from HCC history data of a text file, for example of a TXT file of an email or text from a mobile phone to an employee of the enterprise from a customer, or from an email or text from a mobile phone from an employee of the enterprise to a customer; synthetic data derived from HCC history data of an audio file, for example of a WAV file of a recorded phone message to an employee of the enterprise from a customer or from a recorded phone message from an employee of the enterprise to a customer; synthetic data derived from HCC history data of a text file, for example of a TXT file of notes provided by an enterprise employee regarding a customer; synthetic data derived from HCC history data of a video file, for example an MP4 file of a video meeting between an enterprise employee and a customer; and synthetic data derived from HCC history data of an audio file, for example a WAV file of a recorded voice input message provided by an enterprise employee regarding a customer. This will be described in greater detail with reference to FIG. 8.

FIG. 8 illustrates a block diagram of SCC history data storage 604 of conversations data storage 404. As shown in the figure, SCC history data storage 604 includes a plurality of synthetic customer conversation data structures, a sample of which is indicated as synthetic customer conversation data structure 802. Each synthetic customer conversation data structure corresponds to a distinct respective synthetic conversation associated with a synthetic customer of the enterprise. Furthermore, each synthetic customer conversation data structure includes distinct data portions corresponding to respective distinct data of a respective SCC as discussed above.

In one or more embodiments, each SCC data structure includes: a synthetic customer name data portion, a sample of which is indicated as synthetic customer name data portion 804; a synthetic customer classification data portion, a sample of which is indicated as synthetic customer classification data portion 806; a conversation type data portion, a sample of which is indicated as conversation type data portion 808; a synthetic date/time data portion, as sample of which is indicated as synthetic date/time data portion 810; and a conversation payload data portion, a sample of which is indicated as conversation payload data portion 812.

In one or more embodiments, the synthetic customer name data portion identifies the name of the synthetic customer associated with the SCC of the SCC data structure.

In one or more embodiments, the synthetic customer classification data portion identifies the synthetic classification of the synthetic customer associated with the SCC of the SCC data structure.

In one or more embodiments, the conversation type data portion identifies the type of communication in a manner similar to the conversation type data portion discussed above with reference to the HCC data structures of FIG. 7.

In one or more embodiments, the date/time data portion identifies at least one of the date and time of the SCC of the synthetic HCC data structure.

In one or more embodiments, the conversation payload data portion is the actual data of the synthetic communication, which is similar to the conversation payload data portion discussed above with reference to the HCC data structures of FIG. 7.

Returning to FIG. 6, APCC history data storage 606 may be configured to store APCC data associated with a priori communications.

APCC data, as used herein, refers to customer conversation data associated with a fictional conversation between a fictional customer, i.e., not a real customer, and a fictional enterprise employee, i.e., not a real enterprise employee. APCC data may be derived from logical reasoning and known facts rather than from HCC data or from SCC data.

APCC data may be generated by any known method, a non-limiting examples of which includes generating via a generative pretrained transformer.

In one or more embodiments, non-limiting examples of APCC data associated with conversations that may be stored in APCC history data storage 606 include: APCC data derived from an image file, for example of a pdf file of a text to a fictional employee of the enterprise from a fictional customer that was generated by a generative pre-trained transformer or of a text from a fictional employee of the enterprise to a fictional customer that was generated by a generative pre-trained transformer; APCC data derived from a text file, for example of a TXT file of a fictional email or fictional text from a fictional mobile phone to a fictional employee of the enterprise from a fictional customer that was generated by a generative pre-trained transformer, or from a fictional email or fictional text from a fictional mobile phone from a fictional employee of the enterprise to a fictional customer that was generated by a generative pre-trained transformer; APCC data derived from an audio file, for example of a WAV file of a fictional phone message to a fictional employee of the enterprise from a customer or from a recorded phone message from an employee of the enterprise to a fictional customer that was generated by a generative pre-trained transformer; APCC data derived from a text file, for example of a TXT file of fictional notes provided by a fictional enterprise employee regarding a fictional customer that was generated by a generative pre-trained transformer; APCC data derived from a video file, for example an MP4 file of a fictional video meeting between a fictional enterprise employee and a fictional customer that was generated by a generative pre-trained transformer; and APCC data derived from an audio file, for example a WAV file of a fictional voice input message provided by a fictional enterprise employee regarding a fictional customer that was generated by a generative pre-trained transformer. This will be described in greater detail with reference to FIG. 9.

FIG. 9 illustrates a block diagram of the APCC history data storage 606 of the conversations data storage 404. As shown in the figure, APCC history data storage 606 includes a plurality of APCC data structures, a sample of which is indicated as APCC data structure 902. Each APCC data structure corresponds to a distinct respective APCC associated with a fictional customer of the enterprise. Furthermore, each APCC data structure includes distinct data portions corresponding to respective distinct data of a respective APCC as discussed above.

In one or more embodiments, each APCC data structure includes: a fictional customer name data portion, a sample of which is indicated as fictional customer name data portion 904; a fictional customer classification data portion, a sample of which is indicated as fictional customer classification data portion 906; a conversation type data portion, a sample of which is indicated as conversation type data portion 908; an fictional date/time data portion, as sample of which is indicated as fictional date/time data portion 910; and a conversation payload data portion, a sample of which is indicated as conversation payload data portion 912.

In one or more embodiments, the fictional customer name data portion identifies the name of the fictional customer associated with the fictional customer conversation of the APCC data structure.

In one or more embodiments, the fictional customer classification data portion identifies the classification of the fictional customer associated with the fictional customer conversation of the APCC data structure.

In one or more embodiments, the conversation type data portion identifies the type of communication in a manner similar to the conversation type data portion discussed above with reference to the HCC data structures of FIG. 7.

In one or more embodiments, the date/time data portion identifies at least one of the date and time of the fictional customer conversation data structure.

In one or more embodiments, the conversation payload data portion is the actual data of the synthetic communication, which is similar to the conversation payload data portion discussed above with reference to the HCC data structures of FIG. 7.

Returning to FIG. 4, products/services data storage 406 may be configured to store data associated with enterprise products/services and promotions provided by the enterprise, non-limiting examples of which include a promotion title or a product title, customer qualification, an introductory rate, an introductory time window, a standard rate, a transfer rate, a credit limit, a change in credit limit, cash-back reward amount, cash-back reward requirement, travel points reward amount, travel points reward requirement, and combinations thereof. Non-limiting examples of enterprise products/services include: deposit accounts including savings accounts, checking accounts, money market accounts, and certificates of deposit (CDs); loans including personal loans, home loans, auto loans, business loans, and home equity loans; credit products/services including credit cards and lines of credit; investment products/services including mutual funds, exchange-traded funds (ETFs), stocks, and bonds; foreign exchange services including currency exchange and foreign currency accounts; wealth management products/services including personal management trusts and investment management accounts; insurance products/services including life insurance trusts; business services products/services including cash management solutions, payroll services, and merchant services; digital banking products/services including online and mobile banking platforms and digital payment solutions; and specialized account products/services including individual retirement accounts (IRAs) and business accounts.

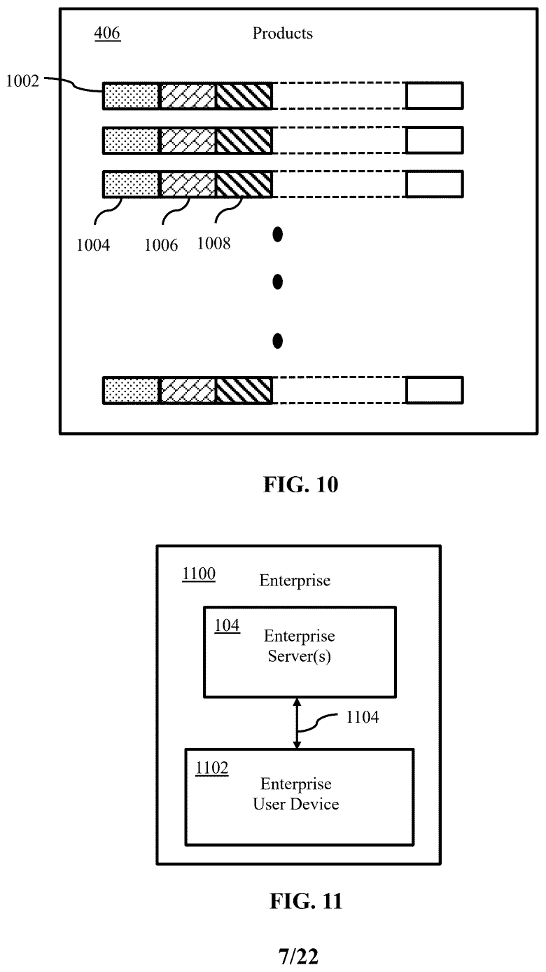

FIG. 10 illustrates a block diagram of products/services data storage 406 of data stores 310. As shown in the figure, products/services data storage 406 includes a plurality of product/service data structures, a sample of which is indicated as product/service data structure 1002. Each product/service data structure corresponds to a distinct respective product offered by the enterprise. Furthermore, each product/service data structure includes distinct data portions corresponding to respective distinct data of a respective product.

In one or more embodiments, each product/service data structure includes: a product name data portion, a sample of which is indicated as product name data portion 1004; a product classification data portion, a sample of which is indicated as product classification data portion 1006; and a product description data portion, a sample of which is indicated as product description data portion 1008.

In one or more embodiments, the product name data portion identifies the name of the enterprise product provided by the enterprise that is associated with the product/service data structure.

In one or more embodiments, the product classification data portion identifies the customer classification, or classifications, that qualify for the enterprise product provided by the enterprise that is associated with the product/service data structure.

In one or more embodiments, the product description data portion includes data describing the enterprise product provided by the enterprise that is associated with the product/service data structure.

In accordance with aspects of the present disclosure, a computer-implemented method consistently and accurately categorizes customers, based on customer conversations, so as to match customers with available enterprise products/services/services that will optimize the financial interest of the customer and the financial interest of the enterprise.

In accordance with aspects of the present disclosure, a computer-implemented method trains a machine learning (ML) algorithm with a plurality of customer conversations from a plurality of customers of an enterprise that have each been previously classified as one respective type of customer classification within a plurality of types of customer classifications.

The plurality of customer conversations that are used to train the ML algorithm may include customer conversations of a plurality of conversations channels, non-limiting examples of which include phone calls, texts, emails, video conferences, and in-person visits. The plurality of customer conversations that may be used to train the ML algorithm may include customer conversations that include historical customer conversations, synthetic customer conversations, a priori customer conversations, and combinations thereof.

In accordance with aspects of the present disclosure, once the ML algorithm is trained to classify a customer based on previous conversations of that customer, a computer-implemented method then implements the ML algorithm to classify a previously unclassified customer of the enterprise a one type of customer classification within a plurality of types of customer classifications.

In accordance with aspects of the present disclosure, a computer-implemented method then determines enterprise products/services/services offered by the enterprise for which the newly classified customer qualifies, based on the classification of the customer.

In accordance with aspects of the present disclosure, a computer-implemented method then generates a product signal that causes a user interface, such as a display, to display a message based on the products/services/services offered by the enterprise for which the newly classified customer qualifies.

In this manner, when the customer communicates with an employee of the enterprise, a user device of the employee may populate with information related to available products/services/services of the enterprise for which the customer qualifies, and that may match the interests of the customer based on past conversations with the customer. This may identify high-value customers from multi-channel conversations, and may improve classification accuracy. Further, the credit card customer may be more likely to use other products/services and services, increasing overall revenue for the enterprise, and strengthening the long-term, profitable relationship between the enterprise and the customer.

A non-limiting example of a computer-implemented method consistently and accurately categorizes customers, based on customer conversations, so as to match customers with available enterprise products/services that will optimize the financial interest of the customer and the financial interest of the enterprise, in accordance with aspects of the present disclosure will now be described in greater detail with additional reference to FIGS. 11-30C.

FIG. 11 illustrates a block diagram of an example enterprise 1100 having one or more enterprise servers 104, an enterprise user device 1102, and a communication channel 1104.

One or more enterprise servers 104 are configured to communicate with enterprise user device 1102 via communication channel 1104.

Enterprise user device 1102 may be any device or system that is operable to enable a user to access and interact with one or more enterprise servers 104. Non-limiting examples of enterprise user device 1102 include a computer or client device.

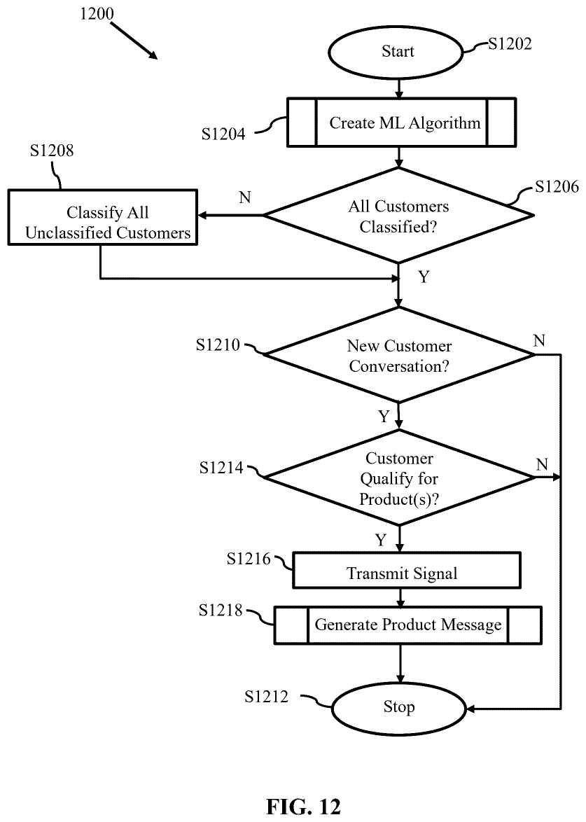

FIG. 12 illustrates an example computer-implemented method 1200 of generating a product message for an enterprise customer based on a customer classification, which is based on a conversation history in accordance with aspects of the present disclosure.

As shown in the figure, computer-implemented method 1200 starts (S1202) and a machine learning (ML) algorithm is created (S1204). For example, returning to FIG. 3, one or more processors 302 may execute instructions in ML module 308 to cause one or more processors 302 to create a ML algorithm to classify customers based on customer conversations.

Consider a conventional situation, wherein the enterprise is a bank, and wherein a bank teller may classify a customer, Francis Blue, based on the bank teller's access to Francis Blue's address data, his employer data, and his account balance/transaction data. From this data, for purposes of discussion, let the bank teller classify Francis Blue as a low-risk, young professional, discount customer, who lives and works in a suburb of New York city. Further, let this classification of Francis Blue qualify him for some products/services of the bank, which may generate a small profit for the bank, while also generating a small amount of capital for Francis Blue.

Suppose, for purposes of discussion, that this classification is not accurate, wherein Francis Blue may qualify for additional bank products/services, which may generate much larger profit for the bank, while also generating a larger amount of capital for Francis Blue. Unfortunately, the current classification of Francis Blue is based on a limited amount of information, and was the result of an inconsistent opinion of a bank teller. As such, Francis Blue is losing out on other products/services for which he would qualify, thus reducing the amount of profit for the bank and reducing the amount of generated capital for Francis Blue.

Consider a situation in accordance with aspects of the present disclosure, wherein the enterprise is a bank, and wherein one or more servers of the bank may classify a customer, Tammy Greenfield, using an ML algorithm that analyzes previous conversations of Tammy Greenfield.

For example, for purposes of discussion, let Tammy have had many different conversations with many different employees of the bank over a time period, wherein the many different conversations are from many different conversation channels, such as: an email to a bank employee, wherein she writes “I won't be back in the area for a few months, because I'm going to be staying at my vacation condo in Bermuda,”; a recorded phone call with another bank employee, wherein she states “my endowment policy with my insurance company should cash-out in about 18 months. I'm thinking of maybe buying another home with it”; or notes from yet another bank employee describing an in-person visit with Tammy, wherein Tammy made a statement that “it sucks having to pay $125,000 in federal taxes every year.”

In this example, no employee might be privy to each conversation with Tammy. Accordingly, there may not be any employee that is able to individually determine Tammy's entire financial situation. Even more importantly, if there are hundreds of communications from Tammy, a person would unlikely be able so spot particular patterns of statements that would enable to the employee to accurately classify Tammy based on her hundreds of communications.

In accordance with aspects of the present disclosure, one or more servers of the bank may train an ML algorithm communications from customers, each of which has a current respective customer classification. In one or more embodiments, the customer communications used to train the ML algorithm include: historical customer communications from actual customers; synthetic customer communications that are derived from historical customer communications; a priori customer communications that are created based on fictional customers; and combinations thereof.

In accordance with aspects of the present disclosure, the trained ML algorithm may analyze all of Tammy's communications, which include many different communications from many different communication channels, and classify Tammy as one type of customer classification from a plurality different customer classifications. This classification of Tammy Greenfield would qualify her for all products/services of the bank, which may generate maximize profit for the bank, while also maximizing capital for Tammy Greenfield. As such, Tammy Greenfield would not lose out on other products/services for which she would qualify.

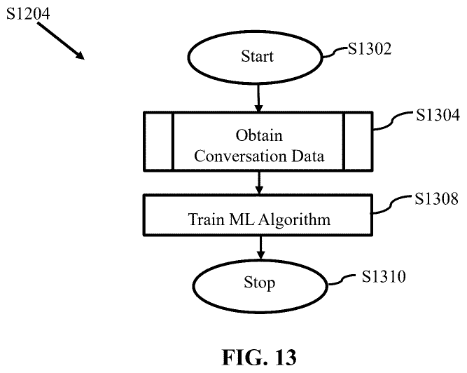

A non-limiting example of a computer-implemented system and method for classifying a customer of an enterprise, based on that customer's communication history with the enterprise, in order to match the customer with products/services of the enterprise will now be described in greater detail with reference to FIGS. 13-21.

FIG. 13 illustrates an example computer-implemented method S1204 of creating a ML algorithm in computer-implemented method 1200.

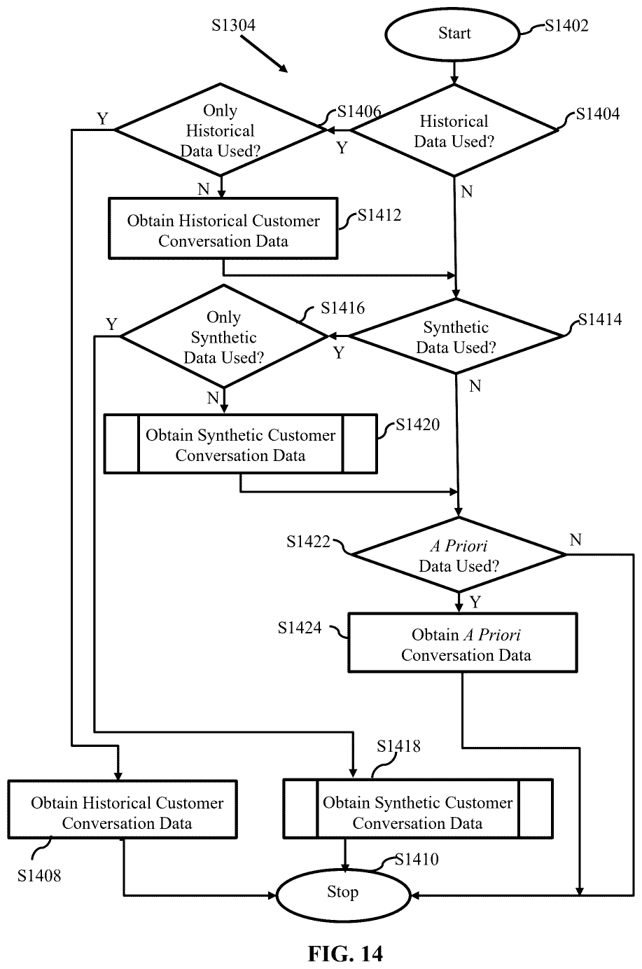

As shown in the figure, computer-implemented method S1204 starts (S1302), and conversation data is obtained (S1304). For example, returning to FIG. 3, one or more processors 302 may execute instructions in ML module 308 to cause one or more processors 302 to obtain conversation data. This will be described in greater detail with reference to FIGS. 14-21.

FIG. 14 illustrates an example computer-implemented method of obtaining conversation data of the method of obtaining conversation data S1304.

As shown in the figure, computer-implemented method S1304 starts (S1402), and it is determined whether HCC data is to be used (S1404). For example, returning to FIG. 3, one or more processors 302 may execute instructions in ML module 308 to determine whether HCC data is to be used to train an ML algorithm within ML module 308 to classify a customer based on that customer's communication history.

In one or more embodiments, instructions within ML module 308 may indicate: whether HCC data is to be used to train an ML algorithm within ML module 308 to classify a customer based on that customer's communication history; whether only HCC data is to be used to train an ML algorithm within ML module 308 to classify a customer based on that customer's communication history; whether SCC data is to be used train an ML algorithm within ML module 308 to classify a customer based on that customer's communication history; whether only SCC data is to be used train an ML algorithm within ML module 308 to classify a customer based on that customer's communication history; whether APCC data is to be used train an ML algorithm within ML module 308 to classify a customer based on that customer's communication history; and whether only APCC data is to be used train an ML algorithm within ML module 308 to classify a customer based on that customer's communication history.

Returning to FIG. 14, if it is determined that HCC data is to be used (Y at S1404), it is determined whether only HCC data is to be used (S1406). For example, returning to FIG. 3, one or more processors 302 may execute instructions in ML module 308 to determine whether only HCC data is to be used to train an ML algorithm within ML module 308 to classify a customer based on that customer's communication history.

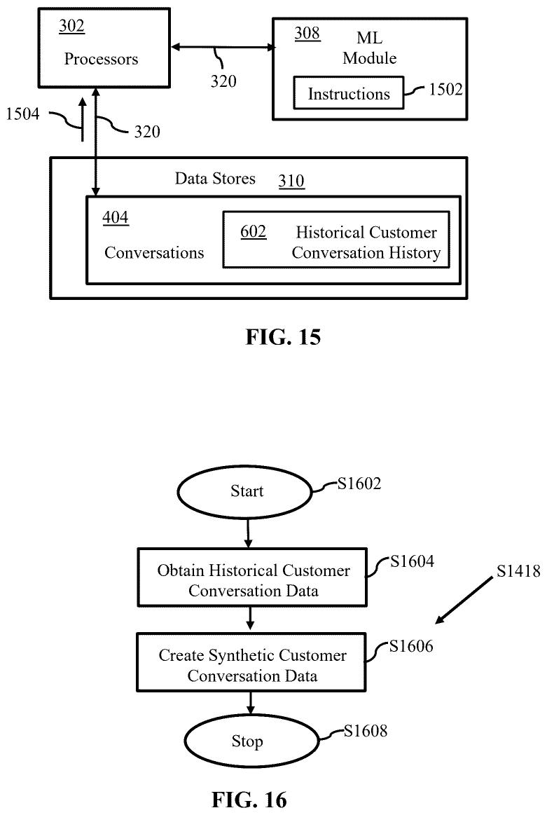

If it is determined that only HCC data is to be used (Y at S1406), HCC data is obtained (S1408). For example, returning to FIG. 3, one or more processors 302 may execute instructions in ML module 308 to obtain HCC data. This will be described in greater detail with reference to FIG. 15.

FIG. 15 illustrates a block diagram of one or more processors 302, conversations data storage 404 within data stores 310 and ML module 308 for obtaining HCC data in accordance with aspects of the present disclosure. Customer module 316 includes instructions 1502 stored therein.

HCC data, as used herein, is data that is based on customer conversation information collected from past events, situations, or phenomena that have been previously recorded or recorded over a previous time period.

In one or more embodiments, one or more processors 302 may execute instructions 1502 in ML module 308 to cause one or more enterprise servers 104 to obtain HCC data 1504 from HCC history data storage 602 within conversations data storage 404 within data stores 310.

In operation, the entire customer conversation data for each customer may be stored as many different types of data files, non-limiting examples of which include: image files, for example, image files of texts from a customer; text files, for example from emails or texts from mobile phones from the customer; audio files from recorded phone messages from the customer; text files based on notes provided by an enterprise employee during an engagement with the customer; and audio files from a recorded voice input message provided by an enterprise employee during an engagement with the customer. These different types of data files are the multiple different types of communication channels with the customer.

In one or more embodiments, an ML algorithm within ML module 308 may be trained using a predetermined integer of conversations from a predetermined integer of all customers. This would decrease the processing resources and time required to train the ML algorithm. As such, ML module 308 may include instructions 1502 to cause one or more processors 302 to obtain HCC data 1504 as a predetermined integer of HCC data structures N₁ from HCC history data storage 602, which correspond to respective HCCs, and which are associated with a predetermined integer of customers M₁ of the enterprise. In one or more embodiments, ML module 308 may include instructions 1502 to cause one or more processors 302 to establish the value for at least one of N₁ and M₁. In one or more embodiments, ML module 308 may include instructions 1502 to cause one or more processors 302 to change an established respective value for at least one of N₁ and M₁.

For purposes of explanation only, consider the following first non-liming example.

Let the predetermined integer of HCC data structures N₁ be 50, and let the predetermined integer of customers M₁ be 1,000. Returning to FIG. 7, ML module 308 may include instructions 1502 to cause one or more processors 302 to obtain the predetermined integer of HCCs N₁ of 50 from each of the predetermined integer of customers M₁ of 1,000. As such, in this example, 50,000 HCCs would be obtained.

As such, in this example, ML module 308 may include instructions 1502 to cause one or more processors 302 to: search the customer name data portion (e.g., customer name data portion 704) of the HCC data structures (e.g., HCC data structure 702) within HCC history data storage 602 to identify all customers; identify customers of all customers that have at least 50 HCC data structures; identify 1,000 customers from the identified customers that have at least 50 HCC data structures; identify 50 HCC data structures from each of the identified 1,000 customers; and then retrieve the 50,000 identified HCC data structures from HCC history data storage 602.

As will be described in more detail below, in one or more embodiments, the retrieved 50,000 HCC data structures, which, from this example, correspond to a predetermined integer of HCCs from a predetermined integer of customers, may be used to train a machine learning (ML) algorithm within ML module 308.

Returning to FIG. 15, in one or more embodiments, an ML algorithm within ML module 308 may be trained using a predetermined ratio of conversations from a predetermined integer of all customers. This would be an alternative method to decrease the processing resources and time required to train the ML algorithm. As such, ML module 308 may include instructions 1502 to cause one or more processors 302 to obtain HCC data 1504 as a predetermined ratio of HCC data structures R_{con1} of all HCC data structures from HCC history data storage 602, which correspond to respective HCCs, and which are associated with a predetermined integer of customers M₂ of the enterprise. In one or more embodiments, ML module 308 may include instructions 1502 to cause one or more processors 302 to establish the value for R_{con1}. In one or more embodiments, ML module 308 may include instructions 1502 to cause one or more processors 302 to change an established value for R_{con1}.

For purposes of explanation only, consider the following second non-liming example.

Let the predetermined ratio of HCC data structures R_{con1} be 1/100, and let the predetermined integer of customers M₂ be 10,000. Returning to FIG. 7, ML module 308 may include instructions 1502 to cause one or more processors 302 to obtain the predetermined ratio of HCC data structures R_{con1} of 1/100 of all the HCCs from the predetermined integer of customers M₂ of 1,000 customers. For purposes of discussion only, in this example, let the 10,000 customers have a total of 6,345,700 HCCs. As such, in this example, 63,457 HCCs would be obtained.

As such, in this example, ML module 308 may include instructions 1502 to cause one or more processors 302 to: search the customer name data portion (e.g., customer name data portion 704) of the HCC data structures (e.g., HCC data structure 702) within HCC history data storage 602 to identify 10,000 customers; identify all HCC data structures from each of the identified 10,000 customers, which in this example would be 6,345,700 HCC data structures; and then retrieve 1 identified HCC data structure out of every 100 identified HCC data structures, which in this example would be 63,457 retrieved HCC data structures.

As will be described in more detail below, in one or more embodiments, the retrieved 63,457 HCC data structures, which, from this example, correspond to a predetermined ratio of HCCs from a predetermined integer of customers, may be used to train a ML algorithm within ML module 308.

Returning to FIG. 15, in one or more embodiments, an ML algorithm within ML module 308 may be trained using all conversations from a predetermined integer of all customers. While using all conversations, this method may nevertheless decrease the processing resources and time required to train the ML algorithm because the communications from all customers are not used. Further, this method may increase the likelihood of the ML algorithm to identify patterns as an entire communication history for each of the predetermined integer of customers being analyzed will be taken into account. As such, ML module 308 may include instructions 1502 to cause one or more processors 302 to obtain HCC data 1504 as all HCC data structures from HCC history data storage 602, which correspond to all respective HCCs, and which are associated with a predetermined integer of customers M₃ of the enterprise. In one or more embodiments, ML module 308 may include instructions 1502 to cause one or more processors 302 to establish the value for M₃. In one or more embodiments, ML module 308 may include instructions 1502 to cause one or more processors 302 to change an established value for M₃.

For purposes of explanation only, consider the following third non-liming example.

Let the predetermined integer of customers M₃ be 1,000, and let the 1,000 customers have a total number of 875,447 historical customer communications. Returning to FIG. 7, ML module 308 may include instructions 1502 to cause one or more processors 302 to obtain the 875,447 HCCs from the predetermined integer of customers M₃ of 1,000.

As such, ML module 308 may include instructions 1502 to cause one or more processors 302 to: search the customer name data portion (e.g., customer name data portion 704) of the HCC data structures (e.g., HCC data structure 702) within HCC history data storage 602 to identify 1,000 customers; identify all HCC data structures from each of the identified 1,000 customers, which in this example is 875,447 HCC data structures; and then retrieve the 875,447 identified HCC data structures from HCC history data storage 602.

As will be described in more detail below, in one or more embodiments, the retrieved 875,447 HCC data structures, which, from this example correspond to all HCCs from a predetermined integer of customers, may be used to train a ML algorithm within ML module 308.

Returning to FIG. 15, in one or more embodiments, an ML algorithm within ML module 308 may be trained using all conversations from a predetermined ratio of all customers. While using all conversations, this method may nevertheless decrease the processing resources and time required to train the ML algorithm because the communications from all customers are not used. Further, this method may increase the likelihood of the ML algorithm to identify patterns as an entire communication history for each of the predetermined ratio of customers being analyzed will be taken into account. As such, ML module 308 may include instructions 1502 to cause one or more processors 302 to obtain HCC data 1504 as all HCC data structures from HCC history data storage 602, which correspond to all respective HCCs, and which are associated with a predetermined ratio of customers R_{cus1} of all the customers of the enterprise. In one or more embodiments, ML module 308 may include instructions 1502 to cause one or more processors 302 to establish the value for R_{cus1}. In one or more embodiments, ML module 308 may include instructions 1502 to cause one or more processors 302 to change an established value for R_{cus1}.

For purposes of explanation only, consider the following fourth non-liming example.

Let the predetermined ratio of customers R_{cus1} be 1/100, and let there be 52,300 customers. Therefore, all HCC data structures from 523 customers, or 1/100^{th} of the total 52,300 customers, would be obtained. In this example, let the 523 customers have a total number of 972,386 historical customer communications.

Returning to FIG. 7, ML module 308 may include instructions 1502 to cause one or more processors 302 to obtain the 972,386 HCCs from the predetermined ratio of customers R_{cus1} of 1/100 of the total 52,300 customers, which in this case would be 523 customers.

As such, ML module 308 may include instructions 1502 to cause one or more processors 302 to: search the customer name data portion (e.g., customer name data portion 704) of the HCC data structures (e.g., HCC data structure 702) within HCC history data storage 602 to identify all 52,300 customers; identify 1 customer out of every 100 customers, which in this case is 523 customers; identify all HCC data structures from each of the identified 523 customers, which in this example is 972,386 HCC data structures; and then retrieve the 972,386 identified HCC data structures from HCC history data storage 602.

As will be described in more detail below, in one or more embodiments, the retrieved 972,386 HCC data structures, which, in this example, correspond to all HCCs from a predetermined ratio of customers, may be used to train a ML algorithm within ML module 308.

Returning to FIG. 15, in one or more embodiments, an ML algorithm within ML module 308 may be trained using a predetermined integer of conversations from all customers. This method may additionally decrease the processing resources and time required to train the ML algorithm because not all the communications from all customers are used. As such, ML module 308 may include instructions 1502 to cause one or more processors 302 to obtain HCC data 1504 as a predetermined integer of HCC data structures N₂ of all HCC data structures from HCC history data storage 602, which correspond to respective HCCs, and which are associated with every customer of the enterprise that has at least N₂ respective associated customer conversation data structures within HCC history data storage 602. In one or more embodiments, ML module 308 may include instructions 1502 to cause one or more processors 302 to establish the value for N₂. In one or more embodiments, ML module 308 may include instructions 1502 to cause one or more processors 302 to change an established value for N₂.

For purposes of explanation only, consider the following fifth non-liming example.

Let the predetermined integer of HCC data structures N₂ be 125, and let there be 18,705 customers that have at least 125 respective associated customer conversation data structures within HCC history data storage 602. Therefore, 125 HCC data structures from 18,705 customers, or 2,338,125 HCC data structures, would be obtained.

Returning to FIG. 7, ML module 308 may include instructions 1502 to cause one or more processors 302 to obtain the predetermined integer of HCC data structures N₂ of 125 of HCCs from the total 18,705 customers, which in this case would be 2,338,125 HCC data structures.

As such, ML module 308 may include instructions 1502 to cause one or more processors 302 to: search the customer name data portion (e.g., customer name data portion 704) of the HCC data structures (e.g., HCC data structure 702) within HCC history data storage 602 to identify all customers; identify from all the customers, the customers that are associated with at least 125 HCC data structures, which in this example is 18,705 customers; identify 125 HCC data structures from each of the identified 18,705 customers, which in this example is 2,338,125 HCC data structures; and then retrieve the 2,338,125 identified HCC data structures from HCC history data storage 602.

As will be described in more detail below, in one or more embodiments, the retrieved 2,338,125 HCC data structures, which, in this example, are from a predetermined integer of HCCs from every customer that has at least the predetermined integer of HCCs, may be used to train a ML algorithm within ML module 308.

Returning to FIG. 15, in one or more embodiments, an ML algorithm within ML module 308 may be trained using a ratio conversations from all customers. This method may additionally decrease the processing resources and time required to train the ML algorithm because not all communications from all customers are. As such, ML module 308 may include instructions 1502 to cause one or more processors 302 to obtain HCC data 1504 as a predetermined ratio of HCC data structures R_{con2} of all HCC data structures from HCC history data storage 602 of each customer, which correspond to respective HCCs associated with each customer, and which are associated with every customer of the enterprise. In one or more embodiments, ML module 308 may include instructions 1502 to cause one or more processors 302 to establish the value for R_{con2}. In one or more embodiments, ML module 308 may include instructions 1502 to cause one or more processors 302 to change an established value for R_{con2}.

For purposes of explanation only, consider the following sixth non-liming example.

Let the predetermined ratio of HCC data structures R_{con2} of all HCC data structures be 1/100, and let there be a total of 7,526,400 HCC data structures for all customers. Therefore, 1/100^{th} of all 7,526,400 HCC data structures, or 75,264 HCC data structures, would be obtained.

Returning to FIG. 7, ML module 308 may include instructions 1502 to cause one or more processors 302 to obtain the predetermined ratio of HCC data structures R_{con2} of 1/100^{th} of all 7,526,400 HCCs data structures, which in this case would be 75,264 HCC data structures.

As such, ML module 308 may include instructions 1502 to cause one or more processors 302 to: identify all 7,526,400 HCC data structures (e.g., HCC data structure 702) within HCC history data storage 602; identify 1 HCC data structures out of every 100 HCC data structures; and then retrieve the 75,264 identified HCC data structures from HCC history data storage 602.

As will be described in more detail below, in one or more embodiments, the retrieved 75,264 HCC data structures, which, in this example, correspond to a predetermined ratio of HCCs of all HCCs from all customers, may be used to train a ML algorithm within ML module 308.

Returning to FIG. 15, in one or more embodiments, an ML algorithm within ML module 308 may be trained using a predetermined integer of conversations of a particular type from a predetermined integer of customers. This method may decrease the processing resources and time required to train the ML algorithm because not all communications from all customers are used. Further, this method may focus the training of the ML algorithm to identify patterns from a specific communication channel for which the enterprise deems particularly important. As such, ML module 308 may include instructions 1502 to cause one or more processors 302 to obtain HCC data 1504 as a predetermined integer of HCC data structures N₃ from HCC history data storage 602, which correspond to respective HCCs, whose respective conversation type data portions identify a predetermined data type of the customer communication, e.g.: image data of an image file, for example of a pdf file of a text to an employee of the enterprise from a customer or of a text from an employee of the enterprise to a customer; text data of a text file, for example of a TXT file of an email or text from a mobile phone to an employee of the enterprise from a customer, or from an email or text from a mobile phone from an employee of the enterprise to a customer; audio data of an audio file, for example of a WAV file of a recorded phone message to an employee of the enterprise from a customer or from a recorded phone message from an employee of the enterprise to a customer; text data of a text file, for example of a TXT file of notes provided by an enterprise employee regarding a customer; video data of a video file, for example an MP4 file of a video meeting between an enterprise employee and a customer; and audio data of an audio file, for example a WAV file of a recorded voice input message provided by an enterprise employee regarding a customer, and which are associated with a predetermined integer of customers M₄ of the enterprise that have at least N₃ respective associated customer conversation data structures of the particular data type. In one or more embodiments, ML module 308 may include instructions 1502 to cause one or more processors 302 to establish the value for at least one of N₃ and M₄. In one or more embodiments, ML module 308 may include instructions 1502 to cause one or more processors 302 to change an established respective value for at least one of N₃ and M₄.

For purposes of explanation only, consider the following seventh non-liming example.

Let the predetermined integer of HCC data structures N₃ be 100, let the predetermined data type of the customer communication be text data, and let the predetermined integer of customers M₄ be 1,000.

Returning to FIG. 7, ML module 308 may include instructions 1502 to cause one or more processors 302 to obtain the integer of HCC data structures N₃ of 100 that correspond to a customer conversation being text data from the predetermined integer of customers M₄ of 1,000 of customers that have at least 100 HCC data structures of a text file type.

As such, ML module 308 may include instructions 1502 to cause one or more processors 302 to: identify all customers via customer name data portion 704 of each HCC data structure (e.g., HCC data structure 702) from all HCC data structures within HCC history data storage 602; identify all HCC data structures within HCC history data storage 602 that correspond to a customer conversation being text data via the conversation type data portion 708; identify 1,000 of all identified customers that have at least 100 HCC data structures that correspond to a customer conversation being text data; and then retrieve the 100,000 identified HCC data structures from HCC history data storage 602.

As will be described in more detail below, in one or more embodiments, the retrieved 100,00 HCC data structures, which in this example correspond to a predetermined integer of HCC data structures corresponding to HCCs of a particular data type from a predetermined integer of customers, may be used to train a ML algorithm within ML module 308.

Returning to FIG. 15, in one or more embodiments, an ML algorithm within ML module 308 may be trained using a predetermined ratio of conversations of a particular type from a predetermined integer of customers. This method may decrease the processing resources and time required to train the ML algorithm because not all communications from all customers are used. Further, this method may focus the training of the ML algorithm to identify patterns from a specific communication channel for which the enterprise deems particularly important. As such, ML module 308 may include instructions 1502 to cause one or more processors 302 to obtain HCC data 1504 as a predetermined ratio of HCC data structures R_{con3} of all HCC data structures from HCC history data storage 602, which correspond to HCCs of a particular data type, and which are associated with a predetermined integer of customers M₅ of the enterprise. In one or more embodiments, ML module 308 may include instructions 1502 to cause one or more processors 302 to establish the value for at least one of R_{con3} and M₅. In one or more embodiments, ML module 308 may include instructions 1502 to cause one or more processors 302 to change an established respective value for at least one of R_{con3} and M₅.

For purposes of explanation only, consider the following eighth non-liming example.

Let the particular data type of customer conversation be image files, let the predetermined integer of customers M₅ be 1,000, and let the predetermined ratio of HCC data structures R_{con3} be 1/100 of all HCC data structures of the 1,000 customers that correspond to a customer conversation being an image file.

Returning to FIG. 7, ML module 308 may include instructions 1502 to cause one or more processors 302 to obtain the ratio of HCC data structures R_{con3} of 1/100 of all HCC data structures that correspond to a customer conversation being an image file from the predetermined integer of customers M₅ of 1,000.

As such, ML module 308 may include instructions 1502 to cause one or more processors 302 to: identify all customers via customer name data portion 704 of each HCC data structure (e.g., HCC data structure 702) from all HCC data structures within HCC history data storage 602; identify all HCC data structures within HCC history data storage 602 that correspond to a customer conversation being an image file via the conversation type data portion 708; identify 1,000 of all identified customers that have HCC data structures that correspond to a customer conversation being an image file; identify all HCC data structures that correspond to a customer conversation being an image file from the identified 1,000 customers, wherein in this example, let there be 526,900 such HCC data structures; identify the predetermined ratio of HCC data structures R_{con3} of 1/100 of all 526,900 of the identified HCC data structures that correspond to a customer conversation being an image file from the identified 1,000 customers, which in this case would be 5,269; and then retrieve 5,269 identified HCC data structures from HCC history data storage 602.

As will be described in more detail below, in one or more embodiments, the retrieved 5,269 HCC data structures, which in this example correspond to a predetermined ratio of HCCs of 1/100 of all HCCs that correspond to an image file conversation from 1000 customers, may be used to train a ML algorithm within ML module 308.

Returning to FIG. 15, in one or more embodiments, an ML algorithm within ML module 308 may be trained using a predetermined ratio of conversations of a particular type from a predetermined ratio of customers. This method may decrease the processing resources and time required to train the ML algorithm because not all communications from all customers are used. Further, this method may focus the training of the ML algorithm to identify patterns from a specific communication channel for which the enterprise deems particularly important. As such, ML module 308 may include instructions 1502 to cause one or more processors 302 to obtain HCC data 1504 as a predetermined ratio of HCC data structures R_{con4} of all HCC data structures from HCC history data storage 602, whose respective conversation type data portions identify a predetermined data type of the customer communication, of all HCC data structures, whose respective conversation type data portions identify the predetermined data type of the customer communication, and which are associated with a predetermined ratio of customers R_{cus2} of all the customers that have at least one HCC, whose respective conversation type data portion identifies the predetermined data type of the customer communication. In one or more embodiments, ML module 308 may include instructions 1502 to cause one or more processors 302 to establish the value for at least one of R_{con4} and R_{cus2}. In one or more embodiments, ML module 308 may include instructions 1502 to cause one or more processors 302 to change an established respective value for at least one of R_{con4} and R_{cus2}.

For purposes of explanation only, consider the following ninth non-liming example.

Let the particular data type of customer conversation be text files, let the predetermined ratio of customers R_{cus2} be 1/20 of all customers, and let the predetermined ratio of HCC data structures R_{con4} be 1/100 of all HCC data structures of the 1/20 of all customers that correspond to a customer conversation being a text file.

Returning to FIG. 7, ML module 308 may include instructions 1502 to cause one or more processors 302 to obtain the ratio of HCC data structures R_{con4} of 1/100 of all HCC data structures that correspond to a customer conversation being a text file from the predetermined ratio of customers R_{cus2} of 1/20 of all customers.

As such, ML module 308 may include instructions 1502 to cause one or more processors 302 to: identify all customers via customer name data portion 704 of each HCC data structure (e.g., HCC data structure 702) from all HCC data structures within HCC history data storage 602, wherein in this example, let there be 25,286 total customers; identify all HCC data structures within HCC history data storage 602 that correspond to a customer conversation being a text file via the conversation type data portion 708; identify all customers, out of all identified customers, that have HCC data structures that correspond to a customer conversation being a text file, wherein in this example, let there be 22,840 customers; identify the predetermined ratio of customers R_{cus2} of 1/20 of all identified customers that have HCC data structures that correspond to a customer conversation being a text file, which in this example would be 1,142; identify all HCC data structures that correspond to a customer conversation being a text file from the identified 1,142 customers, wherein in this example, let there be 9,200 such HCC data structures; identify the predetermined ratio of HCC data structures R_{con3} of 1/100 of all 9,200 of the identified HCC data structures that correspond to a customer conversation being text file from the identified 1,142 customers, which in this case would be 92; and then retrieve the 92 identified HCC data structures from HCC history data storage 602.

As will be described in more detail below, in one or more embodiments, the retrieved 92 HCC data structures, which in this example correspond to a predetermined ratio of HCCs of 1/100 of all HCCs that correspond to a text file conversation from a predetermined ratio of customers of 1/20 of all customers, may be used to train a ML algorithm within ML module 308.

Returning to FIG. 15, in one or more embodiments, an ML algorithm within ML module 308 may be trained using every conversation of a particular type from a predetermined integer of customers. This method may decrease the processing resources and time required to train the ML algorithm because not all communications from all customers are used. Further, this method may focus the training of the ML algorithm to identify patterns from a specific communication channel for which the enterprise deems particularly important. As such, ML module 308 may include instructions 1502 to cause one or more processors 302 to obtain HCC data 1504 as every HCC data structure from HCC history data storage 602, whose respective conversation type data portion identifies a predetermined data type of the customer communication, and which is associated with a predetermined integer of customers M₆ that have at least one HCC, whose conversation type data portion identify the predetermined data type of the customer communication. In one or more embodiments, ML module 308 may include instructions 1502 to cause one or more processors 302 to establish the value for M₆. In one or more embodiments, ML module 308 may include instructions 1502 to cause one or more processors 302 to change an established value for M₆.

For purposes of explanation only, consider the following tenth non-liming example.

Let the particular data type of customer conversation be text files, and let the predetermined integer of customers M₆ be 10,000 customers.

Returning to FIG. 7, ML module 308 may include instructions 1502 to cause one or more processors 302 to obtain all HCC data structures that correspond to a customer conversation being a text file from the predetermined integer of customers M₆ of 10,000 customers.

As such, ML module 308 may include instructions 1502 to cause one or more processors 302 to: identify all customers via customer name data portion 704 of each HCC data structure (e.g., HCC data structure 702) from all HCC data structures within HCC history data storage 602, wherein in this example, let there be 25,286 total customers; identify all HCC data structures within HCC history data storage 602 that correspond to a customer conversation being a text file via the conversation type data portion 708; identify all customers, out of all identified customers, that have HCC data structures that correspond to a customer conversation being a text file, wherein in this example, let there be 22,840 customers; identify the predetermined integer of customers M₆ of 10,000 of all identified customers that have HCC data structures that correspond to a customer conversation being a text file; identify all HCC data structures that correspond to a customer conversation being a text file from the identified 10,000 customers, wherein in this example, let there be 40,326 such HCC data structures; and then retrieve the 40,326 identified HCC data structures from HCC history data storage 602.

As will be described in more detail below, in one or more embodiments, the retrieved 40,326 HCC data structures, which in this example correspond to all HCCs that correspond to a text file conversation from a predetermined integer of customers, may be used to train a ML algorithm within ML module 308.

Returning to FIG. 15, in one or more embodiments, an ML algorithm within ML module 308 may be trained using every conversation of a particular type from a predetermined ratio of customers. This method may decrease the processing resources and time required to train the ML algorithm because not all communications from all customers are used. Further, this method may focus the training of the ML algorithm to identify patterns from a specific communication channel for which the enterprise deems particularly important. As such, ML module 308 may include instructions 1502 to cause one or more processors 302 to obtain HCC data 1504 as every HCC data structure from HCC history data storage 602, whose respective conversation type data portions identify a predetermined data type of the customer communication, and which is associated with a predetermined ratio of customers Rouss of all the customers that have an HCC, whose respective conversation type data portions identify the predetermined data type of the customer communication. In one or more embodiments, ML module 308 may include instructions 1502 to cause one or more processors 302 to establish the value for R_{cus3}. In one or more embodiments, ML module 308 may include instructions 1502 to cause one or more processors 302 to change an established value for R_{cus3}.

For purposes of explanation only, consider the following eleventh non-liming example.

Let the particular data type of customer conversation be text files, and let the predetermined ratio of customers R_{cus3} be 4/5 customers.

Returning to FIG. 7, ML module 308 may include instructions 1502 to cause one or more processors 302 to obtain all HCC data structures that correspond to a customer conversation being a text file from the predetermined ratio of customers R_{cus3} of 4/5 customers of the customers that have a customer conversation as a text file.

As such, ML module 308 may include instructions 1502 to cause one or more processors 302 to: identify all customers via customer name data portion 704 of each HCC data structure (e.g., HCC data structure 702) from all HCC data structures within HCC history data storage 602, wherein in this example, there are 28,445 total customers; identify all HCC data structures within HCC history data storage 602 that correspond to a customer conversation being a text file via the conversation type data portion 708; identify all customers, out of all 28,445 identified customers, that have HCC data structures that correspond to a customer conversation being a text file, wherein in this example, let there be 19,645 customers; identify the predetermined ratio of customers R_{cus3} of 4/5 of all 19,645 identified customers that have HCC data structures that correspond to a customer conversation being a text file; identify all HCC data structures that correspond to a customer conversation being a text file from the identified 19,645 customers, wherein in this example, let there be 117,870 such HCC data structures; and then retrieve the 117,870 identified HCC data structures from HCC history data storage 602.

As will be described in more detail below, in one or more embodiments, the retrieved 117,870 HCC data structures, which this example correspond to all HCCs that correspond to a text file from a predetermined ratio of customers that have HCCs that correspond to a particular data type of file, may be used to train a ML algorithm within ML module 308.

Returning to FIG. 15, in one or more embodiments, an ML algorithm within ML module 308 may be trained using a predetermined integer of conversations of a particular type from every customer. This method may decrease the processing resources and time required to train the ML algorithm because not all communications from all customers are used. Further, this method may focus the training of the ML algorithm to identify patterns from a specific communication channel for which the enterprise deems particularly important. As such, ML module 308 may include instructions 1502 to cause one or more processors 302 to obtain HCC data 1504 as a predetermined integer of HCC data structures N₄ of all HCC data structures from HCC history data storage 602, which correspond to respective HCCs, whose respective conversation type data portions identify a predetermined data type of the customer communication, and which are associated with every customer of the enterprise that has had at least the predetermined integer N₄ of HCCs, whose respective conversation type data portions identify the predetermined data type of the customer communication. In one or more embodiments, ML module 308 may include instructions 1502 to cause one or more processors 302 to establish the value for N₄. In one or more embodiments, ML module 308 may include instructions 1502 to cause one or more processors 302 to change an established value for N₄.

For purposes of explanation only, consider the following twelfth non-liming example.

Let the particular data type of customer conversation be text files, let the predetermined integer of HCC data structures N₄ be 20, and let there be 21,123 customers that each have at least 20 associated HCC data structures that correspond to a text file type conversation.

Returning to FIG. 7, ML module 308 may include instructions 1502 to cause one or more processors 302 to obtain 20 HCC data structures that correspond to a customer conversation being a text file from each of the 21,123 the customers that have a customer conversation as a text file.

As such, ML module 308 may include instructions 1502 to cause one or more processors 302 to: identify all customers via customer name data portion 704 of each HCC data structure (e.g., HCC data structure 702) from all HCC data structures within HCC history data storage 602; identify all HCC data structures within HCC history data storage 602 that correspond to a customer conversation being a text file via the conversation type data portion 708; identify customers out of all customers, that have at least 20 HCC data structures that correspond to a customer conversation being a text file, wherein in this example, there are 21,123 customers; identify 20 HCC data structures that correspond to a customer conversation being a text file from each of the identified 21,123 customers, wherein in this example, there would be 211,230 such HCC data structures; and then retrieve the 211,230 identified HCC data structures from HCC history data storage 602.

As will be described in more detail below, in one or more embodiments, the retrieved 211,230 HCC data structures, which in this example correspond to a predetermined integer of HCCs that correspond to a text file from all customers that have at least the predetermined integer of HCCs that correspond to particular data type of file, may be used to train a ML algorithm within ML module 308.

Returning to FIG. 15, in one or more embodiments, an ML algorithm within ML module 308 may be trained using a predetermined ratio of conversations of a particular type from every customer. This method may decrease the processing resources and time required to train the ML algorithm because not all communications from all customers are used. Further, this method may focus the training of the ML algorithm to identify patterns from a specific communication channel for which the enterprise deems particularly important. As such, ML module 308 may include instructions 1502 to cause one or more processors 302 to obtain HCC data 1504 as a predetermined ratio of HCC data structures R_{con5} of all HCC data structures from HCC history data storage 602, whose respective conversation type data portions identify a predetermined data type of the customer communication, of all HCC data structures, whose respective conversation type data portions identify the predetermined data type of the customer communication, that are associated with every customer of the enterprise that has at least one HCC data structure, whose conversation type data portion identifies the predetermined data type of the customer communication. In one or more embodiments, ML module 308 may include instructions 1502 to cause one or more processors 302 to establish the value for R_{con5}. In one or more embodiments, ML module 308 may include instructions 1502 to cause one or more processors 302 to change an established value for R_{con4}.

For purposes of explanation only, consider the following thirteenth non-liming example.

Let the particular data type of customer conversation be text files, and let the predetermined ratio of HCC data structures R_{con5} be 1/100 of all HCC data structures of all customers that correspond to a customer conversation being a text file.

Returning to FIG. 7, ML module 308 may include instructions 1502 to cause one or more processors 302 to obtain the ratio of HCC data structures R_{con5} of 1/100 of all HCC data structures that correspond to a customer conversation being a text file from all customers that have a customer conversating being a text file.

As such, ML module 308 may include instructions 1502 to cause one or more processors 302 to: identify all customers via customer name data portion 704 of each HCC data structure (e.g., HCC data structure 702) from all HCC data structures within HCC history data storage 602, wherein in this example, let there be 25,286 total customers; identify all HCC data structures within HCC history data storage 602 that correspond to a customer conversation being a text file via the conversation type data portion 708; identify all customers, out of all identified customers, that have HCC data structures that correspond to a customer conversation being a text file, wherein in this example, let there be 22,840 customers; identify all HCC data structures that correspond to a customer conversation being a text file from the identified 22,840 customers, wherein in this example, let there be 137,400 such HCC data structures; identify the predetermined ratio of HCC data structures R_{con4} of 1/100 of all 137,400 of the identified HCC data structures that correspond to a customer conversation being text file from the identified 22,840 customers, which in this case would be 1,374; and then retrieve the 1,374 identified HCC data structures from HCC history data storage 602.

As will be described in more detail below, in one or more embodiments, the retrieved 1,374 HCC data structures, which in this example correspond to a predetermined ratio of HCCs that correspond to a particular data type of file conversation from all customers that are associated with at least one customer conversation of that particular data type, may be used to train a ML algorithm within ML module 308.

Returning to FIG. 15, in one or more embodiments, an ML algorithm within ML module 308 may be trained using predetermined integers of conversations of different particular types from a different integers of customers. This method may decrease the processing resources and time required to train the ML algorithm because not all communications from all customers are used. Further, this method may focus the training of the ML algorithm to identify patterns from a plurality of different communication channels, wherein the different integers of obtained different channels may be weighted differently, as a function of their respective integers, for which the enterprise deems particularly important. As such, ML module 308 may include instructions 1502 to cause one or more processors 302 to obtain HCC data 1504 as: 1) a first predetermined integer of HCC data structures N₅ of all HCC data structures from HCC history data storage 602, which correspond to respective HCCs, whose respective conversation type data portions identify a first predetermined data type of the customer communication, that are associated with a first predetermined integer M₇ of customers of the enterprise; and 2) a second predetermined integer of HCC data structures N₆ of all HCC data structures from HCC history data storage 602, which correspond to respective HCCs, whose respective conversation type data portions identify a second predetermined data type of the customer communication, that are associated with a second predetermined integer M₈ of customers of the enterprise. For example, an integer M_{7I} of image files from each of the N₅ customers, an integer M_{8T} of text files from each of the N₆ customers, and so on. In one or more embodiments, M₇=M₈. In one or more embodiments M₇≠M₈. In one or more embodiments, N₅=N₆. In one or more embodiments N₅≠N₆. In one or more embodiments, ML module 308 may include instructions 1502 to cause one or more processors 302 to establish the value for at least one of N₅, N₆, M₇, and M₈. In one or more embodiments, ML module 308 may include instructions 1502 to cause one or more processors 302 to change an established respective value for at least one of N₅, N₆, M₇ and M₈.

For purposes of explanation only, consider the following fourteenth non-liming example.

Let the first particular data type of customer conversation be text files, let the first predetermined integer of HCC data structures N₅ be 500,000, let the first predetermined integer of customers M₇ be 10,000 customers, let the second particular data type of customer conversation be image files, let the second predetermined integer of HCC data structures N₆ be 80,000. and let the second predetermined integer of customers M₈ be 20,000 customers.

Returning to FIG. 7, ML module 308 may include instructions 1502 to cause one or more processors 302 to obtain 500,000 HCC data structures that correspond to a customer conversation being a text file from the first predetermined integer of customers M₇ of 10,000 and obtain 80.000 HCC data structures that correspond to a customer conversation being an image file from the second predetermined integer of customers M₈ of 20,000 customers.

As such, ML module 308 may include instructions 1502 to cause one or more processors 302 to: 1) identify all customers via customer name data portion 704 of each HCC data structure (e.g., HCC data structure 702) from all HCC data structures within HCC history data storage 602, wherein in this example, let there be 25,286 total customers; identify all HCC data structures within HCC history data storage 602 that correspond to a customer conversation being a text file via the conversation type data portion 708; identify all customers, out of all identified customers, that have HCC data structures that correspond to a customer conversation being a text file, wherein in this example, let there be 22,840 customers; identify the first predetermined integer of customers M₇ of 10,000 of all identified customers that have HCC data structures that correspond to a customer conversation being a text file; identify all HCC data structures that correspond to a customer conversation being a text file from the identified 10,000 customers, wherein in this example, let there be 621,801 such HCC data structures; identify the first predetermined integer of HCC data structures N₅ of 500,000 historical conversation data structures that correspond to a customer conversation being a text file of the identified 621,801 historical conversation data structures that correspond to a customer conversation being a text file; and then retrieve the 500,00 identified HCC data structures that correspond to a customer conversation being a text file from HCC history data storage 602; and 2) identify all HCC data structures within HCC history data storage 602 that correspond to a customer conversation being an image file via the conversation type data portion 708; identify all customers, out of all identified customers, that have HCC data structures that correspond to a customer conversation being an image file, wherein in this example, let there be 20,548 customers; identify the second predetermined integer of customers M₈ of 20,000 of all identified customers that have HCC data structures that correspond to a customer conversation being an image file; identify all HCC data structures that correspond to a customer conversation being an image file from the identified 20,000 customers, wherein in this example, let there be 130,285 such HCC data structures; identify the second predetermined integer of HCC data structures N₆ of 80,000 historical conversation data structures that correspond to a customer conversation being an image file of the identified 130,285 historical conversation data structures that correspond to a customer conversation being an image file; and then retrieve the 80,000 identified HCC data structures that correspond to a customer conversation being an image file from HCC history data storage 602.

As will be described in more detail below, in one or more embodiments, the retrieved 500,00 HCC data structures, which in this example correspond to a first predetermined integer of HCCs that correspond to a first type of conversation from a first predetermined integer of customers, in addition to the retrieved 80,000 HCC data structures, which in this example correspond to a second predetermined integer of HCCs that correspond to second type of conversation from a second predetermined integer of customers, may be used to train a ML algorithm within ML module 308.

Returning to FIG. 15, in one or more embodiments, an ML algorithm within ML module 308 may be trained using predetermined ratios of conversations of different particular types from a different integers of customers. This method may decrease the processing resources and time required to train the ML algorithm because not all communications from all customers are used. Further, this method may focus the training of the ML algorithm to identify patterns from a plurality of different communication channels, wherein the different ratios of obtained different channels may be weighted differently, as a function of their respective ratios, for which the enterprise deems particularly important. As such, ML module 308 may include instructions 1502 to cause one or more processors 302 to obtain HCC data 1504 as: 1) a first predetermined ratio of HCC data structures R_{con6} of all HCC data structures from HCC history data storage 602, whose respective conversation type data portions identify a first predetermined data type of the customer communication, of all HCC data structures, whose respective conversation type data portions identify the first predetermined data type of the customer communication, of all HCC data structures, whose respective conversation type data portions identify the predetermined data type of the customer communication, that are associated with a first predetermined integer M₉ of customers of the enterprise; and 2) a second predetermined ratio of HCC data structures R_{con7} of all HCC data structures from HCC history data storage 602, whose respective conversation type data portions identify a second predetermined data type of the customer communication, of all HCC data structures, whose respective conversation type data portions identify the second predetermined data type of the customer communication, that are associated with a second predetermined integer M₁₀ of customers of the enterprise. For example, a ratio R_{con6I} of image files of all image files from each of the M₉ customers, a ratio R_{con7T} of text files of all text files from each of the M₁₀ customers. In one or more embodiments, R_{con6}=R_{con7}. In one or more embodiments R_{con6}≠R_{con7}. In one or more embodiments, M₉=M₁₀. In one or more embodiments M₉≠M₁₀. In one or more embodiments, ML module 308 may include instructions 1502 to cause one or more processors 302 to establish the value for at least one of R_{con6}, R_{con7}, M₉, and M₁₀. In one or more embodiments, ML module 308 may include instructions 1502 to cause one or more processors 302 to change an established respective value for at least one of R_{con6}, R_{con7}, M₉, and M₁₀.

For purposes of explanation only, consider the following fifteenth non-liming example.

Let the first particular data type of customer conversation be image files, let the first predetermined integer of customers M₉ be 1,000, let the first predetermined ratio of HCC data structures R_{con6} be 1/100 of all HCC data structures of the 1,000 customers that correspond to a customer conversation being an image file, let the second particular data type of customer conversation be text files, let the second predetermined integer of customers M₁₀ be 2,000, and let the second predetermined ratio of HCC data structures R_{con7} be 1/50 of all HCC data structures of the 2,000 customers that correspond to a customer conversation being an text file.

Returning to FIG. 7, ML module 308 may include instructions 1502 to cause one or more processors 302 to: 1) obtain the first ratio of HCC data structures R_{con6} of 1/100 of all HCC data structures that correspond to a customer conversation being an image file from the first predetermined integer of customers M₉ of 1,000; and 2) obtain the second ratio of HCC data structures R_{con7} of 1/50 of all HCC data structures that correspond to a customer conversation being an text file from the second predetermined integer of customers M₁₀ of 2,000.

As such, ML module 308 may include instructions 1502 to cause one or more processors 302 to: 1) identify all customers via customer name data portion 704 of each HCC data structure (e.g., HCC data structure 702) from all HCC data structures within HCC history data storage 602; identify all HCC data structures within HCC history data storage 602 that correspond to a customer conversation being an image file via the conversation type data portion 708; identify 1,000 of all identified customers that have HCC data structures that correspond to a customer conversation being an image file; identify all HCC data structures that correspond to a customer conversation being an image file from the identified 1,000 customers, wherein in this example, let there be 526,900 such HCC data structures; identify the first predetermined ratio of HCC data structures R_{con6} of 1/100 of all 526,900 of the identified HCC data structures that correspond to a customer conversation being an image file from the identified 1,000 customers, which in this case would be 5,269; and then retrieve 5,269 identified HCC data structures from HCC history data storage 602; and 2) identify all HCC data structures within HCC history data storage 602 that correspond to a customer conversation being a text file via the conversation type data portion 708; identify 2,000 of all identified customers that have HCC data structures that correspond to a customer conversation being a text file; identify all HCC data structures that correspond to a customer conversation being text file from the identified 2,000 customers, wherein in this example, let there be 3,782,450 such HCC data structures; identify the second predetermined ratio of HCC data structures R_{con7} of 1/50 of all 3,782,450 of the identified HCC data structures that correspond to a customer conversation being a text file from the identified 20,000 customers, which in this case would be 75,649; and then retrieve 75,649 identified HCC data structures from HCC history data storage 602.

As will be described in more detail below, in one or more embodiments, the retrieved 5,269 HCC data structures, which in this example correspond to a first predetermined ratio of HCCs of all HCCs that correspond to a first type of conversation from a first predetermined integer of customers, and the retrieved 75,649 HCC data structures, which in this example correspond to a second predetermined ratio of HCCs of all HCCs that correspond to a second type of conversation from a second predetermined integer of customers, may be used to train a ML algorithm within ML module 308.

Returning to FIG. 15, in one or more embodiments, an ML algorithm within ML module 308 may be trained using predetermined integers of conversations of different particular types from all customers. This method may decrease the processing resources and time required to train the ML algorithm because not all communications from all customers are used. Further, this method may focus the training of the ML algorithm to identify patterns from a plurality of different communication channels, wherein the different integers of obtains different channels may be weighted differently, as a function of their respective integers, for which the enterprise deems particularly important. As such, ML module 308 may include instructions 1502 to cause one or more processors 302 to obtain HCC data 1504 as: 1) a predetermined integer of HCC data structures N₇ of all HCC data structures from HCC history data storage 602, which correspond to respective HCCs, whose respective conversation type data portions identify a first predetermined data type of the customer communication, that are associated with every customer of the enterprise; and 2) a predetermined integer of HCC data structures Ng of all HCC data structures from HCC history data storage 602, which correspond to respective HCCs, whose respective conversation type data portions identify a second predetermined data type of the customer communication, that are associated with every customer of the enterprise. For example, a first integer N₇ of image files from every customer, and a second integer N_{8T} of text files from every customer, and so on. In one or more embodiments, N₇=N₈. In one or more embodiments N₇≠N₈. In one or more embodiments, ML module 308 may include instructions 1502 to cause one or more processors 302 to establish the value for at least one of N₇ and N₈. In one or more embodiments, ML module 308 may include instructions 1502 to cause one or more processors 302 to change an established respective value for at least one of N₇ and N₈.

For purposes of explanation only, consider the following sixteenth non-liming example.

Let the first particular data type of customer conversation be text files, let the second particular data type of customer conversation be image files, let the first predetermined integer of HCC data structures N₇ be 500,000, and let the second predetermined integer of HCC data structures N₈ be 20,000.

Returning to FIG. 7, ML module 308 may include instructions 1502 to cause one or more processors 302 to obtain all HCC data structures that correspond to a customer conversation being a text file from the first predetermined integer of customers M₇ of 10,000 customers and obtain all HCC data structures that correspond to a customer conversation being an image file from the second predetermined integer of customers M₈ of 20,000 customers.

As such, ML module 308 may include instructions 1502 to cause one or more processors 302 to: 1) identify all customers via customer name data portion 704 of each HCC data structure (e.g., HCC data structure 702) from all HCC data structures within HCC history data storage 602, wherein in this example, let there be 25,286 total customers; identify all HCC data structures within HCC history data storage 602 that correspond to a customer conversation being a text file via the conversation type data portion 708; identify all customers, out of all identified customers, that have HCC data structures that correspond to a customer conversation being a text file, wherein in this example, let there be 22,840 customers; identify the first predetermined integer of customers M₇ of 10,000 of all identified customers that have HCC data structures that correspond to a customer conversation being a text file; identify all HCC data structures that correspond to a customer conversation being a text file from the identified 10,000 customers, wherein in this example, let there be 40,326 such HCC data structures; and then retrieve the 40,326 identified HCC data structures from HCC history data storage 602; and 2) identify all HCC data structures within HCC history data storage 602 that correspond to a customer conversation being an image file via the conversation type data portion 708; identify all customers, out of all identified customers, that have HCC data structures that correspond to a customer conversation being an image file, wherein in this example, let there be 21,412 customers; identify the second predetermined integer of customers M₈ of 20,000 of all identified customers that have HCC data structures that correspond to a customer conversation being an image file; identify all HCC data structures that correspond to a customer conversation being an image file from the identified 20,000 customers, wherein in this example, let there be 30,794 such HCC data structures; and then retrieve the 30,794 identified HCC data structures from HCC history data storage 602.

As will be described in more detail below, in one or more embodiments, the retrieved 40,326 HCC data structures, which in this example correspond to all HCCs that correspond to a first type of conversation from a first predetermined integer of customers, in addition to the retrieved 30,794 HCC data structures, which in this example correspond to all HCCs that correspond to second type of conversation from a second predetermined integer of customers, may be used to train a ML algorithm within ML module 308.

Returning to FIG. 15, in one or more embodiments, an ML algorithm within ML module 308 may be trained using predetermined ratios of conversations of different particular types from all customers. This method may decrease the processing resources and time required to train the ML algorithm because not all communications from all customers are used. Further, this method may focus the training of the ML algorithm to identify patterns from a plurality of different communication channels, wherein the different ratios of obtained different channels may be weighted differently, as a function of their respective ratios, for which the enterprise deems particularly important. As such, ML module 308 may include instructions 1502 to cause one or more processors 302 to obtain HCC data 1504 as: 1) a first predetermined ratio of HCC data structures R_{con8} of all HCC data structures from HCC history data storage 602, whose respective conversation type data portions identify a first predetermined data type of the customer communication, of all HCC data structures, whose respective conversation type data portions identify the first predetermined data type of the customer communication, of all HCC data structures, whose respective conversation type data portions identify the predetermined data type of the customer communication, that are associated with all customers of the enterprise; and 2) a second predetermined ratio of HCC data structures R_{con9} of all HCC data structures from HCC history data storage 602, whose respective conversation type data portions identify a first predetermined data type of the customer communication, of all HCC data structures, whose respective conversation type data portions identify the second predetermined data type of the customer communication, of all HCC data structures, whose respective conversation type data portions identify the predetermined data type of the customer communication, that are associated with all customers of the enterprise. For example, a ratio R_{con8I} of image files of all image files from all customers, a ratio R_{con9T} of text files of all text files from all customers. In one or more embodiments, R_{con8}=R_{con9}. In one or more embodiments R_{con8}≠R_{con9}. In one or more embodiments, ML module 308 may include instructions 1502 to cause one or more processors 302 to establish the value for at least one of R_{con8} and R_{con9}. In one or more embodiments, ML module 308 may include instructions 1502 to cause one or more processors 302 to change an established respective value for at least one of R_{con8} and R_{con9}.

For purposes of explanation only, consider the following seventeenth non-liming example.

Let there be 24,692 total customers, let the first particular data type of customer conversation be text files, let the first predetermined ratio of HCC data structures R_{con8} be 1/100 of all HCC data structures of the 24,692 total customers that correspond to a customer conversation being a text file, let the second particular data type of customer conversation be image files, and let the second predetermined ratio of HCC data structures R_{con8} be 1/50 of all HCC data structures of the 24,692 total customers that correspond to a customer conversation being an image file.

Returning to FIG. 7, ML module 308 may include instructions 1502 to cause one or more processors 302 to: 1) obtain the first ratio of HCC data structures R_{con8} of 1/100 of all HCC data structures that correspond to a customer conversation being a text file from all 24,692 customers; and 2) obtain the second ratio of HCC data structures R_{con9} of 1/50 of all HCC data structures that correspond to a customer conversation being a text file from all 24,692 customers.

As such, ML module 308 may include instructions 1502 to cause one or more processors 302 to: 1) identify all customers via customer name data portion 704 of each HCC data structure (e.g., HCC data structure 702) from all HCC data structures within HCC history data storage 602; identify all HCC data structures within HCC history data storage 602 that correspond to a customer conversation being a text file via the conversation type data portion 708; identify all HCC data structures that correspond to a customer conversation being a text file from all identified 24,692 customers, wherein in this example, let there be 4,215,800 such HCC data structures; identify the first predetermined ratio of HCC data structures R_{con8} of 1/100 of all 42,158 of the identified HCC data structures that correspond to a customer conversation being a text file from all identified 24,692 customers, which in this case would be 42,158 identified HCC data structures; and then retrieve the 42,158 identified HCC data structures from HCC history data storage 602; and 2) identify all HCC data structures within HCC history data storage 602 that correspond to a customer conversation being an image file via the conversation type data portion 708, wherein in this example, let there be 855,650 such HCC data structures; identify the second predetermined ratio of HCC data structures R_{con9} of 1/50 of all 855,650 of the identified HCC data structures that correspond to a customer conversation being an image file from all 24,692 customers, which in this case would be 17,113 identified HCC data structures; and then retrieve the 17,113 identified HCC data structures from HCC history data storage 602.

As will be described in more detail below, in one or more embodiments, the retrieved 42,158 HCC data structures, which in this example correspond to a first predetermined ratio of HCCs of all HCCs that correspond to a first type of conversation from all customers, and the retrieved 17,113 HCC data structures, which in this example correspond to a second predetermined ratio of HCCs of all HCCs that correspond to a second type of conversation from all customers, may be used to train a ML algorithm within ML module 308.

Returning to FIG. 14, after HCC data is obtained (S1408), computer-implemented method S1304 stops (S1410). For example, returning to FIG. 3, one or more processors 302 may execute instructions in ML module 308 to obtain HCC data.

As such, in one or more embodiments only HCC data is used to train an ML algorithm within ML module 308 to classify a customer based on that customer's communication history.

Returning to FIG. 14, if it is determined that not only HCC data is to be used (N at S1406), HCC data is obtained (S1412). This may be performed in a manner as discussed above (See S1408). After HCC data is obtained (S1412), or if it is determined that HCC data is not to be used (N at S1404), it is determined whether SCC data is to be used (S1414). For example, returning to FIG. 3, one or more processors 302 may execute instructions in ML module 308 determine whether SCC data is to be used to train an ML algorithm within ML module 308 to classify a customer based on that customer's communication history.

For example, in some instances there may be insufficient HCC data and/or APCC data to train an ML algorithm within ML module 308 to classify a customer based on that customer's communication history. In such cases, SCC data may be used to train an ML algorithm within ML module 308 to classify a customer based on that customer's communication history.

Returning to FIG. 14, if it is determined that SCC data is to be used (Y at S1414), it is determined whether only SCC data is to be used (S1416). For example, returning to FIG. 3, one or more processors 302 may execute instructions in ML module 308 to determine whether only SCC data is to be used to train an ML algorithm within ML module 308 to classify a customer based on that customer's communication history.

For example, in some instances as a result of enterprise policy or governmental regulation, HCC data may not be used to train an ML algorithm within ML module 308 to classify a customer based on that customer's communication history. Further, in some of these instances, there may not be any APCC data to be used to train the ML algorithm within ML module 308 to classify a customer based on that customer's communication history. In such cases, only SCC data may be used to train the ML algorithm within ML module 308 to classify a customer based on that customer's communication history.

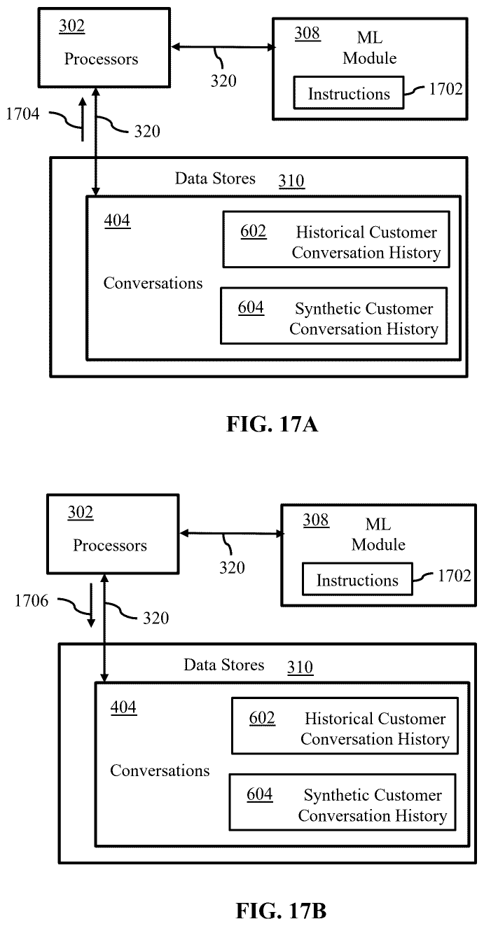

Returning to FIG. 14, if it is determined that only SCC data is to be used (Y at S1416), SCC data is obtained (S1418). For example, returning to FIG. 3, one or more processors 302 may execute instructions in customer module 316 to obtain SCC data. This will be described in greater detail with reference to FIGS. 16-17B.

FIG. 16 illustrates an example computer-implemented method S1418 of obtaining SCC data in accordance with aspects of the present disclosure.

As shown in the figure, computer-implemented method S1418 starts (S1602), and HCC data is obtained (S1604). For example, returning to FIG. 3, one or more processors 302 may execute instructions in customer module 316 to obtain HCC data. This will be described in greater detail with reference to FIG. 17A.

FIG. 17A illustrates a block diagram of one or more processors 302, conversations data storage 404 within data stores 310 and ML module 308 for obtaining HCC data in accordance with aspects of the present disclosure. Customer module 316 includes instructions 1702 stored therein.

In one or more embodiments, one or more processors 302 may execute instructions 1702 in ML module 308 to cause one or more enterprise servers 104 to obtain HCC data 1704 from HCC history data storage 602 within conversations data storage 404 within data stores 310. This may be performed in a manner as discussed above (see S1408).

Returning to FIG. 16, after HCC data has been obtained (S1604), SCC data is created (S1606). For example, returning to FIG. 3, one or more processors 302 may execute instructions in customer module 316 to create SCC data from obtained HCC data. This will be described in greater detail with reference to FIG. 17B.

FIG. 17B illustrates a block diagram of FIG. 17A at a subsequent time.

In one or more embodiments, one or more processors 302 may execute instructions 1702 in ML module 308 to cause one or more enterprise servers 104 to create SCC data 1706.

In one or more embodiments, ML module 308 may include instructions 1702 to cause one or more processors 302 to create SCC data 1706 as SCC data structures based on an obtained predetermined integer of HCC data structures N₉ from HCC history data storage 602, which correspond to respective HCCs, and which are associated with a predetermined integer of customers M₁₁ of the enterprise, for example as discussed above with reference to FIG. 15. In one or more embodiments, ML module 308 may include instructions 1702 to cause one or more processors 302 to establish the value for at least one of N₉ and M₁₁. In one or more embodiments, ML module 308 may include instructions 1702 to cause one or more processors 302 to change an established respective value for at least one of N₉ and M₁₁.

In one or more embodiments, ML module 308 may include instructions 1702 to cause one or more processors 302 to create SCC data 1706 as SCC data structures based on all obtained HCC data structures from HCC history data storage 602, which correspond to all respective HCCs, and which are associated with a predetermined integer of customers M₁₂ of the enterprise, for example as discussed above with reference to FIG. 15. In one or more embodiments, ML module 308 may include instructions 1702 to cause one or more processors 302 to establish the value for M₁₂. In one or more embodiments, ML module 308 may include instructions 1702 to cause one or more processors 302 to change an established value for M₁₂.

In one or more embodiments, ML module 308 may include instructions 1702 to cause one or more processors 302 to create SCC data 1706 as SCC data structures based on all obtained HCC data structures from HCC history data storage 602, which correspond to all respective HCCs, and which are associated with a predetermined ratio of customers R_{cus4} of all the customers of the enterprise, for example as discussed above with reference to FIG. 15. In one or more embodiments, ML module 308 may include instructions 1702 to cause one or more processors 302 to establish the value R_{cus4}. In one or more embodiments, ML module 308 may include instructions 1702 to cause one or more processors 302 to change an established value for R_{cus4}.

In one or more embodiments, ML module 308 may include instructions 1702 to cause one or more processors 302 to create SCC data 1706 as SCC data structures based on an obtained predetermined integer of HCC data structures N₁₀ of all HCC data structures from HCC history data storage 602, which correspond to respective HCCs, and which are associated with every customer of the enterprise that has at least N₁₀ respective associated customer conversation data structures within HCC history data storage 602, for example as discussed above with reference to FIG. 15. In one or more embodiments, ML module 308 may include instructions 1702 to cause one or more processors 302 to establish the value for N₁₀. In one or more embodiments, ML module 308 may include instructions 1702 to cause one or more processors 302 to change an established value for N₁₀.

In one or more embodiments, ML module 308 may include instructions 1702 to cause one or more processors 302 to create SCC data 1706 as SCC data structures based on an obtained predetermined ratio of HCC data structures R_{con210} of all HCC data structures from HCC history data storage 602 of each customer, which correspond to respective HCCs associated with each customer, and which are associated with every customer of the enterprise, for example as discussed above with reference to FIG. 15. In one or more embodiments, ML module 308 may include instructions 1702 to cause one or more processors 302 to establish the value for R_{con10}. In one or more embodiments, ML module 308 may include instructions 1702 to cause one or more processors 302 to change an established value for R_{con10}.

In one or more embodiments, ML module 308 may include instructions 1702 to cause one or more processors 302 to create SCC data 1706 based on an obtained predetermined integer of HCC data structures N₁₁ from HCC history data storage 602, which correspond to respective HCCs of a particular data type, e.g.: image data of an image file, for example of a pdf file of a text to an employee of the enterprise from a customer or of a text from an employee of the enterprise to a customer; text data of a text file, for example of a TXT file of an email or text from a mobile phone to an employee of the enterprise from a customer, or from an email or text from a mobile phone from an employee of the enterprise to a customer; audio data of an audio file, for example of a WAV file of a recorded phone message to an employee of the enterprise from a customer or from a recorded phone message from an employee of the enterprise to a customer; text data of a text file, for example of a TXT file of notes provided by an enterprise employee regarding a customer; video data of a video file, for example an MP4 file of a video meeting between an enterprise employee and a customer; and audio data of an audio file, for example a WAV file of a recorded voice input message provided by an enterprise employee regarding a customer, and which are associated with a predetermined integer of customers M₁₃ of the enterprise that have at least N₁₁ respective associated customer conversation data structures of the particular data type, for example as discussed above with reference to FIG. 15. In one or more embodiments, ML module 308 may include instructions 1702 to cause one or more processors 302 to establish the value for at least one of N₁₁ and M₁₃. In one or more embodiments, ML module 308 may include instructions 1702 to cause one or more processors 302 to change an established respective value for at least one of N₁₁ and M₁₃.

In one or more embodiments, ML module 308 may include instructions 1702 to cause one or more processors 302 to create SCC data 1706 as SCC data structures based on an obtained predetermined ratio of HCC data structures R_{con11} of all HCC data structures from HCC history data storage 602, which correspond to HCCs of a particular data type, of all HCC data structures that correspond to HCCs of that particular data type, and which are associated with a predetermined integer of customers M₁₄ of the enterprise, for example as discussed above with reference to FIG. 15. In one or more embodiments, ML module 308 may include instructions 1702 to cause one or more processors 302 to establish the value for at least one of R_{con11} and M₁₄. In one or more embodiments, ML module 308 may include instructions 1702 to cause one or more processors 302 to change an established respective value for at least one of R_{con11} and M₁₄.

In one or more embodiments, ML module 308 may include instructions 1702 to cause one or more processors 302 to create SCC data 1706 as SCC data structures based on an obtained predetermined ratio of HCC data structures R_{con12} of all HCC data structures from HCC history data storage 602, which correspond to HCCs of a particular data type, of all HCC data structures that correspond to HCCs of that particular data type, and which are associated with a predetermined ratio of customers R_{cus5} of all the customers of the enterprise, for example as discussed above with reference to FIG. 15. In one or more embodiments, ML module 308 may include instructions 1702 to cause one or more processors 302 to establish the value for at least one of R_{con12} and R_{cus5}. In one or more embodiments, ML module 308 may include instructions 1702 to cause one or more processors 302 to change an established respective value for at least one of R_{con12} and R_{cus5}.

In one or more embodiments, ML module 308 may include instructions 1702 to cause one or more processors 302 to create SCC data 1706 as SCC data structures based on every obtained HCC data structure from HCC history data storage 602, which corresponds to every respective HCC of a particular data type, of all HCC data structures that correspond to HCCs of that particular data type, and which is associated with a predetermined integer of customers M₁₅ of the enterprise, for example as discussed above with reference to FIG. 15. In one or more embodiments, ML module 308 may include instructions 1702 to cause one or more processors 302 to establish the value for M₁₅. In one or more embodiments, ML module 308 may include instructions 1702 to cause one or more processors 302 to change an established value for M₁₅.

In one or more embodiments, ML module 308 may include instructions 1702 to cause one or more processors 302 to create SCC data 1706 as SCC data structures based on every obtained HCC data structure from HCC history data storage 602, which corresponds to every respective HCC of a particular data type, of all HCC data structures that correspond to HCCs of that particular data type, and which is associated with a predetermined ratio of customers R_{cus6} of all the customers that have a HCC of that particular data type, for example as discussed above with reference to FIG. 15. In one or more embodiments, ML module 308 may include instructions 1702 to cause one or more processors 302 to establish the value for R_{cus6}. In one or more embodiments, ML module 308 may include instructions 1702 to cause one or more processors 302 to change an established value for R_{cus6}.

In one or more embodiments, ML module 308 may include instructions 1702 to cause one or more processors 302 to create SCC data 1706 as SCC data structures based on an obtained predetermined integer of HCC data structures N₁₂ of all HCC data structures from HCC history data storage 602, which correspond to HCCs of a particular data type, and which are associated with every customer of the enterprise that has had at least the predetermined integer N₁₂ of HCCs of that particular data type, for example as discussed above with reference to FIG. 15. In one or more embodiments, ML module 308 may include instructions 1702 to cause one or more processors 302 to establish the value for N₁₂. In one or more embodiments, ML module 308 may include instructions 1702 to cause one or more processors 302 to change an established value for N₁₂.

In one or more embodiments, ML module 308 may include instructions 1702 to cause one or more processors 302 to create SCC data 1706 as SCC data structures based on an obtained predetermined ratio of HCC data structures R_{con13} of all HCC data structures from HCC history data storage 602, which correspond to HCCs of a particular data type, of all HCC data structures that correspond to HCCs of that particular data type, that are associated with every customer of the enterprise that correspond to a customer conversation being that particular data type of file, for example as discussed above with reference to FIG. 15. In one or more embodiments, ML module 308 may include instructions 1702 to cause one or more processors 302 to establish the value for R_{con13}. In one or more embodiments, ML module 308 may include instructions 1702 to cause one or more processors 302 to change an established value for R_{con13}.

In one or more embodiments, ML module 308 may include instructions 1702 to cause one or more processors 302 to create SCC data 1706 as SCC data structures based on: 1) an obtained first predetermined integer of HCC data structures N₁₃ of all HCC data structures from HCC history data storage 602, which correspond to HCCs of a first particular data type, that are associated with a first predetermined integer M₁₆ of customers of the enterprise; and 2) an obtained second predetermined integer of HCC data structures N₁₄ of all HCC data structures from HCC history data storage 602, which correspond to HCCs of a second particular data type that are associated with a second predetermined integer M₁₇ of customers of the enterprise, for example as discussed above with reference to FIG. 15. For example, an integer M₁₆₁ of image files from each of the N₁₃ customers, an integer M₁₇T of text files from each of the N₁₄ customers, and so on. In one or more embodiments, M₁₆=M₁₇. In one or more embodiments M₁₆≠M₁₇. In one or more embodiments, N₁₃=N₁₄. In one or more embodiments N₁₃≠N₁₄. In one or more embodiments, ML module 308 may include instructions 1702 to cause one or more processors 302 to establish the value for at least one of N₁₃, N₁₄, M₁₆ and M₁₇. In one or more embodiments, ML module 308 may include instructions 1702 to cause one or more processors 302 to change an established respective value for at least one of 13₅, N₁₄, M₁₆ and M₁₇.

In one or more embodiments, ML module 308 may include instructions 1702 to cause one or more processors 302 to create SCC data 1706 as SCC data structures based on: 1) an obtained first predetermined ratio of HCC data structures R_{con14} of all HCC data structures from HCC history data storage 602, which correspond to HCCs of a first particular data type, that are associated with a first predetermined integer M₁₈ of customers of the enterprise; and 2) an obtained second predetermined ratio of HCC data structures R_{con15} of all HCC data structures from HCC history data storage 602, which correspond to HCCs of a second particular data type, of all HCC data structures that correspond to HCCs of that particular data type, that are associated with a second predetermined integer M₁₉ of customers of the enterprise, for example as discussed above with reference to FIG. 15. For example, a ratio R_{con14I} of image files of all image files from each of the M₁₈ customers, a ratio R_{con15T} of text files of all text files from each of the M₁₉ customers. In one or more embodiments, R_{con14}=R_{con15}. In one or more embodiments R_{con14}≠R_{con15}. In one or more embodiments, M₁₈=M₁₉. In one or more embodiments M₁₈≠M₁₉. In one or more embodiments, ML module 308 may include instructions 1702 to cause one or more processors 302 to establish the value for at least one of R_{con14}, R_{con15}, M₁₈, and M₁₉. In one or more embodiments, ML module 308 may include instructions 1702 to cause one or more processors 302 to change an established respective value for at least one of R_{con14}, R_{con15}, M₁₈, and M₁₉.

In one or more embodiments, ML module 308 may include instructions 1702 to cause one or more processors 302 to create SCC data 1706 as SCC data structures based on: 1) an obtained predetermined integer of HCC data structures N₁₅ of all HCC data structures from HCC history data storage 602, which correspond to HCCs of a first particular data type, that are associated with every customer of the enterprise; and 2) an obtained predetermined integer of HCC data structures N₁₆ of all HCC data structures from HCC history data storage 602, which correspond to HCCs of a second particular data type, for example as discussed above with reference to FIG. 15. For example, a first integer N_{15I} of image files from every customer, and a second integer N_{16T} of text files from every customer, and so on. In one or more embodiments, N₁₅ =N₁₆. In one or more embodiments N₁₅≠N₁₆. In one or more embodiments, ML module 308 may include instructions 1702 to cause one or more processors 302 to establish the value for at least one of N₁₅ and N₁₆. In one or more embodiments, ML module 308 may include instructions 1702 to cause one or more processors 302 to change an established respective value for at least one of N₁₅ and N₁₆.

In one or more embodiments, ML module 308 may include instructions 1702 to cause one or more processors 302 to create SCC data 1706 as SCC data structures based on: 1) an obtained first predetermined ratio of HCC data structures R_{con15} of all HCC data structures from HCC history data storage 602, which correspond to HCCs of a first particular data type, that are associated with all customers of the enterprise; and 2) an obtained second predetermined ratio of HCC data structures R_{con16} of all HCC data structures from HCC history data storage 602, which correspond to HCCs of a second particular data type, of all HCC data structures that correspond to HCCs of that second particular data type, that are associated with all customers of the enterprise, for example as discussed above with reference to FIG. 15. For example, a ratio R_{con15I} of image files of all image files from all customers, a ratio R_{con16T} of text files of all text files from all customers. In one or more embodiments, R_{con15}=R_{con16}. In one or more embodiments R_{con15}≠R_{con16}. In one or more embodiments, ML module 308 may include instructions 1702 to cause one or more processors 302 to establish the value for at least one of R_{con15} and R_{con16}. In one or more embodiments, ML module 308 may include instructions 1702 to cause one or more processors 302 to change an established respective value for at least one of R_{con15} and R_{con16}.

In one or more embodiments, in one or more embodiments, ML module 308 may include instructions 1702 to cause one or more processors 302 to store created SCC data 1706 into SCC history data storage 604, as SCC data structures as discussed above with respect to FIG. 8.

Returning to FIG. 16, after SCC data is obtained (S1608), computer-implemented method S1418 stops (S1610). Returning to FIG. 14, after SCC data is obtained (S1418), computer-implemented method S1304 stops (S1410).

As such, in one or more embodiments, only SCC data is used to train an ML algorithm within ML module 308 to classify a customer based on that customer's communication history.

Alternatively, if it is determined that not only SCC data is to be used (N at S1416), SCC data is obtained (S1420). This may be performed in a manner as discussed above (See S1418). After SCC data is obtained (S1420), or if it is determined that SCC data is not to be used (N at S1414), it is determined whether APCC data is to be used (S1422). For example, returning to FIG. 3, one or more processors 302 may execute instructions in ML module 308 to determine whether APCC data is to be used to train an ML algorithm within ML module 308 to classify a customer based on that customer's communication history.

Furthermore, in some instances, where HCC data may be used to train an ML algorithm within ML module 308 to classify a customer based on that customer's communication history, there may be insufficient HCC data to train the ML algorithm. Further, in some of these instances, there may be no SCC data or insufficient SCC data to train the ML algorithm within ML module 308 to classify a customer based on that customer's communication history. In such cases, only APCC data may be used to train the ML algorithm within ML module 308 to classify a customer based on that customer's communication history.

Returning to FIG. 14, if it is determined that APCC data is not to be used (N at S1422), computer-implemented method S1304 stops (S1410). As such, in one or more embodiments: only HCC data is used to train an ML algorithm within ML module 308 to classify a customer based on that customer's communication history; only SCC data is used to train the ML algorithm within ML module 308 to classify a customer based on that customer's communication history; or a combination of HCC data and SCC data is used to train the ML algorithm within ML module 308 to classify a customer based on that customer's communication history.

Returning to FIG. 14, if it is determined that APCC data is to be used (Y at S1422), APCC data is obtained (S1424). For example, returning to FIG. 3, one or more processors 302 may execute instructions in ML module 308 to obtain APCC data. This will be described in greater detail with reference to FIG. 18.

FIG. 18 illustrates a block diagram of one or more processors 302, conversations data storage 404 within data stores 310, and ML module 308 to cause one or more enterprise servers 104 to create APCC data in accordance with aspects of the present disclosure. Customer module 316 includes instructions 1802 stored therein. APCC history data storage 606 includes APCC data stored therein.

In one or more embodiments, one or more processors 302 may execute instructions 1802 in ML module 308 to create APCC data and store the created APCC data into APCC history data storage 606.

In one or more embodiments, ML module 308 may include instructions 1802 to cause one or more processors 302 to create APCC data 1804 as APCC data structures, which correspond to all respective APCCs, and which are associated with a predetermined integer of fictional customers M₁₉ of the enterprise. In one or more embodiments, ML module 308 may include instructions 1802 to cause one or more processors 302 to establish the value for M₁₉. In one or more embodiments, ML module 308 may include instructions 1802 to cause one or more processors 302 to change an established value for M₁₉.

In one or more embodiments, ML module 308 may include instructions 1802 to cause one or more processors 302 to create APCC data 1804 as APCC data structures, which correspond to all respective APCCs, and such that every fictional customer of the enterprise has at least N₁₇ respective associated fictional customer conversation data structures within APCC history data storage 606. In one or more embodiments, ML module 308 may include instructions 1802 to cause one or more processors 302 to establish the value for N₁₇. In one or more embodiments, ML module 308 may include instructions 1802 to cause one or more processors 302 to change an established value for N₁₇.

In one or more embodiments, ML module 308 may include instructions 1802 to cause one or more processors 302 to create APCC data 1804 as a predetermined integer of APCC data structures N₁₈, which correspond to all APCCs and which all are of a particular data type, e.g.: image data of an image file, for example of a pdf file of a text to an fictional employee of the enterprise from a fictional customer or of a text from an fictional employee of the enterprise to a fictional customer; text data of a text file, for example of a TXT file of an email or text from a mobile phone to an fictional employee of the enterprise from a fictional customer, or from an email or text from a mobile phone from an fictional employee of the enterprise to a fictional customer; audio data of an audio file, for example of a WAV file of a recorded phone message to an fictional employee of the enterprise from a fictional customer or from a recorded phone message from an fictional employee of the enterprise to a fictional customer; text data of a text file, for example of a TXT file of notes provided by an enterprise fictional employee regarding a fictional customer; video data of a video file, for example an MP4 file of a video meeting between an enterprise fictional employee and a fictional customer; and audio data of an audio file, for example a WAV file of a recorded voice input message provided by an enterprise fictional employee regarding a fictional customer, and which are associated with a predetermined integer of fictional customers M₂₀. In one or more embodiments, ML module 308 may include instructions 1802 to cause one or more processors 302 to establish the value for at least one of N₁₈ and M₂₀. In one or more embodiments, ML module 308 may include instructions 1802 to cause one or more processors 302 to change an established respective value for at least one of N₁₈ and M₂₀.

In one or more embodiments, ML module 308 may include instructions 1802 to cause one or more processors 302 to create APCC data 1804 as APCC data structures: 1) as a first predetermined integer of APCC data structures N₁₉, which correspond to APCCs of a first particular data type, that are associated with a first predetermined integer M₂₁ of fictional customers of the enterprise; and 2) as a second predetermined integer of APCC data structures N₂₀, which correspond to APCCs of a second particular data type that are associated with a second predetermined integer M₂₂ of fictional customers of the enterprise. For example, an integer M_{21I} of image files from each of the N₁₉ fictional customers, an integer M_{22T} of text files from each of the N₂₀ fictional customers, and so on. In one or more embodiments, M₂₁=M₂₂. In one or more embodiments M₂₁≠M₂₂. In one or more embodiments, N₁₉=N₂₀. In one or more embodiments N₁₉≠N₂₀.

In one or more embodiments, ML module 308 may include instructions 1802 to cause one or more processors 302 to create APCC data 1804 as APCC data structures: 1) as a first predetermined integer of APCC data structures N₂₁, which correspond to APCCs of a first particular data type, that are associated with every fictional customer of the enterprise; and 2) as second predetermined integer of APCC data structures N₂₂, which correspond to APCCs of a second particular data type, that are associated with every fictional customer of the enterprise. For example, a first integer N_{21I} of image files from every fictional customer, and a second integer N_{22T} of text files from every fictional customer, and so on. In one or more embodiments, N₂₁=N₂₂. In one or more embodiments N₂₁≠N₂₂. In one or more embodiments, ML module 308 may include instructions 1802 to cause one or more processors 302 to establish the value for at least one of N₂₁ and N₂₂. In one or more embodiments, ML module 308 may include instructions 1802 to cause one or more processors 302 to change an established respective value for at least one of N₂₁ and N₂₂.

In one or more embodiments, in one or more embodiments, ML module 308 may include instructions 1802 to cause one or more processors 302 to store created APCC data 1804 into APCC history data storage 606, as APCC data structures as discussed above with respect to FIG. 9.

In one or more embodiments, one or more processors 302 may execute instructions 1802 in ML module 308 to cause one or more enterprise servers 104 to obtain APCC data 1804 from APCC history data storage 606 within conversations data storage 404 within data stores 310.

Returning to FIG. 14, after APCC data is obtained (S1424), computer-implemented method S1304 stops (S1410).

As such, in one or more embodiments: HCC data, SCC data, and APCC data is used to train an ML algorithm within ML module 308 to classify a customer based on that customer's communication history; HCC data and APCC data is used to train the ML algorithm within ML module 308 to classify a customer based on that customer's communication history; SCC data and APCC data is used to train the ML algorithm within ML module 308 to classify a customer based on that customer's communication history; or only APCC data is used to train the ML algorithm within ML module 308 to classify a customer based on that customer's communication history.

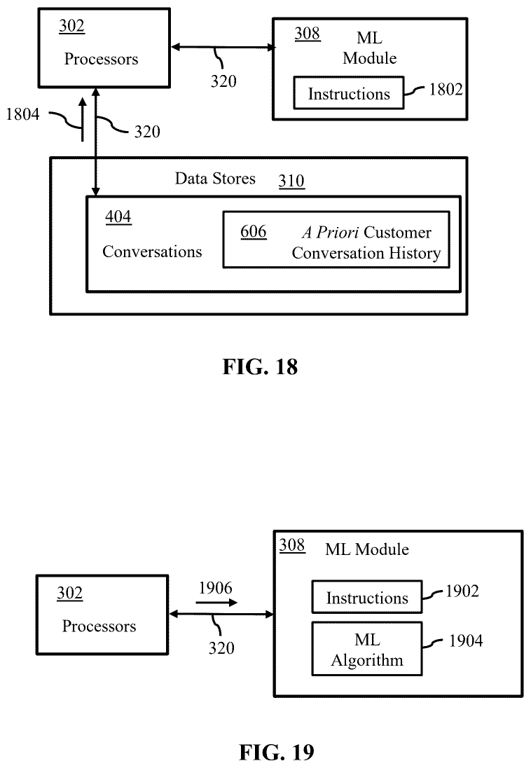

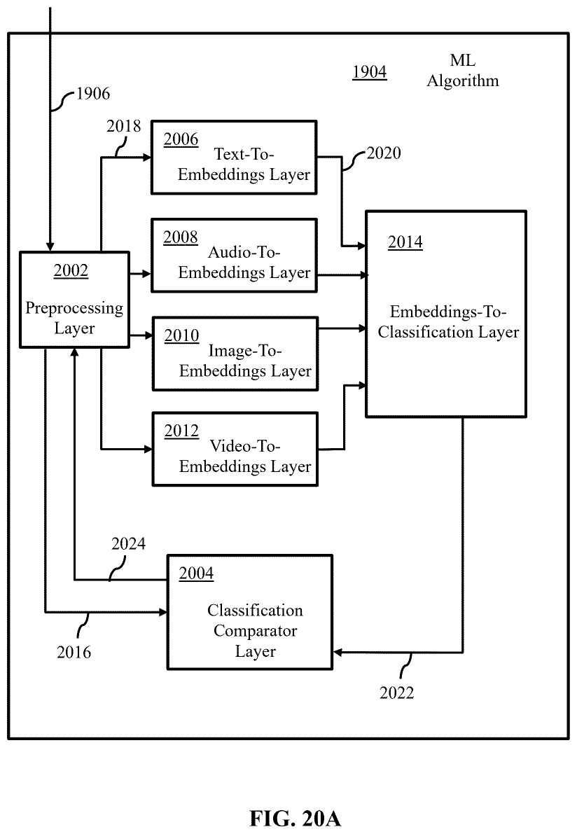

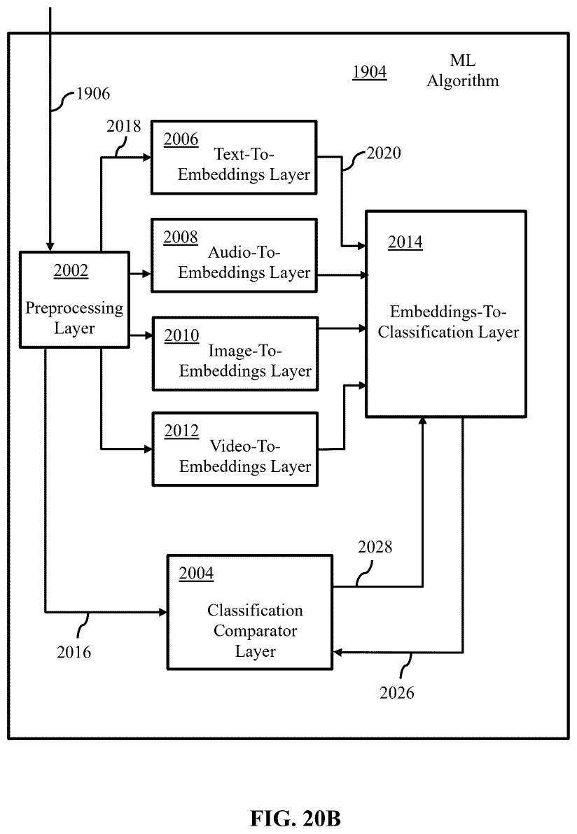

Returning to FIG. 13, after conversation data is obtained (S1304), the ML algorithm is trained (S1308). For example, returning to FIG. 3, one or more processors 302 may execute instructions in ML module 308 to cause one or more processors 302 to train the ML algorithm. This will be described in greater detail with reference to FIGS. 19-20B.

FIG. 19 illustrates a block diagram of one or more processors 302, and ML module 308, having instructions 1902 and an ML algorithm 1904 stored therein, for training an ML algorithm to classify enterprise customers based on conversation history in accordance with aspects of the present disclosure.

As shown in the figure, one or more processors 302 may execute instructions 1902 to cause one or more processors 302 to provide a repackaged conversation data structure 1906 to ML module 308 to train ML algorithm 1904.

In one or more embodiments, one or more processors 302 may execute instructions 1902 to cause one or more processors 302 to repackage all obtained conversation data, including any obtained HCC data, any obtained SCC data, and any APCC data, as discussed above with reference to FIGS. 14-18, into distinct groups of obtained conversation data based on respective distinct customers. In this manner, each distinct group of obtained conversation data will include only conversation data corresponding to a single customer, whether that be an actual customer in the case of HCC data, a synthetic customer in the case of SCC data, or a fictional customer in the case of APCC data.

In one or more embodiments, the obtained HCC data take the form of HCC data structures, for example as discussed above with reference to FIG. 7, SCC data structures, for example as discussed above with reference to FIG. 8, or APCC data structures, for example as discussed above with reference to FIG. 9. As such, one or more processors 302 may repackage all conversation data based on respective distinct customers, by identifying each conversation data structure for each customer via: the customer name data portion, in the case of an HCC data structure; the synthetic customer name data portion, in the case of a SCC data structure; and the fictional customer name data portion, in the case of an APCC data structure.

In one or more embodiments, each repackaged conversation data structure provided by one or more processors 302 to ML module 308 corresponds to a group of obtained conversation data that include only conversation data corresponding to a single customer. As will be described in greater detail below with respect to FIGS. 20A-B, upon receiving notification from ML module 308 for a new repackaged conversation data structure, one or more processors 302 will then provide a new repackaged conversation data structure to ML module 308 that corresponds to a new group of obtained conversation data that include only conversation data corresponding to a new single customer. This process will continue until all repackaged conversation data structures are provided to ML module 308, or in other words, until the conversation history of each customer within the obtain conversation data has been processed by ML module 308.

FIG. 20A illustrates a block diagram of ML algorithm 1904, when ML algorithm 1904 correctly classifies a customer, corresponding to repackaged conversation data structure 1906, as one classification type within a plurality of different classification types.

As shown in the figure, ML algorithm 1904 includes a preprocessing layer 2002, a classification comparator layer 2004, a text-to-embeddings layer 2006, an audio-to-embeddings layer 2008, an image-to-embeddings layer 2010, a video-to-embeddings layer 2012, and an embeddings-to-classification layer 2014.

For purposes of explanation only, in this non-limiting example, let repackaged conversation data structure 1906 correspond to a plurality of HCC data structures, such as discussed above with reference to HCC data structure 702 of FIG. 7, each of which corresponds to a real customer John Green. Further, let the conversation type data portion of each HCC data structure in repackaged conversation data structure 1906 indicate that repackaged conversation data structure 1906 corresponds to text data.

In one or more embodiments, preprocessing layer 2002 is operable: to receive repackaged conversation data structure 1906; to review the conversation data type portion of at least one of the HCC data structures in repackaged conversation data structure 1906; to generate a conversation classification data structure; to output the conversation classification data structure to classification comparator layer 2004; to generate a plurality of preprocessed conversation data structures, each of which corresponds to a single respective HCC data structure within repackaged conversation data structure 1906; and to serially output the plurality of preprocessed conversation data structures to one of text-to-embeddings layer 2006, audio-to-embeddings layer 2008, image-to-embeddings layer 2010, video-to-embeddings layer 2012.

In one or more embodiments, preprocessing layer 2002 is operable to generate each preprocessed conversation data structure by removing at least one data portion from the respective corresponding HCC data structure within repackaged conversation data structure 1906. For example, with respect to an HCC data structure, for example as discussed above with reference to FIG. 7, preprocessing layer 2002 may be operable to generate the preprocessed conversation data structure by removing the classification data portion from the HCC data structure. Similarly, with respect to a SCC data structure, for example as discussed above with reference to FIG. 8, preprocessing layer 2002 may be operable to generate the preprocessed conversation data structure by removing the classification data portion from the SCC data structure. Similarly, with respect to an APCC data structure, for example as discussed above with reference to FIG. 9, preprocessing layer 2002 may be operable to generate the preprocessed conversation data structure by removing the classification data portion from the APCC data structure.

In particular, as will be described in greater detail below, embeddings-to-classification layer 2014 may be operable to classify a customer associated with a repackaged conversation data structure, as one classification type within a plurality of different classification types. As such, including a customer classification within a preprocessed conversation data structure may inadvertently cause embeddings-to-classification layer 2014 to classify a customer associated with a repackaged conversation data structure with the same classification that is identified within the repackaged conversation data structure. This would obviate the need to train embeddings-to-classification layer 2014 to be able to reclassify a customer based on newly added customer conversations or to be able to classify new customers, based on newly added customer conversations for the new customer.

In one or more embodiments, preprocessing layer 2002 is operable to output a preprocessed conversation data structure to text-to-embeddings layer 2006 when the conversation data type portion of the conversation data structure of the repackaged conversation data structure 1906 identifies the type of data within the conversation payload data portion of the conversation data structure as text data.

In one or more embodiments, preprocessing layer 2002 is operable to output a preprocessed conversation data structure to audio-to-embeddings layer 2008 when the conversation data type portion of the conversation data structure of the repackaged conversation data structure 1906 identifies the type of data within the conversation payload data portion of the conversation data structure as audio data.

In one or more embodiments, preprocessing layer 2002 is operable to output a preprocessed conversation data structure to image-to-embeddings layer 2010 when the conversation data type portion of the conversation data structure of the repackaged conversation data structure 1906 identifies the type of data within the conversation payload data portion of the conversation data structure as image data.

In one or more embodiments, preprocessing layer 2002 is operable to output a preprocessed conversation data structure to video-to-embeddings layer 2012, when the conversation data type portion of the conversation data structure of the repackaged conversation data structure 1906 identifies the type of data within the conversation payload data portion of the conversation data structure as video data.

For purposes of explanation only, in this non-limiting example, let repackaged conversation data structure 1906 correspond to a plurality of HCC data structures, such as discussed above with reference to HCC data structure 702 of FIG. 7, wherein the conversation type data portion of each HCC data structure indicates that the data within the conversation payload data portion of the HCC data structure corresponds to a particular data type of data. In this non-limiting example, let a first HCC data structure within repackaged conversation data structure 1906 have a conversation type data portion that indicates that the data within the conversation payload data portion of the HCC data structure corresponds to text data. Accordingly, in this non-limiting example, preprocessing layer 2002 is operable to output a preprocessed conversation data structure 2018 to text-to-embeddings layer 2006.

In one or more embodiments, classification comparator layer 2004 is operable to: a receive conversation classification data structure as an input customer classification from preprocessing layer 2002; receive a determined customer classification from embeddings-to-classification layer 2014; and compare the customer classification indicated by conversation classification data structure as provided by preprocessing layer 2002 with the determined customer classification as provided by embeddings-to-classification layer 2014.

In one or more embodiments, classification comparator layer 2004 is operable to, when the input customer classification as provided by preprocessing layer 2002 is the same as the determined customer classification as provided by embedding to classification layer 2014, provide a next repackaged conversation data structure instruction to preprocessing layer 2002.

In one or more embodiments, the next conversation data structure instruction may cause preprocessing layer 2002 to retrieve the next repackaged conversation data structure from one or more processors 302.

In one or more embodiments, classification comparator layer 2004 is operable to, when the input customer classification as provided by preprocessing layer 2002 is not the same as the determined customer classification as provided by embedding to classification layer 2014, provide a modification instruction to embeddings-to-classification layer 2014.

In one or more embodiments, text-to-embeddings layer 2006 is operable to output embeddings, based on an input preprocessed conversation data structure, to embeddings-to-classification layer 2014.

In the case of text-to-embeddings layer 2006, the output embeddings therefrom are based on preprocessed conversation data structures having a conversation payload data portion that corresponds to a text data type.

In one or more embodiments, text-to-embeddings layer 2006 may be a neural network having a plurality of weights and biases, wherein upon receiving a preprocessed conversation data structure from preprocessing layer 2002, is operable to output embeddings to embeddings-to-classification layer 2014.

In one or more embodiments, audio-to-embeddings layer 2008 is operable to output embeddings, based on an input preprocessed conversation data structure, to embeddings-to-classification layer 2014. In the case of audio-to-embeddings layer 2008, the output embeddings therefrom are based on preprocessed conversation data structures having a conversation payload data portion that corresponds to an audio data type.

In one or more embodiments, audio-to-embeddings layer 2008 may be a neural network having a plurality of weights and biases, wherein upon receiving a preprocessed conversation data structure from preprocessing layer 2002, is operable to output embeddings to embeddings-to-classification layer 2014.

In one or more embodiments, image-to-embeddings layer 2010 is operable to output embeddings, based on an input preprocessed conversation data structure, to embeddings-to-classification layer 2014. In the case of image-to-embeddings layer 2010, the output embeddings therefrom are based on preprocessed conversation data structures having a conversation payload data portion that corresponds to an image data type.

In one or more embodiments, image-to-embeddings layer 2010 may be a neural network having a plurality of weights and biases, wherein upon receiving a preprocessed conversation data structure from preprocessing layer 2002, it is operable to output embeddings to embeddings-to-classification layer 2014.

In one or more embodiments, video-to-embeddings layer 2012 is operable to output embeddings, based on an input preprocessed conversation data structure, to embeddings-to-classification layer 2014. In the case of video-to-embeddings layer 2012, the output embeddings therefrom are based on preprocessed conversation data structures having a conversation payload data portion that corresponds to a video data type.

In one or more embodiments, video-to-embeddings layer 2012 may be a neural network having a plurality of weights and biases, wherein upon receiving a preprocessed conversation data structure from preprocessing layer 2002, it is operable to output embeddings to embeddings-to-classification layer 2014.

In one or more embodiments, embeddings-to-classification layer 2014 is operable to output a determined customer classification of a predetermined number of customer classifications, based on input embeddings from one of text-to-embeddings layer 2006, audio-to-embeddings layer 2008, image-to-embeddings layer 2010, and video-to-embeddings layer 2012, to classification comparator layer.

In one or more embodiments, the predetermined number of customer classifications may include at least one of regulatory classifications, risk-based classifications, demographic and behavioral classifications, customer value classifications, and combinations thereof.

In one or more embodiments, embeddings-to-classification layer 2014 may be a recurrent neural network having a plurality of weights and biases, wherein upon receiving a modification instructions from classification comparator layer 2004, is operable to back propagate to adjust the plurality of weights and biases.

A recurrent neural network (RNN) produces a single output based on a plurality of serially fed input vectors by leveraging its ability to process sequential data and retain information from previous inputs through its hidden states.

In the case of ML algorithm 1904 as an RNN, each input vector, Xi, is an embedding as provided by one of text-to-embeddings layer 2006, audio-to-embeddings layer 2008, image-to-embeddings layer 2010, and video-to-embeddings layer 2012, to classification comparator layer. At each time step t, the RNN computes a hidden state hₜ using the current input vector xᵢ and the previous hidden state hₜ₋₁, wherein hᵢ=g (U Hᵢ₋₁+W xᵢ+bi), wherein U and Ware weight matrices, b is a bias vector, and wherein g is a nonlinear activation function (e.g., ReLU, tanh, or sigmoid). This recursive computation allows the RNN to encode information about both the current input and past inputs into its hidden state.

In the case of ML algorithm 1904 as an RNN, the last input vector is an embedding as provided by one of text-to-embeddings layer 2006, audio-to-embeddings layer 2008, image-to-embeddings layer 2010, and video-to-embeddings layer 2012, to classification comparator layer, and which corresponds to a last customer communication data structure within repackaged conversation data structure 1906. After processing all input vectors in the sequence, the RNN uses the final hidden state hy (from the last time step, which corresponds to the last customer communication data structure within repackaged conversation data structure 1906), to compute the single output y, wherein y=f (V h_{T}+b_{T}), wherein V is another weight matrix, b_{T} is the final bias vector, and f is a linear or nonlinear transformation depending on the task. In one or more embodiments, f is a nonlinear softmax transformation for classifying the customer associated with repackaged conversation data structure 1906 as one type of classification among a plurality of types of classifications.

In the case of ML algorithm 1904 as an RNN, the RNN maintains memory of prior inputs through its hidden states, enabling it to capture dependencies across time steps. This makes the RNN suitable for identifying patterns within the sequential customer communication data structures, where context from earlier inputs influences later outputs.

In other words, an RNN processes each input vector sequentially, updates its hidden states recursively, and uses the final hidden state to produce a single output that encapsulates information from all prior inputs. In the case of ML algorithm 1904 as an RNN, ML algorithm 1904 serially processes a plurality of embeddings that correspond to different communication channels, e.g., text, image, audio, video, of a single customer over a period of time, to produce a single output that classifies the single customer from information of all the customer communications over that period of time. The single output being the determined customer classification of the customer associated with repackaged conversation data structure 1906.

In one or more embodiments, embeddings-to-classification layer 2014 may be a recurrent neural network having a plurality of weights and biases, wherein upon receiving a modification instructions from classification comparator layer 2004, is operable to back propagate to adjust the plurality of weights and biases.

Upon receiving repackaged conversation data structure 1906, preprocessing layer 2002 extricates the customer classification data portion from each respective conversation data structure within repackaged conversation data structure 1906. Preprocessing layer 2002 then generates a conversation classification data structure 2016 based on data within the customer classification data portion of at least one of the conversation data structures within repackaged conversation data structure 1906. Preprocessing layer 2002 provides conversation classification data structure 2016 to classification comparator layer 2004.

The data within conversation classification data structure 2016 identifies the classification of the customer associated with repackaged conversation data structure 1906.

Preprocessing layer 2002 additionally generates a preprocessed conversation data structure 2018 from a first provided conversation data structure within repackaged conversation data structure 1906, such that preprocessed conversation data structure 2018 does not include a customer classification data portion.

In one or more embodiments, the data within the conversation type data portion of preprocessed conversation data structure 2018 identifies the data type of the conversation payload portion of preprocessed conversation data structure 2018. In one or more embodiments, the data within the conversation type data portion of preprocessed conversation data structure 2018 indicates the type of encoding of the data within the conversation payload data portion of preprocessed conversation data structure 2018. Accordingly, the data within preprocessed conversation data structure 2018 directs preprocessing layer 2002 as to which of text-to-embeddings layer 2006, audio-to-embedding layer 2008, image-to-embeddings layer 2010, and video-to-embeddings layer 2012 preprocessed conversation data structure 2018 is to be provided.

For purposes of discussion only, in a non-limiting example, let preprocessed conversation data structure 2018 be a conversation data structure wherein the type of data within the conversation payload data portion is text data. Therefore, preprocessing layer 2002 provides preprocessed conversation data structure 2018 to text-to-embeddings layer 2006.

Text-to-embeddings layer outputs embeddings 2020, based on preprocessed conversation data structure 2018, to embeddings-to-classification layer 2014. Embeddings-to-classification layer 2014 then processes embeddings 2020.

This process is repeated until every preprocessed conversation data structure, which corresponds to a respective conversation data structure within repackaged conversation data structure 1906, is processed by embeddings-to-classification layer 2014. At that point, embeddings-to-classification layer 2014 outputs a determined customer classification 2022 to classification comparator layer 2004.

In this example, let determined customer classification 2022 correspond to a customer classification that matches a customer classification as identified in conversation classification data structure 2016.

Classification comparator layer 2004 compares the classification as identified in conversation classification data structure 2016 with the classification as identified in determined customer classification 2022. In this example, as indicated above, the classification as identified in conversation classification data structure 2016 matches the classification as identified in determined customer classification 2022. As such, classification comparator layer 2004 provides a next repackaged conversation data structure instruction 2024 to preprocessing layer 2002.

In response to receiving the next repackaged conversation data structure instruction 2024, preprocessing layer 2002 obtains the next repackaged conversation data structure from one or more processors 302 to continue to train ML algorithm.

FIG. 20B illustrates a block diagram of the ML algorithm of FIG. 19, when embeddings-to-classification layer 2014 incorrectly classifies a customer, corresponding to repackaged conversation data structure 1906, as one classification type within a plurality of different classification types.

For purposes of discussion only, in a non-limiting example, let preprocessed conversation data structure 2018 be a conversation data structure wherein the type of data within the conversation payload data portion is text data. Therefore, preprocessing layer 2002 provides preprocessed conversation data structure 2018 to text-to-embeddings layer 2006.

Upon receiving repackaged conversation data structure 1906, preprocessing layer 2002 extricates the customer classification data portion from each respective conversation data structure within repackaged conversation data structure 1906, generates conversation classification data structure 2016, and provides conversation classification data structure 2016 to classification comparator layer 2004, as discussed above with reference to FIG. 20A.

Preprocessing layer 2002 additionally generates preprocessed conversation data structure 2018, and provides preprocessed conversation data structure 2018 to text-to-embeddings layer 2006, as discussed above with reference to FIG. 20A.

Text-to-embeddings layer outputs embeddings 2020, based on preprocessed conversation data structure 2018, to embeddings-to-classification layer 2014, as discussed above with reference to FIG. 20A.

Embeddings-to-classification layer 2014 then processes embeddings 2020.

This process is repeated until every preprocessed conversation data structure, which corresponds to a respective conversation data structure within repackaged conversation data structure 1906, is processed by embeddings-to-classification layer 2014, as discussed above with reference to FIG. 20. At that point, embeddings-to-classification layer 2014 outputs a determined customer classification 2026 to classification comparator layer 2004.

In response to receiving modification instruction 2028, embeddings-to-classification layer 2014 back propagates to adjust the plurality of weights and biases. Embeddings-to-classification layer 2014 then, but with newly adjusted weights and biases, again processes every preprocessed conversation data structure, that corresponds to a respective conversation data structure within repackaged conversation data structure 1906. Embeddings-to-classification layer 2014 then outputs a new determined customer classification to classification comparator layer 2004.

This process of adjustment of the plurality of weights and biases continues until classification comparator layer 2004 determines that the classification as identified in conversation classification data structure 2016 matches the determined customer classification as output by embeddings-to-classification layer 2014. At such a point, classification comparator layer 2004 would then provide a next repackaged conversation data structure instruction to preprocessing layer 2002, as discussed above with reference to FIG. 20A.

The process of training ML algorithm 1904 continues with each repackaged conversation data structure is provided by one or more processors 302, such that all obtained conversation data (see S1304) has been used.

Returning to FIG. 13, after the ML algorithm is trained (S1308), method S1204 stops (S1308).

Returning to FIG. 12, after the ML algorithm is created (S1204), it is determined whether all customers are classified (S1206). For example, returning to FIG. 3, one or more processors 302 may execute instructions in customer module 316 to cause one or more processors 302 to determine whether all customers are classified.

In one or more embodiments, one or more processors 302 may search through all HCC data structures within HCC history data storage 602. In particular, one or more processors 302 may: 1) identify all customers that have at least one HCC via the customer name data portion of all HCC data structures; and 2) identify any identified customers having HCC data structures that have an empty customer classification data portion. This indicates that such identified customers have not been classified.

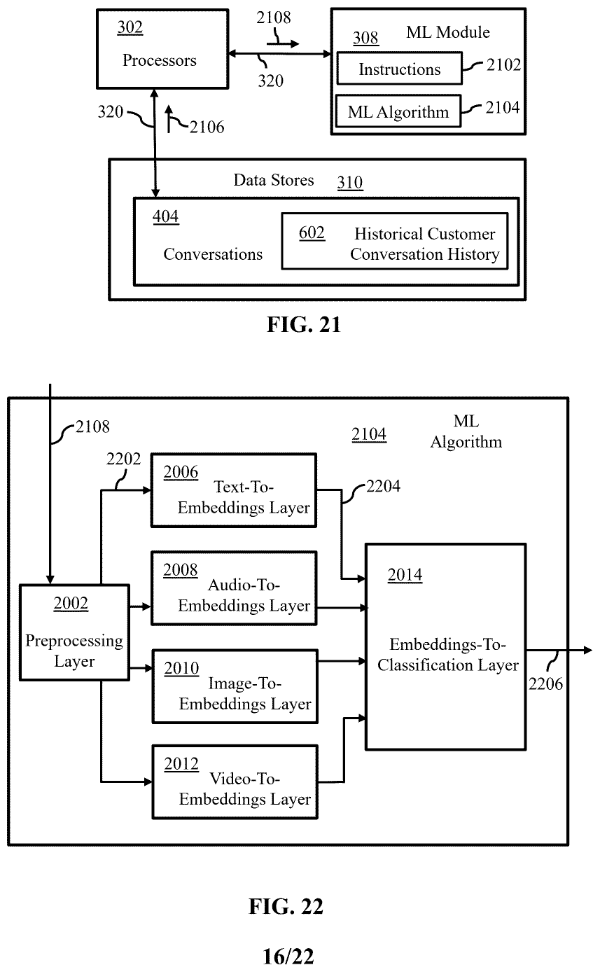

Returning to FIG. 12, if it is determined that all customers are not classified (N at S1206), then all unclassified customers are classified (S1208). For example, returning to FIG. 3, one or more processors 302 may execute instructions in ML module 308 to cause one or more processors 302 to classify any unclassified customers. This will be described in greater detail with reference to FIGS. 21-23B.

FIG. 21 illustrates a block diagram of one or more processors 302, conversations data storage 404 within data stores 310, and ML module 308 for obtaining HCC data from unclassified customers in accordance with aspects of the present disclosure. ML module 308 includes instructions 2102 and an ML algorithm 2104 stored therein.

In one or more embodiments, one or more processors 302 may execute instructions 2102 in ML module 308 to cause one or more enterprise servers 104 to obtain HCC conversation data 2106 from any HCC conversation data structures within HCC history data storage 602 within conversations data storage 404 within data stores 310.

In one or more embodiments, one or more processors 302 may execute instructions 2102 to cause one or more processors 302 to provide a repackaged conversation data structure 2108 to ML module 308 to be processed by ML algorithm 2104 in order to classify a previously unclassified customer.

In one or more embodiments, one or more processors 302 may execute instructions 2102 to cause one or more processors 302 to repackage all obtained HCC conversation data associated with the previously unclassified customers, as discussed above with reference to FIGS. 14-16, into distinct groups of obtained conversation data based on respective distinct customers. In this manner, each distinct group of obtained conversation data will include only conversation data corresponding to a single customer actual customer.

In one or more embodiments, the obtained HCC data take the form of HCC data structures, for example as discussed above with reference to FIG. 7. As such, one or more processors 302 may repackage all conversation data based on respective distinct customers, by identifying each conversation data structure for each customer via: the customer name data portion.

In one or more embodiments, each repackaged conversation data structure provided by one or more processors 302 to ML module 308 corresponds to a group of obtained conversation data that include only conversation data corresponding to a single customer. Upon receiving notification from ML module 308 for a new repackaged conversation data structure, one or more processors 302 will then provide a new repackaged conversation data structure to ML module 308 that corresponds to a new group of obtained conversation data that include only conversation data corresponding to a new single customer. This process will continue until all repackaged conversation data structures are provided to ML module 308, or in other words, until the conversation history of each previously unclassified customer within the obtain conversation data has been processed by ML module 308. This will be described in greater detail with reference to FIG. 22.

FIG. 22 illustrates a block diagram of ML algorithm 2104 for classifying a previously unclassified customer, corresponding to repackaged conversation data structure 2108, as one classification type within a plurality of different classification types, in accordance with aspects of the present disclosure.

As shown in the figure, ML algorithm 2104 includes preprocessing layer 2002, text-to-embeddings layer 2006, audio-to-embeddings layer 2008, image-to-embeddings layer 2010, video-to-embeddings layer 2012, and embeddings-to-classification layer 2014. As compared to ML algorithm 1904 discussed above with reference to FIG. 20A, ML algorithm 2104 does not include classification comparator layer 2004. This is because ML algorithm 2104 includes an already trained embeddings-to-classification layer 2014. As such, embeddings-to classification layer 2014 will not output a determined customer classification to be compared to a conversation classification data structure as discussed above with reference to the training of embeddings-to-classification layer 2014 discussed above with reference to FIGS. 20A-B.

For purposes of explanation only, in this non-limiting example, let repackaged conversation data structure 2108 correspond to a plurality of HCC data structures, such as discussed above with reference to HCC data structure 702 of FIG. 7, each of which corresponds to a previously unclassified customer Mary Black.

In one or more embodiments, preprocessing layer 2002 is operable: to receive repackaged conversation data structure 2108; to review the conversation data type portion of at least one of the HCC data structures in repackaged conversation data structure 2108; to generate a plurality of preprocessed conversation data structures, each of which corresponds to a single respective HCC data structure within repackaged conversation data structure 2108; and to serially output the plurality of preprocessed conversation data structures to one of text-to-embeddings layer 2006, audio-to-embeddings layer 2008, image-to-embeddings layer 2010, video-to-embeddings layer 2012.

In one or more embodiments, preprocessing layer 2002 is operable to generate each preprocessed conversation data structure by removing at least one data portion from the respective corresponding HCC data structure within repackaged conversation data structure 2108. For example, as discussed above with reference to FIG. 7, preprocessing layer 2002 may be operable to generate the preprocessed conversation data structure by removing the classification data portion from the HCC data structure.

In particular, as will be described in greater detail below, embeddings-to-classification layer 2014 may be operable to classify a customer associated with a repackaged conversation data structure, as one classification type within a plurality of different classification types. As such, including a customer classification within a preprocessed conversation data structure may inadvertently cause embeddings-to-classification layer 2014 to classify a customer associated with a repackaged conversation data structure with the same classification that is identified within the repackaged conversation data structure.

For purposes of explanation only, in this non-limiting example, let repackaged conversation data structure 2108 correspond to a plurality of HCC data structures, such as discussed above with reference to HCC data structure 702 of FIG. 7, wherein the conversation type data portion of each HCC data structure indicates that the data within the conversation payload data portion of the HCC data structure corresponds to a particular data type of data. In this non-limiting example, let a first HCC data structure within repackaged conversation data structure 2108 have a conversation type data portion that indicates that the data within the conversation payload data portion of the HCC data structure corresponds to text data. Accordingly, in this non-limiting example, preprocessing layer 2002 is operable to output a preprocessed conversation data structure 2202 to text-to-embeddings layer 2006.

Preprocessing layer 2002 generates a preprocessed conversation data structure 2202 from a first provided conversation data structure within repackaged conversation data structure 2108, such that preprocessed conversation data structure 2202 does not include a customer classification data portion.

In one or more embodiments, the data within the conversation type data portion of preprocessed conversation data structure 2202 identifies the data type of the conversation payload portion of preprocessed conversation data structure 2202. In one or more embodiments, the data within the conversation type data portion of preprocessed conversation data structure 2202 indicates the type of encoding of the data within the conversation payload data portion of preprocessed conversation data structure 2202. Accordingly, the data within preprocessed conversation data structure 2202 directs preprocessing layer 2002 as to which of text-to-embeddings layer 2006, audio-to-embedding layer 2008, image-to-embeddings layer 2010, and video-to-embeddings layer 2012 preprocessed conversation data structure 2202 is to be provided.

For purposes of discussion only, in a non-limiting example, let a first HCC data structure within preprocessed conversation data structure 2202 be a conversation data structure wherein the type of data within the conversation payload data portion is text data. Therefore, preprocessing layer 2002 provides preprocessed conversation data structure 2202, based on the first HCC data structure within repackaged conversation data structure 2108, to text-to-embeddings layer 2006.

Text-to-embeddings layer outputs embeddings 2204, based on preprocessed conversation data structure 2202, to embeddings-to-classification layer 2014.

Embeddings-to-classification layer 2014 then processes embeddings 2204.

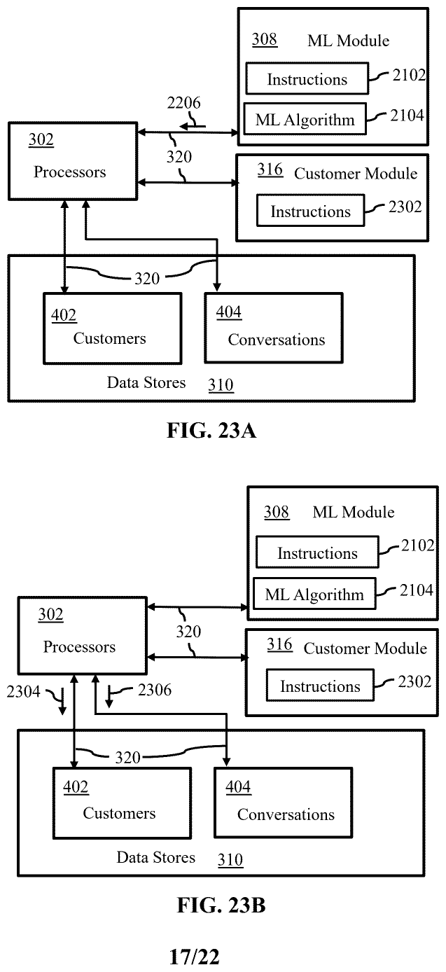

This process is repeated until every preprocessed conversation data structure, which corresponds to a respective conversation data structure within repackaged conversation data structure 2108, is processed by embeddings-to-classification layer 2014. At that point, embeddings-to-classification layer 2014 outputs a determined customer classification 2206 to one or more processors 302. This will be described in greater detail with reference to FIGS. 23A-B.

FIG. 23A illustrates a block diagram of one or more processors 302, customers data storage 402 and conversations data storage 404 within data stores 310, ML module 308, and customer module 316 for classifying a previously unclassified customer in accordance with aspects of the present disclosure. ML module 308 includes instructions 2102 and an ML algorithm 2104 stored therein. Customer module 316 include instructions 2302 stored therein.

In one or more embodiments, one or more processors 302 may receive determined customer classification 2206 from ML algorithm 2104. For purposes of discussion only, in this non-limiting example, let determined customer classification 2206 correspond to one classification type of within a plurality of different classification types for previously unclassified customer Mary Black.

FIG. 23B illustrates the block diagram of FIG. 23A at a subsequent time.

In one or more embodiments, one or more processors 302 may execute instructions 2302 in customer module 316 to cause one or more enterprise servers 104 to provide customer classification data 2304 to customers data storage 402 and to provide customer classification data 2306 to conversations data storage 404. Customer classification data 2304 and customer classification data 2306 each include data identifying the one classification type within the plurality of different classification types as indicated in determined customer classification 2206 from ML algorithm 2104.

For example, returning to FIG. 5, in one or more embodiments, one or more processors 302 may execute instructions 2302 in customer module 316 to cause one or more enterprise servers 104 to insert customer classification data 2304 into the customer classification data portion of the customer data structure within customers data storage 402. For purposes of discussion only, in this non-limiting example, let determined customer classification data 2304 be inserted into the customer classification data portion of the customer data structure of previously unclassified customer Mary Black. Therefore, previously unclassified customer Mary Black would now be classified in accordance with the one classification type as determined by ML algorithm 2104.

Similarly, and to provide customer classification data 2306 to conversations data storage 404. Similarly, one or more processors 302 may execute instructions 2302 in customer module 316 to cause one or more enterprise servers 104 to insert customer classification data 2306 into the customer classification data portion of each the HCC data structures within customers data storage 402, that are associated with the previously unclassified customer. For purposes of discussion only, in this non-limiting example, let determined customer classification data 2306 be inserted into the customer classification data portion of each of the HCC data structure of previously unclassified customer Mary Black. Therefore, each of the HCC data structures of previously unclassified customer Mary Black now includes the classification in accordance with the one classification type as determined by ML algorithm 2104.

The process for classifying a previously unclassified customer as discussed above with reference to FIGS. 21-23B may be repeated until every unclassified customer is classified by ML algorithm 2104.

Returning to FIG. 12, after all unclassified customers have been classified (S1208), or if it is determined that all customers have been classified (Y at S1206), it is determined whether there is a new customer conversation (S1210). For example, returning to FIG. 3, one or more processors 302 may execute instructions in customer module 316 to cause one or more enterprise servers 104 to determine whether there is a new customer conversation.

In some cases, customers may communicate with enterprise 1100. Such communications include a direct enterprise customer representative initiated phone call, an automated enterprise initiated phone call, a direct customer initiated phone call, a direct enterprise customer representative initiated email, an automated enterprise initiated email, and a direct customer initiated email. Any of these communications are termed a customer communication.

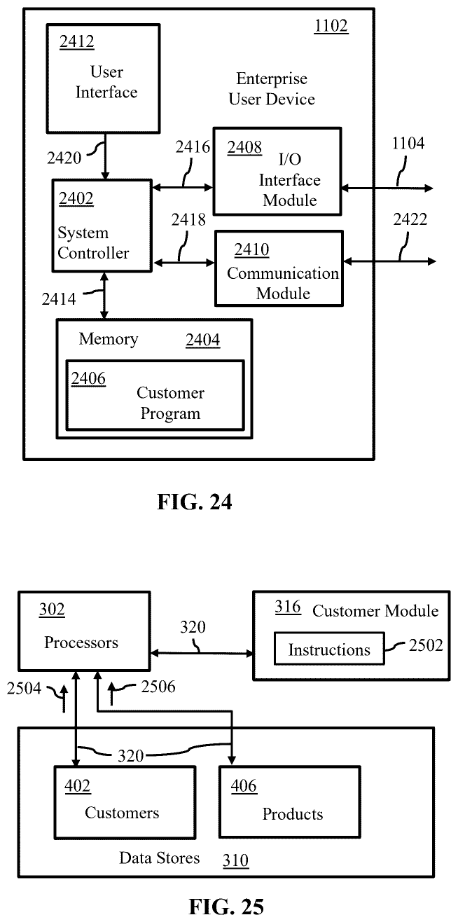

FIG. 24 illustrates a block diagram of enterprise user device 1102. As shown in the figure, enterprise user device 1102 includes a system controller 2402, a non-transitory memory 2404 having instructions and a customer program 2406 stored therein, an input/output (I/O) interface module 2408, a communication module 2410, a user interface (UI) 2412, and communication channels 2414, 2416, 2418, and 2420.

In this example, system controller 2402, non-transitory memory 2404, I/O interface module 2408, communication module 2410, and UI 2412 are illustrated as individual elements of one or more enterprise user device 1102. However, in one or more embodiments, at least two of system controller 2402, non-transitory memory 2404, I/O interface module 2408, communication module 2410, and UI 2412 may be combined as a unitary device. Further, in one or more embodiments, at least one of system controller 2402, non-transitory memory 2404, I/O interface module 2408, communication module 2410, and UI 2412 may be implemented as a computer having non-transitory computer-readable media for carrying or having computer-executable instructions or data structures stored thereon.

System controller 2402 is operable to communicate with: non-transitory memory 2404 via communication channel 2414; I/O interface module 2408 via communication channel 2416; communication module 2410 via communication channel 2418; and UI 2412 via communication channel 2420.

I/O interface module is additionally configured to communicate with one or more enterprise servers 104 via communication channel 1104.

Communication module is additionally configured to communicate with client device 102 via communication channel 2422 and communications network 106.

Each of communication channels 2414, 2416, 2418, 2420, and 2422 may be any known type of communication channel, including wired and wireless.

System controller 2402 may be any device or system that is operable to control general operations of enterprise user device 1102 and includes, but is not limited to, a CPU, a hardware microprocessor, a single core processor, a multi-core processor, an FPGA, a microcontroller, an ASIC, a DSP, or other similar processing device capable of executing any type of instructions, algorithms, or software for controlling the operation and functions of enterprise user device 1102.

Non-transitory memory 2404 may be any device or system capable of storing data and instructions used by enterprise user device 1102 and includes, but is not limited to, RAM, DRAM, a hard drive, a solid-state drive, ROM, EPROM, EEPROM, flash memory, embedded memory blocks in an FPGA, or any other various layers of memory hierarchy.

Customer program 2406 includes instructions that when executed by system controller 2402, enable enterprise user device 1102 to perform the functions disclosed herein.

In one or more embodiments, as will be described in greater detail below, customer program 2406 includes instructions, that when executed by system controller 2402, enable enterprise user device 1102 to cause system controller to generate an HCC data structure based on a communication with a customer via communication module 2410.

In one or more embodiments, as will be described in greater detail below, customer program 2406 includes instructions, that when executed by system controller 2402, enable enterprise user device 1102 to cause system controller to generate an HCC data structure based on an input from an enterprise employee via UI 2412, wherein the input is based on a communication between the enterprise employee and a customer.

In one or more embodiments, as will be described in greater detail below, customer program 2406 includes instructions, that when executed by system controller 2402, enable enterprise user device 1102 to cause system controller to generate an HCC data structure based on an input from an enterprise employee via UI 2412, wherein the input is based on notes from an enterprise employee about a customer.

In one or more embodiments, as will be described in greater detail below, customer program 2406 includes instructions, that when executed by system controller 2402, enable enterprise user device 1102 to I/O interface module 2408 to transmit a generated HCC data structure to one or more enterprise servers 104.

In one or more embodiments, as will be described in greater detail below, customer program 2406 includes instructions, that when executed by system controller 2402, enable enterprise user device 1102 to cause UI 2412 to display information related to acknowledgment of a customer's current implemented product.

In one or more embodiments, as will be described in greater detail below, customer program 2406 includes instructions that when executed by system controller 2402, enable enterprise user device 1102 to cause UI 2412 to display information related to an alternate available product for a customer.

In one or more embodiments, as will be described in greater detail below, customer program 2406 includes instructions that when executed by system controller 2402, enable enterprise user device 1102 to cause UI 2412 to display information related to an available product for a customer.

I/O interface module 2408 is operable to connect to one or more enterprise servers 104. I/O interface module 2408 may include one or more of an input interface, an output interface, and a network controller to facilitate communications between enterprise user device 1102 and one or more enterprise servers 104. The input interface and the output interface may be integrated as a single, unitary interface, or alternatively, be separate as independent interfaces that are operatively connected.

Communication module 2410 may be any device or system that is operable to facilitate user communications with devices external to enterprise 1100. In one or more embodiments, communication module is operable to enable transmission of text messages from enterprise user device 1102 to client device 102 though communications network 106 via communication channel 2422. In one or more embodiments, communication module 2410 is operable to enable receipt of text messages from client device 102 by enterprise user device 1102 though communications network 106 via communication channel 2422. In one or more embodiments, communication module is operable to enable transmission of email messages from enterprise user device 1102 to client device 102 though communications network 106 via communication channel 2422. In one or more embodiments, communication module 2410 is operable to enable receipt of email messages from client device 102 by enterprise user device 1102 though communications network 106 via communication channel 2422. In one or more embodiments, communication module is operable to facilitate user access to one or more websites through communications network 106.

UI 2412 may be any device, software, component, system, element, or arrangement or groups thereof that enable information and/or data to be entered as input commands by a user in a manner that directs system controller 2402 to execute instructions and that enable information/data to be presented to a user. UI 2412 may include a user interface (UI), a graphical user interface (GUI), such as, for example, a display, human-machine interface (HMI), or the like. Embodiments, however, are not limited thereto, and thus, this disclosure contemplates UI 2412 including a keypad, touch screen, multi-touch screen, button, joystick, mouse, trackball, microphone and/or combinations thereof. UI 2412 may additionally include one or more of a visual display or an audio display, including, but not limited to, a microphone, earphone, and/or speaker.

In operation, for purposes of discussion only, consider the non-limiting example situation when a customer calls an employee of enterprise 1100 and the conversation between the employee and the customer is recorded via communication module 2410. System controller 2402 may execute instructions in customer program 2406 to generate an HCC data structure of the recorded conversation. Further, system controller 2402 may execute instructions in customer program 2406 to cause I/O interface module 2408 to store the created HCC data structure associated with the customer into HCC history data storage 602 of conversations data storage 404 of data stores 310 of within one or more enterprise servers. Upon receiving the HCC data structure from enterprise user device 1102, one or more processors 302 may execute instructions in customer module 316 to determine that there is a new customer conversation.

Consider the non-limiting example situation when a calls an employee of enterprise 1100 and the employee enters a description of the conversation via UI 2412. System controller 2402 may execute instructions in customer program 2406 to generate an HCC data structure of the entered description of the conversation. Further, system controller 2402 may execute instructions in customer program 2406 to cause I/O interface module 2408 to store the created HCC data structure associated with the customer into HCC history data storage 602 of conversations data storage 404 of data stores 310 of within one or more enterprise servers. Upon receiving the HCC data structure from enterprise user device 1102, one or more processors 302 may execute instructions in customer module 316 to determine that there is a new customer conversation.

Returning to FIG. 12, if it is determined that there is no new customer conversation (N at S1210), then computer-implemented method 1200 stops (S1212). For example, in the event there is no new engagement event with a customer, then an employee of enterprise 1100 may not have an opportunity to suggest available products/services that the customer may have qualified for but does not currently use.

Alternatively, if it is determined that there is a new customer conversation (Y at S1210), then it is determined whether the engaged customer qualifies for any products/services (S1214). For example, returning to FIG. 3, one or more processors 302 may execute instructions in customer module 316 to cause one or more enterprise servers 104 to determine whether the engaged customer qualifies for any products/services. This will be described in greater detail with reference to FIG. 25.

FIG. 25 illustrates a block diagram of one or more processors 302, customers data storage 402 and products/services data storage 406 within data stores 310, and customer module 316 for determining whether a customer qualifies for any products/services in accordance with aspects of the present disclosure. Customer module 316 include instructions 2502 stored therein.

In one or more embodiments, one or more processors 302 execute instructions 2502 to cause one or more processors 302 to retrieve customer classification data 2504 from the customer classification data portion of the customer data structure corresponding to the customer from customers data storage 402. In one or more embodiments, the customer classification data identifies the type of classification of the customer. For purposes of discussion only, in this non-limiting example, let the customer corresponding to the classification be Mary Black, and let Mary Black's classification be a TIER 1 classification.

In one or more embodiments, one or more processors 302 execute instructions 2502 to cause one or more processors 302 to retrieve qualified product/service data 2506 from the product classification data portion of the available product/service data structure corresponding to the customer classification from customer classification data 2504. For purposes of discussion only, in this non-limiting example, let qualified product/service data 2506 correspond to one product that is available to customers having a TIER 1 classification, and let that one product be a 6-month certificate of deposit.

Returning to FIG. 12, if it is determined that the engaged customer does not qualify for any products/services (N at S1214), then computer-implemented method 1200 stops (S1212). For example, there may be situations where a customer already has all products/services that are offered by enterprise 1100, for which that customer qualifies. In such instances, in one or more embodiments, enterprise 1100 may determine that the customer does not qualify for any further products/services.

Alternatively, if it is determined that the engaged customer does qualify for at least one product (Y at S1214) then a product signal is transmitted (S1214). For example, returning to FIG. 3, one or more processors 302 may execute instructions in customer module 316 to cause one or more enterprise servers 104 to transmit a product signal. Returning to FIG. 24, I/O interface module 2408 is operable to receive the product signal and provide the product signal to system controller 2402.

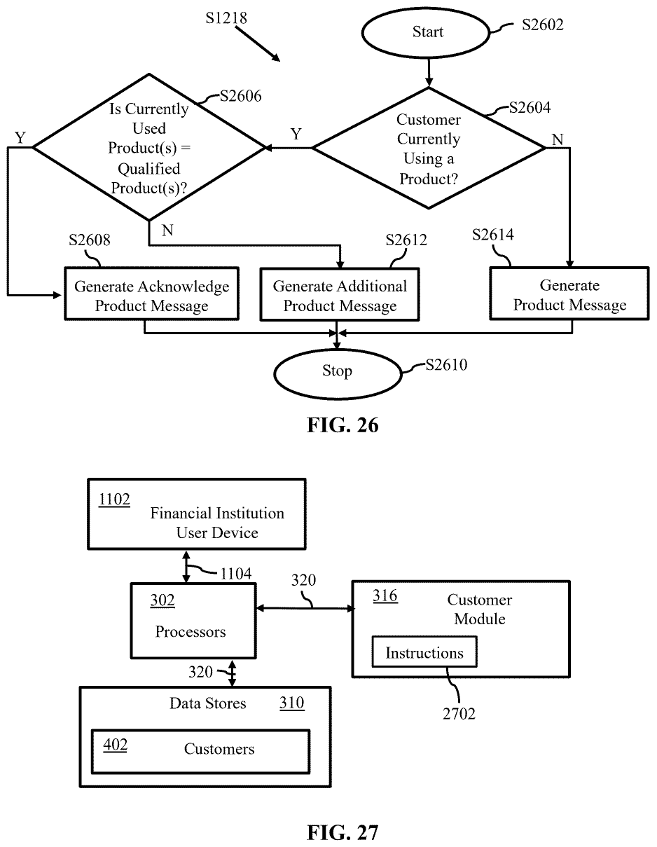

Returning to FIG. 12, after a product signal is transmitted (S1216), a product message is generated (S1218). For example, returning to FIG. 3, one or more processors 302 may execute instructions in customer module 316 to cause financial institution user device to generate a product message. This will be described in greater detail with reference to FIGS. 26-30C.

FIG. 26 illustrates an example computer-implemented method S1218 of generating a product message in accordance with aspects of the present disclosure.

As shown in the figure, computer-implemented method S1218 starts (S2602), and it is determined whether the customer is currently using an enterprise product (S2604). For example, returning to FIG. 3, one or more processors 302 may execute instructions in customer module 316 to cause one or more enterprise servers 104 to determine whether the customer is using a product. This will be described in greater detail with reference to FIG. 27.

FIG. 27 illustrates a block diagram of a portion of one or more enterprise servers of FIG. 3 for identifying whether a customer is currently using an available product in accordance with aspects of the present disclosure.

As shown in the figure, customer module 316 includes instructions 2702.

In one or more embodiments, one or more processors 302 may execute instructions 2702 to cause one or more processors 302 to determine whether the customer is currently using any products/services via data within the customer products/services data portion of the customer data structure, which is associated with the customer, within customers data storage 402, for example as discussed above with reference to FIG. 5.

In one or more embodiments, one or more processors 302 may execute instructions 2702 to cause one or more processors 302 to determine that the customer is currently using a product if there is data identifying a product in the customer products/services data portion of the customer data structure. Further, one or more processors 302 may execute instructions 2702 to cause one or more processors 302 to identify the product that the customer is currently using based on the data identifying the product in the customer products/services data portion of the customer data structure.

In one or more embodiments, one or more processors 302 may execute instructions 2702 to cause one or more processors 302 to determine that the customer is currently using multiple products/services if there is data identifying multiple products/services in the customer products/services data portion of the customer data structure. Further, one or more processors 302 may execute instructions 2702 to cause one or more processors 302 to identify the multiple products/services that the customer is currently using based on the data identifying the products/services in the customer products/services data portion of the customer data structure.

For purposes of explanation only, in a non-limiting example, let the customer be John Green, and let the customer products/services data portion of the customer data structure associated with John Green within customers data storage 402 indicate that John Green is currently using a CD, a line of credit, and a home loan. As such, in this example, one or more processors 302 may execute instructions 2702 to cause one or more processors 302 to determine that John Green is currently using a CD, a line of credit, and a home loan.

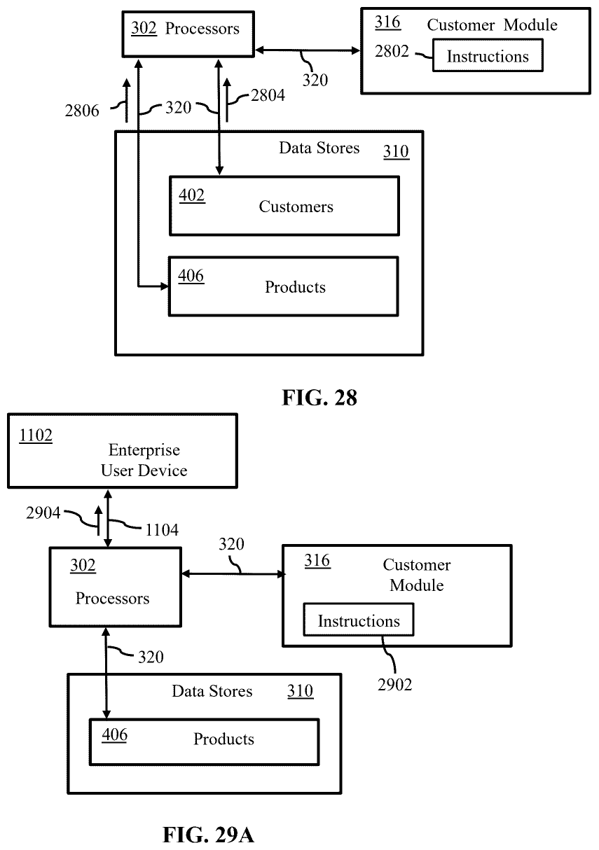

Returning to FIG. 26, if it is determined that the customer is currently using a product(s) (Y at S2604), it is then determined whether the customer's currently used product(s) is the available product(s) (S2606). For example, returning to FIG. 3, one or more processors 302 may execute instructions in customer module 316 to cause one or more enterprise servers 104 to determine whether the product(s) being currently used by a customer is the available product(s). This will be described in greater detail with reference to FIG. 28.

FIG. 28 illustrates a block diagram of a portion of one or more enterprise servers of FIG. 3 for identifying whether a customer's currently used product(s) is the available product(s), in accordance with aspects of the present disclosure.

As shown in the figure, customer module 316 includes instructions 2802.

In one or more embodiments, one or more processors 302 may execute instructions 2702 to cause one or more processors 302 to identify whether a customer's currently used product(s) is the available product(s).

In one or more embodiments, one or more processors 302 may execute instructions 2702 to cause one or more processors 302 to: 1) identify every product the customer is currently using; 2) identify every product for which the customer qualifies based on the classification of the customer; and 3) determine whether any products/services for which the customer qualifies are not being used by the customer.

In one or more embodiments, one or more processors 302 may execute instructions 2702 to cause one or more processors 302 to identify every product the customer is currently using via data within the customer products/services data portion of the customer data structure, which is associated with the customer, within customers data storage 402.

In one or more embodiments, one or more processors 302 may execute instructions 2702 to cause one or more processors 302 identify every product for which the customer qualifies based on the classification of the customer via: 1) identifying the customer classification of the customer from data within the customer classification data portion of the customer data structure, which is associated with the customer, within customers data storage 402; and 2) identifying all product/service data structures within products/services data storage 406, that include data identifying the customer classification of the customer within the product classification data portion.

In one or more embodiments, one or more processors 302 may execute instructions 2702 to cause one or more processors 302 to determine whether any products/services for which the customer qualifies are not being used by the customer via identifying any products/services, corresponding to product/service data structures within products/services data storage 406, that include data identifying the customer classification of the customer within the product classification data portion, that are not included in every identified product for which the customer is currently using.

Again, for purposes of explanation only, in a non-limiting example let the customer be John Green, as discussed above, wherein the customer products/services data portion of the customer data structure associated with John Green within customers data storage 402 indicates that John Green is currently using a CD, a line of credit, and a home loan. Further, in this example, let the customer data structure associated with John Green within customers data storage 402 indicate that John Green is a TIER 3 customer. Still further, in this example, let the product classification data portion of each of: a product/service data structure corresponding a CD; a product/service data structure corresponding to a line of credit; and a product/service data structure corresponding to a home loan, indicate that a customer having a TIER 3 classification qualifies for the respective products/services.

As such, in this example, one or more processors 302 may execute instructions 2702 to cause one or more processors 302 to identify that John Green is using all available products/services for which he is qualified, based on his customer classification.

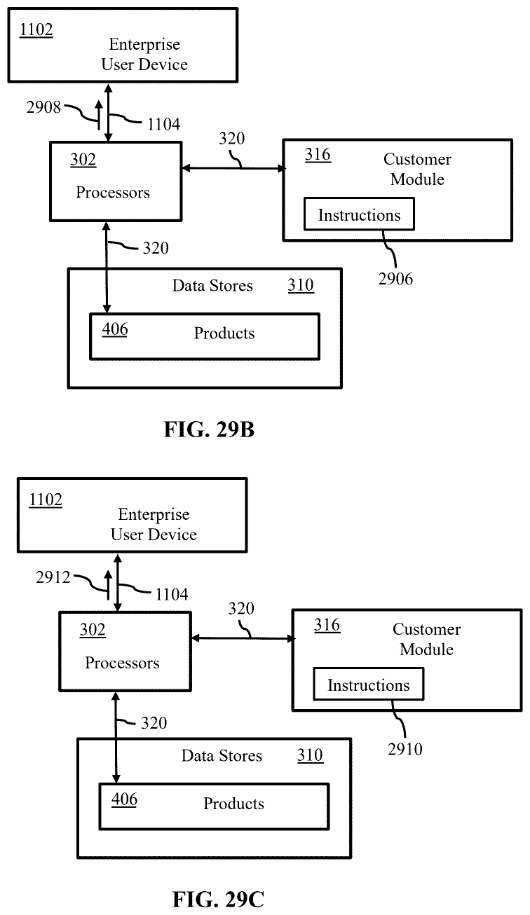

Returning to FIG. 26, if it is determined that the customer's currently used product(s) is the available product(s) (Y at S2606), then an acknowledge product message is generated (S2608). For example, returning to FIG. 3, one or more processors 302 may execute instructions in customer module 316 to cause one or more enterprise servers 104 to generate an acknowledge product signal to cause enterprise user device 1102 to generate an acknowledge product message. This will be described in greater detail with reference to FIG. 29A.

FIG. 29A illustrates a block diagram of a portion of one or more enterprise servers of FIG. 3 and enterprise user device 1102 for displaying information related to acknowledging a currently used product(s) in accordance with aspects of the present disclosure.

As shown in FIG. 29A, customer module 316 includes instructions 2902 stored therein.

One or more processors 302 may execute instructions 2902 to cause one or more one or more processors 302 to generate an acknowledge product signal 2904 based on product information 2806, which corresponds to the product(s) that the customer is currently using. In one or more embodiments, the product(s) that the customer is currently using is determined from customers data storage 402, as discussed above (S2604).

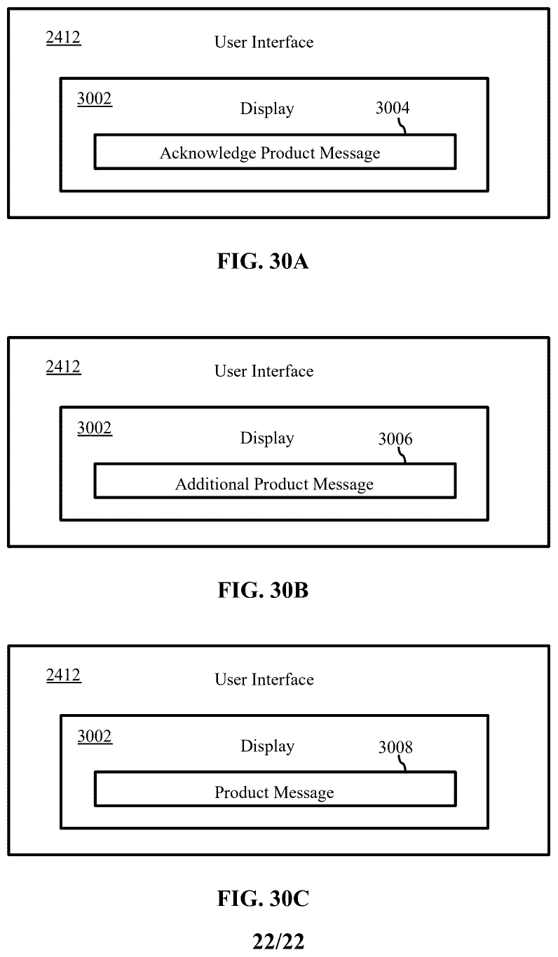

Upon receiving acknowledge product signal 2904, enterprise user device 1102 is configured to display information related to acknowledging a currently used product(s). For example, returning to FIG. 24, upon receiving acknowledge product signal 2904, system controller 2402 may execute instructions within customer program 2406 to cause UI 2412 to display to display information related to acknowledging the customer's currently used product(s). This will be described in greater detail with reference to FIG. 30A.

FIG. 30A illustrates UI 2412 of enterprise user device 1102 displaying an acknowledge product message in accordance with aspects of the present disclosure. As shown in the figure, UI 2412 includes a display 3002 displaying a predetermined acknowledge product message 3004.

For purposes of explanation, consider the situation wherein a customer calls enterprise 600 to speak with a representative. Further, let the representative be using enterprise user device 1102. Upon speaking with the customer, and with reference to FIGS. 4, 11 and 26, the representative may access information of the customer from any one of customers data storage 402 or products/services data storage 406 via UI 2412 of enterprise user device 1102.

Further, in one or more embodiments, customer module 316 may have instructions stored therein, that when executed by one or more processors 302, cause one or more enterprise servers 104 to instruct UI 2412 of enterprise user device 1102 to display a message for the representative, “I see that you have been using our product(s) ______. I hope you are enjoying it,” wherein the blank is filled in with product(s) title(s) of the product(s) that the customer is currently using.

Returning to FIG. 26, after an acknowledge product message is generated (S2608), computer-implemented method S1218 stops (S2610). If it is determined that the customer's currently used product(s) is not available product(s) (N at S2606), then an additional product message is generated (S2612).

For example, returning to FIG. 3, one or more processors 302 may execute instructions in customer module 316 to cause one or more enterprise servers 104 to generate an additional product signal to cause enterprise user device 1102 to generate an additional product message. This will be described in greater detail with reference to FIG. 29B.

FIG. 29B illustrates a block diagram of a portion of one or more enterprise servers of FIG. 3 and enterprise user device 1102 for displaying information related to informing of an additional product(s) in accordance with aspects of the present disclosure.

As shown in FIG. 29B, customer module 316 includes instructions 2906 stored therein.

One or more processors 302 may execute instructions 2906 to cause one or more one or more processors 302 to generate an additional product signal 2908 based on based on product information 2804, which corresponds to the product(s) that the customer is currently using and product information 2806, which corresponds to the products/services(s) that are available to a customer having a customer classification of the customer. In one or more embodiments, the product(s) that the customer is currently using is determined from customers data storage 402, as discussed above (S2604), whereas the product(s) that the customer may qualify for based on the customer classification is determined from the products/services data storage 406.

Upon receiving additional product signal 2908, enterprise user device 1102 is configured to display information related to the alternate available product(s). For example, returning to FIG. 24, upon receiving additional product signal 2908, system controller 2402 may execute instructions within customer program 2406 to cause UI 2412 to display to display information related an optimal available product. This will be described in greater detail with reference to FIG. 30B.

FIG. 30B illustrates UI 2412 of enterprise user device 1102 displaying an additional product message in accordance with aspects of the present disclosure. As shown in the figure, UI 2412 includes display 3002 displaying a predetermined additional product message 3006.

Now, for purposes of explanation only, in a non-limiting example, let the customer be Jennifer White, wherein the customer products/services data portion of the customer data structure associated with Jennifer White within customers data storage 402 indicates that Jennifer White is currently using a CD, a line of credit, and a home loan. Further, in this example, let the customer data structure associated with Jennifer White within customers data storage 402 indicate that Jennifer White is a TIER 2 customer. Still further, in this example, let the product classification data portion of each of: a product/service data structure corresponding a CD; a product/service data structure corresponding to a line of credit; a product/service data structure corresponding to a home loan; and a product/service data structure corresponding to a mutual fund product, indicate that a customer having a TIER 2 classification qualifies for the respective products/services.

As such, in this example, one or more processors 302 may execute instructions 2702 to cause one or more processors 302 to identify that Jennifer White is not using all available products/services for which she is qualified, based on her customer classification.

For purposes of explanation, consider the situation wherein a customer calls enterprise 600 to speak with a representative. Further, let the representative be using enterprise user device 1102. Upon speaking with the customer, and with reference to FIGS. 4, 11 and 26, the representative may access information of the customer from any one of customers data storage 402 or products/services data storage 406 via UI 2412 of enterprise user device 1102.

Further, in one or more embodiments, customer module 316 may have instructions stored therein, that when executed by one or more processors 302, cause one or more enterprise servers 104 to instruct user interface 2412 of enterprise user device 1102 to display a message for the representative, “I see that you have been using our product ______. However, you may want to consider using our additional product ______, because the benefits that you will receive from this product seem to benefit you most based on your past purchase history,” wherein the first blank is filled in with product title of the product that the customer is currently using, and the second blank is filled in with the product title of the additional product.

Returning to FIG. 26, after an additional product message is generated (S2612), computer-implemented method S1218 stops (S2610).

If it is determined that the customer is not currently using a product (N at S2604), then a product message is generated (S2614). For example, returning to FIG. 3, one or more processors 302 may execute instructions in customer module 316 to cause one or more enterprise servers 104 to generate a product signal to cause enterprise user device 1102 to generate a product message. This will be described in greater detail with reference to FIG. 29C.

FIG. 29C illustrates a block diagram of a portion of one or more enterprise servers of FIG. 3 and enterprise user device 1102 for displaying information related to informing of a product in accordance with aspects of the present disclosure.

As shown in FIG. 29C, customer module 316 includes instructions 2910 stored therein.

One or more processors 302 may execute instructions 2910 to cause one or more one or more processors 302 to generate a product signal 2912 based on based product information 2804, which corresponds to the product(s) that the customer is currently using and product information 2806, which corresponds to the products/services(s) that are available to a customer having a customer classification of the customer.

Upon receiving product signal 2912, enterprise user device 1102 is configured to display information related to the optimal available product. For example, returning to FIG. 24, upon receiving product signal 2912, system controller 2402 may execute instructions within customer program 2406 to cause UI 2412 to display to display information related an available product(s). This will be described in greater detail with reference to FIG. 30C.

FIG. 30C illustrates UI 2412 of enterprise user device 1102 displaying a product message in accordance with aspects of the present disclosure. As shown in the figure, UI 2412 includes display 3002 displaying a predetermined product message 3008.

Now, for purposes of explanation only, in a non-limiting example, let the customer be David Brown, wherein the customer products/services data portion of the customer data structure associated with David Brown within customers data storage 402 indicates that David Brown is not currently using any products/services. Further, in this example, let the customer data structure associated with David Brown within customers data storage 402 indicate that David Brown is a TIER 2 customer. Still further, in this example, let the product classification data portion of each of: a product/service data structure corresponding a CD; a product/service data structure corresponding to a line of credit; a product/service data structure corresponding to a home loan; and a product/service data structure corresponding to a mutual fund product, indicate that a customer having a TIER 2 classification qualifies for the respective products/services.

As such, in this example, one or more processors 302 may execute instructions 2702 to cause one or more processors 302 to identify that David Brown is not using any available products/services for which he is qualified, based on his customer classification.

For purposes of explanation, consider the situation wherein a customer calls enterprise 600 to speak with a representative. Further, let the representative be using enterprise user device 1102. Upon speaking with the customer, and with reference to FIGS. 4, 11 and 26, the representative may access information of the customer from any one of customers data storage 402 or products/services data storage 406 via UI 2412 of enterprise user device 1102.

Further, in one or more embodiments, customer module 316 may have instructions stored therein, that when executed by one or more processors 302, cause one or more enterprise servers 104 to instruct UI 2412 of enterprise user device 1102 to display a message for the representative, “I see that you have not been using any of our products/services. You may want to consider using our product ______, because the benefits that you will receive from this product seem to benefit you most based on your past purchase history,” wherein the blank is filled in with the product title of the available product(s).

Returning to FIG. 26, after a product message is generated (S2614), computer-implemented method S1218 stops (S2610).

In the above-discussed non-limiting example embodiment, a product message is generated to assist an enterprise stakeholder in describing a qualified product for a current customer. However, in one or more embodiments, a product message may be generated to assist an enterprise stakeholder in describing at least one more product for a current customer.

Returning to FIG. 12, after a product message is generated (S1218), computer-implemented method 1200 stops (S1212).

The foregoing description of various preferred embodiments have been presented for purposes of illustration and description. It is not intended to be exhaustive or to limit the disclosure to the precise forms disclosed, and obviously many modifications and variations are possible in light of the above teaching. The example embodiments, as described above, were chosen and described in order to enable others skilled in the art to best utilize the disclosure in various embodiments and with various modifications as are suited to the particular use contemplated. It is intended that the scope of the disclosure be defined by the claims appended hereto.

1. A server computing system, comprising:
a processor; and
a non-transitory memory, coupled to the processor, the non-transitory memory including a set of instructions of computer-executable program code, which when executed by the processor, cause the processor to perform operations including:
capturing, from a storage location, customer conversation data associated with a customer and product/service data relating to a respective plurality of available products/services, the customer conversation data including data structures corresponding to a plurality of distinct conversations associated with a respective data type of a plurality of data types including text data, audio data, image data, and video data;
classifying, via a machine learning (ML) algorithm and based on the customer conversation data, the customer as one classification type within a plurality of different classification types, wherein the machine learning algorithm is to perform ML operations comprising:
routing each distinct conversation, based on the data type associated with that distinct conversation, to a corresponding embedding layer of a multichannel set of embedding layers including a respective embedding layer for each data type of the plurality of data types;
generating a set of embeddings via the multichannel set of embedding layers; and
generating, via a classification layer comprising a recurrent neural network and based on the set of embeddings. the one classification type for the customer;
identifying an available product based on the one classification type;
generating an available product signal based on the available product; and
transmitting the available product signal to a client device to cause display, via a user interface of the client device, of information related to the available product.

2. The server computing system of claim 1, wherein the set of instructions, which when executed by the processor, cause the processor to perform operations including:
identifying a second available product based on the one classification type;
generating the available product signal based on the available product and the second available product; and
transmitting the available product signal to a client device to cause display, via the user interface of the client device, of information related to the available product and the second available product.

3. The server computing system of claim 1, wherein the recurrent neural network has been trained via reinforcement learning.

4. The server computing system of claim 1, wherein the customer is classified, using the recurrent neural network, based on at least one of an email message from the customer, a recorded voice message from the customer, a text message from the customer, data related to an in-person visit by the customer, and combinations thereof, of the customer conversation data.

5. The server computing system of claim 3, wherein the recurrent neural network has been trained via reinforcement learning of historical customer conversation data of at least one of an email message from a second customer, a recorded voice message from the second customer, a text message from the second customer, data related to an in-person visit by the second customer, and combinations thereof.

6. The server computing system of claim 5, wherein the recurrent neural network has been trained via reinforcement learning additionally of synthetic customer conversation data created from historical customer conversation data of at least one of the email message from the second customer, the recorded voice message from the second customer, the text message from the second customer, the data related to the in-person visit by the second customer, and combinations thereof.

7. The server computing system of claim 6, wherein the recurrent neural network has been trained via reinforcement learning additionally of a priori data of at least one of an email message, a recorded voice message, a text message, data related to an in-person visit, and combinations thereof.

8. The server computing system of claim 3, wherein the recurrent neural network has been trained via reinforcement learning of synthetic customer conversation data created from historical customer conversation data of at least one of an email message from a second customer, a recorded voice message from the second customer, a text message from the second customer, data related to an in-person visit by the second customer, and combinations thereof.

9. The server computing system of claim 8, wherein the recurrent neural network has been trained via reinforcement learning of a priori data of at least one of an email message, a recorded voice message, a text message, data related to an in-person visit, and combinations thereof.

10. The server computing system of claim 3, wherein the recurrent neural network has been trained via reinforcement learning of a priori data of at least one of an email message, a recorded voice message, a text message, data related to an in-person visit, and combinations thereof.

11. The server computing system of claim 1, wherein the set of instructions, which when executed by the processor, cause the processor to perform operations including transmitting, to a second server computing system having the neural network stored therein, updated customer conversation data based on at least one of a new email message from the customer, a new recorded voice message from the customer, a new text message from the customer, data related to a new in-person visit by the customer, and combinations thereof, to cause the second server computing system to update the recurrent neural network based on the updated customer conversation data.

12. The server computing system of claim 1, wherein the set of instructions, which when executed by the processor, cause the processor to perform operations including:
receiving, from a second server computing system having the recurrent neural network stored therein, a modification instruction; and
updating the recurrent neural network based on the modification instruction.

13. The server computing system of claim 12, wherein the set of instructions, which when executed by the processor, cause the processor to perform operations including:
reclassifying the customer, via the recurrent neural network that has been updated based on the modification instruction and based on the customer conversation data, as a new classification type within the plurality of different classification types;
identifying a new available product based on the new classification type;
generating a new available product signal based on the new available product; and
transmitting the new available product signal to the client device to cause display of new information related to the new available product on the user interface of the client device.

14. The server computing system of claim 13, wherein the set of instructions, which when executed by the processor, cause the processor to perform operations including:
determining whether the one classification type is different from the new classification type;
generating a classification type change signal when the one classification type is different from the new classification type; and
transmitting the classification type change signal to the client device to cause display of classification type change information related to change in classification type on the user interface of the client device.

15. The server computing system of claim 14, wherein the set of instructions, which when executed by the processor, cause the processor to perform operations including:
determining whether the available product is different from the new available product;
generating an available product change signal when the available product is different from the new available product; and
transmitting the available product change signal to the client device to cause display of available product change information related to change in available product on the user interface of the client device.

16. The server computing system of claim 15, wherein the set of instructions, which when executed by the processor, cause the processor to perform operations including:
determining whether the one classification type is different from the new classification type;
generating a classification type change signal when the one classification type is different from the new classification type; and
transmitting the classification type change signal to the client device to cause display of classification type change information related to change in classification type on the user interface of the client device.

17. (canceled)

18. The server computing system of claim 12, wherein the set of instructions, which when executed by the processor, cause the processor to perform operations including:
receiving new customer conversation data based on at least one of a new email message from the customer, a new recorded voice message from the customer, a new text message from the customer, new data related to a new in-person visit by the customer;
reclassifying the customer, via the recurrent neural network that has been updated based on the modification instruction and based on the new customer conversation data, as new classification type within the plurality of different classification types;
identifying a new available product based on the new classification type;
generating a new available product signal based on the new available product; and
transmitting the new available product signal to the client device to cause display of new information related to the new available product on the user interface of the client device.

19. A computer-implemented method of operating a system for implementation by a processor of a server computing system, said computer-implemented method comprising:
generating customer conversation data associated with a customer, the customer conversation data including data structures corresponding to a plurality of distinct conversations associated with a respective data type of a plurality of data types including text data, audio data, image data, and video data;
classifying the customer, via a machine learning (ML) algorithm and based on the customer conversation data, as one classification type within a plurality of different classification types, wherein the machine learning algorithm performs ML operations comprising:
routing each distinct conversation, based on the data type associated with that distinct conversation, to a corresponding embedding layer of a multichannel set of embedding layers including a respective embedding layer for each data type of the plurality of data types;
generating a set of embeddings via the multichannel set of embedding layers; and
generating, via a classification layer comprising a recurrent neural network and based on the set of embeddings, the one classification type for the customer;
identifying an available product based on the one classification type;
generating an available product signal based on the available product; and
transmitting the available product signal to a client device to cause display, via a user interface of the client device, of information related to the available product.

20. A computer program product comprising at least one non-transitory computer readable medium having a set of instructions of computer-executable program code, which when executed by a processor of an enterprise computer server system, cause the processor to perform operations comprising:
generating customer conversation data associated with a customer, the customer conversation data including data structures corresponding to a plurality of distinct conversations associated with a respective data type of a plurality of data types including text data, audio data, image data, and video data;
classifying the customer, via a machine learning (ML) algorithm and based on the customer conversation data, as one classification type within a plurality of different classification types, wherein the machine learning algorithm is to perform ML operations comprising:
routing each distinct conversation, based on the data type associated with that distinct conversation, to a corresponding embedding layer of a multichannel set of embedding layers, the multichannel set of embedding layers including a respective embedding layer for each data type of the plurality of data types;
generating a set of embeddings via the multichannel set of embedding layers; and
generating, via a classification layer comprising a recurrent neural network and based on the set of embeddings, the one classification type for the customer;
identifying an available product based on the one classification type;
generating an available product signal based on the available product; and
transmitting the available product signal to a client device to cause display, via a user interface of the client device, of information related to the available product on a user interface of the client device.

21. The computer-implemented method of claim 19, wherein the customer is classified, using the recurrent neural network, based on at least one of an email message from the customer, a recorded voice message from the customer, a text message from the customer, data related to an in-person visit by the customer, and combinations thereof.
